(19) United States
(12) Patent Application Publication
(10) Pub. No.: US 2024/0389603 A1
(43) Pub. Date: Nov. 28, 2024

(54) USE OF AN EXTRACT OF PART OF A PLANT FOR STIMULATING THE DEFENCES OF PLANTS AGAINST PATHOGENS, ASSOCIATED COMPOSITION AND METHODS

(71) Applicant: ELICIR, MONTPELLIER (FR)

(72) Inventor: Christelle MARTINEZ-BARBREAU, Cazevieille (FR)

(21) Appl. No.: 18/632,495

(22) Filed: Apr. 11, 2024

Related U.S. Application Data
(63) Continuation-in-part of application No. PCT/EP2022/078302, filed on Oct. 11, 2022.
(63) Continuation-in-part of application No. PCT/EP2022/078282, filed on Oct. 11, 2022.
(63) Continuation-in-part of application No. 18/494,791, filed on Oct. 26, 2023.
(63) Continuation-in-part of application No. 18/494,842, filed on Oct. 26, 2023.
(60) Provisional application No. 63/495,784, filed on Apr. 13, 2023.

(30) Foreign Application Priority Data
Oct. 11, 2021 (FR) FR2110751
Oct. 11, 2021 (FR) FR2110752

(51) Int. Cl. A01N 65/08; A01P 1/00; A01P 15/00

(52) U.S. Cl. CPC A01N 65/08; A01P 1/00; A01P 15/00

(57) ABSTRACT

The elicitor composition stimulating the defences of the plants and trees and/or reducing the effects of an attack by a pathogen, comprising at least one part of at least one of the following plants: Rockets, including Eruca sativa, Diplotaxis, Erucastrum and Bunias genera, Cakile, plants of the Allium genera, mustard (Sinapis alba, Brassica nigra, Sinapis arvensis, Brassica juncea), wasabi (Eutrema japonicum), horseradish (Armoracia rusticana), watercress (Nasturtium officinale), plants of the species Brassica rapa, Brassica ruvo, Brassica napus, Raphanus sativus, Barbarea verna, Erysimum allionii, Erysimum cheiri, Tropaeolum majus L, Alliaria petiolata, Salvadora persica, Carica papaya and Brassica oleracea.

### TECHNICAL FIELD OF THE INVENTION

The present invention relates to the use of an extract of specific plants for stimulating the defences of plants and trees against pathogens, and associated composition and methods. The present invention therefore aims to reduce the effects of a pathogen attack.

### STATE OF THE ART

Plants, just like animals, in their constant struggle for survival have developed a diverse range of protection and defence systems, which enable them to resist infectious diseases and parasites (fungi [e.g., mushrooms], bacteria, viruses, etc.). Some protection systems are pre-existent (prior to any contact of the pathogen with the host) while other resistance mechanisms (induced resistance) are established after the plant's encounter with its attacker.

Examples of pre-existent defence means are morphological barriers. These can, for example, consist of thick cuticles covered with hydrophobic substances (wax, cutin, suberin, etc.) that prevent the pathogens from entering or developing. Spines on the surfaces of the leaves and stems that can repel animals (especially herbivorous mammals), and the closure of stomata in the leaves and lenticels of stems to prevent fungus spores, bacteria, etc. from entering, may be observed.

The plants also produce biologically active secondary metabolites and inert precursors for protection against harmful organisms. These “secondary metabolites” are not necessary for essential biological activities, such as growth and reproduction, but help the plant to adapt to its environment, and turn into active molecules during the attack by a pest or pathogen, or being wounded.

Pathogen attacks can also induce metabolic changes which may either provide a muted, late defence, or a resistance that is active and rapidly induced.

The late defence is frequently linked to receptors in the membrane or plant cell, which are able to recognise molecular signals associated with microbes or pathogens. For example, the fragments of cell walls, chitin or peptide motifs of the flagellum of bacteria (exogenous elicitor), and proteins (endogenous elicitor) form part of patterns that, once detected by the plant, can trigger a basic immune response (PAMP-Triggered Immunity, or “PTI”), in order to limit the invasion and slow the advance of the pathogen.

In contrast, the specific recognition of a pathogen's attack inducing a rapid response in the host can also limit or stop the invasion and enable the defence to be triggered very rapidly. The recognition of foreign components in plants is coordinated by specialised receptors, which trigger the host's defence responses after detecting the pathogen. In this case of specific recognition, the elicitor is coded in the pathogen by genes known as avirulence (“AVR”) genes. The plant's receptors recognising the avirulence gene product in this way are coded by the plant's resistance (R) genes. The interaction between the parasite's avirulence gene product and the plant's Resistance gene is called the “gene-for-gene relationship”.

The R genes have been isolated for various plant species (for example tomato, flax, rice, tobacco, Arabidopsis, sugar beet). Despite the significant variety of parasites to which they confer resistance (e.g., mushrooms, bacteria, viruses or nematodes), their comparison reveals a high similarity of sequences and the conservation of structural motifs:

The majority of the proteins of the isolated R genes of plants share various structural elements characterised within protein domains operating in the defence mechanisms of yeasts, drosophilae or vertebrates. By analogy, most of the R products combine a receptor domain and an effector domain, respectively performing two major functions: the recognition of elicitor molecules by protein-protein interaction mechanisms, and the direct or indirect activation of signal transduction.

Five main structural domains conserved within the R genes have been identified:

1/ Most of the deduced products of the R gene sequences of R genes cloned to date have an intra- or extra-cytoplasmic LRR (“Leucine-Rich Repeats”) domain in the C-terminal position. The LRR domains correspond to the repetition of a variable-sized motif containing leucine residues. They may act in protein-protein and protein-polysaccharide interaction mechanisms.

2/ The NBS (“Nucleotide Binding Site”) or NB domain, associated with the LRR (NBS-LRR) domain, is widely distributed within the cloned R genes. This domain, containing different conserved kinase-type motifs in particular, corresponds to an ATP and/or GTP nucleotide-triphosphates binding and hydrolysis site. It has similarities with animal proteins potentially involved in the phenomenon of apoptotic cell death, especially APAF-1 in humans and CED-4 in Caenorhabditis elegans. All these domains are grouped under the term NB-ARC.

3 & 4/ Two other domains, called “TIR” and “CC” (or “LZ”), less frequent in the identified R genes, can be associated, in the N-terminal position, with the NBS-LRR products. The TIR (“Toll Interleukin Receptor”) domain has significant sequence similarities with the isolated intracellular protein receptor domains of drosophila (Toll receptor) and human beings (Interleukin-1 receptor). Based on these similarities, a role in the cellular signalling cascade is assigned to the TIR domain. The CC (“Coiled-Coil”) or LZ (“Leucine-Zipper”) domain, which can vary in size and position, is known to perform a role in the homodimerisation or heterodimerisation of proteins.

5/ Lastly, the Serine/Threonine kinase domain is present on its own (for example Pto gene product) or associated with an LRR domain (for example Xa21 gene product). It may be involved in phosphorylation reactions during signalling cascades.

In most cases, during an incompatible interaction, with the very active defence, leading to a resistance situation, a whole series of events is implemented following the detection of the pathogen by the plant.

The entire metabolism of the infected cells is utilised and brings into play many mechanisms whose function is to destroy and trap the parasites: G proteins, ion flows, in particular Ca₂⁺, H⁺, K⁺ and Cl⁻, active forms of oxygen (or ROS, “Reactive Oxygen Species”) and a whole protein phosphorylation/dephosphorylation cascade, such as the MAPKs (“Mitogen-Activated Protein Kinase”).

Most of the time, this outpouring of signals is reflected phenotypically by the quick death of the cells infected with the pathogen, and the formation of necrotic lesions localised around the penetration site of the parasite. This genetically deterministic reaction is referred to as a hypersensitivity reaction (or “HR”) or apoptosis (programmed cell death).

The major metabolic changes making it possible to confine the attacker to its penetration site are the result of the expression of many defence genes at the location of the infected area. The cell death (“HR”) also generates signals that activate states known as “locally acquired resistance” (LAR), next to the lesions, and “systemic acquired resistance” (SAR), at a distance from the infection site.

When LAR is established, the defence responses are intense and, more particularly, localised in the ring of cells surrounding the HR area. These responses include the synthesis of a broad spectrum of anti-microbial compounds such as “PR” proteins (Pathogenesis Related Proteins), some secondary metabolites with antibiotic properties, e.g., phytoalexins, and also the accumulation of molecules playing a role in the signalling pathways, in particular the ROS and various hormones, including salicylic acid. These two levels of local resistance (HR and LAR) are accompanied by a resistance established at the level of the plant, the SAR, whose expression, slower and less intense, can continue for several weeks after the infection. The SAR keeps the plant in a state of alert that allows it to resist not only the original attacker but also a large range of other parasites that can subsequently intervene.

The establishment of SAR, in non-infected tissues, depends on an elaborate intercellular communication network. Signals released by the cells expressing the HR are transmitted and reach other cells which, in their turn, trigger a specific response. Salicylic acid, ethylene, jasmonic acid, and systemic have been recognised as chemical messengers participating in this signalling. These messengers alert the uninfected cells and direct their metabolism towards the establishment of defence responses, in particular strengthening of the cell wall, stimulation of the secondary metabolism pathways (enzymes for phenylpropanoid metabolism and the biosynthesis pathway of ethylene and jasmonic acid) and the accumulation of proteins.

The reactive oxygen species (ROS) are formed in the cells as the result of many processes, biotic or abiotic stresses, redox imbalances, actions or syntheses of hormones, growth, programmed cell death, etc. These molecules are generally produced by specific enzymes (electronic transport chain, peroxidases) in the organelles such as the chloroplast, in the cytoplasm or the periplasm, and can be the consequence of cellular dysfunctions. The ROS reactive oxygen species are at the origin of a cell signalling system, and their concentration and their influence on the cellular metabolism are governed by protection mechanisms such as the dissipation of excess light energy in the photosynthetic membrane, or the action of enzymes (superoxide dismutase, peroxidases, catalases). Their localisation, as well as the extent and duration of their production, and their stability over time determine the specific features of the cellular response (compatibility or incompatibility and type of response).

In the framework of a gene-for-gene relationship (resistance of the plant to the pathogens), the early triggering of a ROS (Reactive Oxygen Species) oxidative burst acts in the first line of the defence mechanisms. Directly toxic to the pathogen at its point of penetration, it acts both in terms of cellular necrosis (apoptosis) and in the signalling.

In the framework of the pathogen resistance of plants, several forms of reactive oxygen species (O2·−, H2O2, OH−·) are known to be involved in the lipid peroxidation of the plant's plasma membrane, leading to cell destructuration and death, also generating molecular signals that will be involved in the activation of defensive responses. O2·− is a reactive and unstable form of oxygen that is essential in the metabolic cascade inducing the pathogen defence mechanisms of plants. In general, the presence of an oxidative burst following an infection is the sign of the plant's state of resistance to its attacker.

In this context, the NADPH/NADH oxidase complexes are known to be a major source of the ROS reactive oxygen species in the plants (anion superoxide). Other enzymes are also known, in plants or mammals, to be at the origin of oxidative bursts, such as lipoxygenases, oxalate-oxidases, xanthine oxidases, or peroxidases (they trigger the ROS generation).

The local resistance (LR or RL) to pathogens is generally accompanied by high levels of salicylic acid. The salicylic acid plays a central role in the signalling leading to the induction of defence mechanisms, and plays an important role in the effectiveness of the local resistance. The injection (by human beings) of salicylic acid generally induces the activation of the same genes as in the framework of an incompatible plant/pathogen relationship.

It is also recognised that ethylene is produced in the framework of interactions between plants and pathogens in many species. It is well known that a large production of ethylene is generated after the first steps of the initiation of the hypersensitivity reaction and can induce the expression of genes linked to defence. It has long been known that the ethylene treatment of plants increases the sensitivity or resistance, depending on the plant-pathogen interaction and the conditions of the interaction. More recently, the availability of mutant plants of Arabidopsis thaliana affected by the production or signalling of ethylene has made a more functional study of the role of this phytohormone possible. However, contradictory results have been obtained, showing in some cases that ethylene can act as avirulence factor (i.e., increase in the effects of the attack) of bacterial and fungal pathogens and, in other cases, indicating its involvement as a signalling compound in the resistance to diseases. These contrasted effects may be due to the fact that, during phytopathogen interactions, the ethylene regulates the programmed cell death, which is observed during both the HR and the development of the disease. The effects of ethylene in cells at different stages of the infection and at different distances from pathogen inoculation sites may also differ greatly. Lastly, as mentioned above, ethylene acts in concert with the signalling molecules, such as the antagonistic interactions described between SA and JA/ethylene or the synergistic action of SA and ethylene.

Jasmonic acid, considered a phytohormone, and its methyl ester also act in the induction of defence mechanisms. For example, an increase can be observed in the expression of several genes coding proteins that reduce the digestibility of the tissue attacked by insects. These defensive proteins, produced by the plants, inhibit in particular the activity of proteases, digestive enzymes of herbivorous insects.

Jasmonic acid, synthesised from linoleic acid, regulates not only the development and growth of plants but also the activity of metabolites in the defence systems of plants. Accumulated in wounded plants, it activates many genes that code proteins having antifungal properties. It can also be metabolised into a volatile compound, methyl jasmonate, an important diffusible molecule in intra- and interplant communications. The enzymes in the biosynthesis and metabolism of jasmonic acid (JA) may have a regulatory function in controlling the activity and content of various signalling molecules in the plant's development and adaptation to environmental stresses.

### Phytoviruses:

A phytovirus, or plant virus, is a virus that attacks plant organisms. These viruses have the particularity of penetrating the plant cell of their host in order to hijack the cell's mechanisms to their benefit and allow them to reproduce.

Among the viruses infecting plants, those whose genome consists of one or more single-stranded RNA molecules of messenger polarity (“positive”) are the most important, because of both their frequency (85-90% of known viruses) and their economic impact. Even though their morphologies differ, many of these viruses have a very simple structure, the non-enveloped particles being constituted of one or several (2 or 3) types of subunits of capsid protein (CP).

Plants may employ RNA interference, or RNAi, to defend themselves against many viruses. During their replication phase, the RNA viruses pass through a double-strand RNA (dsRNA) stage that is recognised by the plant as an alert signal and makes it possible for its defence system to be actuated, which may lead to the viruses being eliminated. For most RNA viruses, an effective antiviral RNAi response draws mainly on the activity of the DICER-LIKE4 (“DCL4”) protein to produce the majority of the antiviral “interfering” RNAs (siRNA) from the dsRNA. These are associated with an ARGONAUTE (“AGO”) protein, to guide the protein to the viral RNA, leading to its cleavage.

Phytoviruses possess several distinguishing features:

1/ Unlike other pathogens, viral populations have a very high potential to evolve. This rapid evolution leads to the emergence of viral variants able to circumvent plant genetic resistance.

2/ Viral infections of plants are incurable by chemical means once the disease is established in a field, with no known effective remedy. The infected sensitive plants will keep the virus in their tissues until they die.

3/ It is the host cells that are responsible for the proliferation of the viruses parasitising them. Phytoviruses can infect all parts of a plant. Only the meristems (undifferentiated cells) of the buds escape their invasion. They are most often the cause of generalised diseases.

4/ Viruses can only survive in a living plant. They are destroyed as soon as the plant dies. They also require external agents to spread from one plant to another.

Even within the virus/plant interaction, very specific mechanisms are implemented, different from the metabolic events occurring in the other plant/pathogen interactions (bacteria, mushrooms, etc.).

Thus, phytoviruses are major pathogens found in crops worldwide. Among emerging infectious diseases, viruses alone represent almost half of the pathogens involved, i.e. 47% compared to 30% for mushrooms, and only 16% for bacteria.

In this context, currently the deployment of plant varieties carrying resistance genes against phytoviruses remains the most effective approach to controlling these viral pathogens, so as to use the plant's existing defence machinery already in place. One of the main criteria for the breeders remains obtaining varieties having durable resistance, i.e., which remains effective over a long period when the variety is grown intensively in an environment conducive to the development of the disease.

### Bacterial and Fungal Plant Pathogens

A variety of other pathogens are known to damage plant crops, for example Xylella fastidiosa bacteria, which are known to infect, for example:
Myrtle-leaf milkwort,
Grape vines,
Olive trees,
Citrus trees,
oleander,
Almond trees,
Coffee trees,
Peach trees and stone fruit trees,
Oak trees,
Lavender,
Rosemary, and
Broom.

Further, plants of the Actinidia genus can be infected by Pseudomonas syringae pv actinidiae bacteria.

Further, trees can be infected by Xantomonas arboricola pv juglandis bacteria, in particular walnut trees; or by Xanthomonas arboricola pv. pruni bacteria, especially Prunus spp., and in particular fruit/nut trees such as apricot trees, almond trees, cherry trees, peach trees, plum trees, P. salicina, cherry laurel and other exotic or ornamental Prunus species, including P. davidiana and P. laurocerasus.

Further, pear trees can be infected by Pear Decline phytoplasma bacteria or Candidatus phytoplasma pyri.

Further, Candidatus phytoplasma solani bacteria can attack grape vines, lavender, potato plants, tomato plants, aubergine plants, pepper plants and tobacco plants.

Further, grape vines can be attacked by downy mildew (Plasmapora viticola), as well as potato plants and tomato plants (infected by Phytophtora infestans), citrus trees (infected by Phytophtora citrophtora), pear trees and apple trees (infected by Phytophtora cactorum), or artichokes (infected by Bremia lactucae).

Further, rose bushes and grape vines can be attacked by powdery mildew (oidium), fungi respectively known as Podosphaera pannosa and Erysiphe necator, formerly Uncinula necator, and also tomato plants, lettuces, cucumbers, strawberry plants, raspberry plants, currant bushes, peach trees, pear trees, privet, carnations infected by oidium.

The present invention also relates to the use of 1,3-thiazepane-2-thione for stimulating the defences of plants and trees against pathogens, in particular bacteria, viruses and mushrooms, and associated composition and methods. The present invention aims to reduce the effects of an attack by such a pathogen on a plant, including a tree, in order to, at least, enable the plant or tree to continue to grow properly despite this infection, surpassing the disease, i.e. by allowing the plant or the tree to develop despite the pathogen, by reducing or eliminating the impact of the pathogen. 1,3-thiazepane-2-thione, synthesised or extracted from a source plant, can also, in certain use cases, allow the plant that is the target of the attack to eradicate certain pathogens. This use can be curative or preventive.

In crop protection, the future no longer lies with synthetic pesticides. They will have to be progressively replaced by more natural products, able to resist pathogens while avoiding the well-known adverse effects of toxicity and damage to the environment. Society is increasingly reluctant to bear their heavy ecological and health costs.

Social and regulatory pressure to reduce the use of chemical pesticides continues to rise. Many farmers seek products that are more environmentally friendly, sustainably applicable in new agricultural schemes, simple to use and contributing to a positive image for their produce. Increasingly, consumers want wholesome food, without the harmful impacts of pesticides that have become known in recent years.

The present invention also concerns a biostimulant, a use of crushed material obtained from Rocket plant, for example of the genera Eruca (Eruca sativa, Eruca vesicaria, etc), Diplotaxis (Diplotaxis erucoides, Diplotaxis tenuifolia, Diplotaxis muralis, etc), Bunias (Bunias erucago, Bunias orientalis, etc), Erucastrum (Erucastrum nasturtiifolium, Erucastrum incanum, etc) or Cakile (Cakile maritima, etc), in order to promote plant growth or root growth, and a method for speeding up the growth of a plant.

The present invention applies, in particular, to promoting plant growth (increasing the biomass of plants in general, and/or increasing the size of plants, and/or increasing the size of the fruit, and/or increasing the weight of the fruit), as well as the precocity of plant growth (earlier flowering, and/or appearance of fruit, and/or physiological stages in general). The present invention applies to agriculture in general, gardening, horticulture, arboriculture, etc.

The usefulness of the product of the invention has also been proven in conditions of stress for the plant (for example water stress).

The invention particularly relates to the field of cultivated plants, in particular in fields, and to the prevention of the harmful effects linked to exposure to water stress in said cultivated plants, in particular the loss of dry matter, i.e., per hectare, and the decrease in yield. Thus, the invention also relates to a biostimulant and a method of preventive or curative treatment of a plant in cultivation to limit the loss of dry matter linked to water stress.

The invention also particularly relates to the field of cultivated plants, in particular in fields, and to the prevention of the harmful effects linked to exposure to water stress in said cultivated plants, in particular the loss of dry matter, i.e., per hectare, and the decrease in yield. Thus, the invention also relates to a biostimulant and a method of preventive or curative treatment of a plant in cultivation to limit the loss of dry matter linked to water stress.

Plants, that is to say crops, trees and ornamental plants or trees, are subjected to various stresses. In particular, plants are constantly exposed to their environment and cannot escape water stressors (drought, heat, salinity, etc.). These water stresses cause morphological, physiological, biochemical and molecular changes in plants, resulting in a reduction in the yield per hectare of crops, i.e., a reduction in the production of dried material. In other words, a plant cultivated, for example in fields, is subjected to these various stresses having in particular the effect of a decrease in the production of dry matter by the plant compared to a plant cultivated under optimal conditions (controlled conditions of water intake, day/night period, no exposure to water stress). To fight against water stress (or drought), farmers use extensive irrigation of crops, which creates ecological and economic problems. Consequently, one of the problems which the invention proposes to solve is that of developing a biostimulant and a method for treating a plant in order to effectively reduce the loss of dry matter induced by exposure to water stress.

It has to be noted that there is a real difference between growth, as such, and resistance to water stress, since the mechanisms of protection of the plant from heat or drought and those of its growth are not identical (closure of stomata, brake of sap circulation, vs. cell multiplication and elongation, respectively).

### SUMMARY OF THE INVENTION

The described embodiments aim to remedy all or part of these drawbacks.

To this end, according to a first aspect, the present invention envisages an elicitor composition as described herein.

The action of this composition circumvents the pathogen resistance. Circumvention of a resistance is expressed in time by the emergence and spread of a virulent variant at the level of the cell and then of the plant, to finish at the scale of the entire plot. According to the definition by plant pathologists, the virulence of a pathogen refers to the qualitative component of the pathogenicity, i.e., the ability or not to infect a genotype carrying a given resistance. The evolutionary forces will be heavily involved in the appearance of virulent variants that do not already exist naturally in an agroecosystem. The genetic variations will therefore be linked to variations/mutations in the AVR genes: The first step is the appearance at the cell level of a virulent variant able to infect a plant having a resistance gene in the case of gene-for-gene-like interaction. This means that it accumulates the necessary mutations in its avirulence factor to become virulent.

It has been shown that the composition that is the subject of the invention, preferably in its form extracted from a rocket plant, in particular Eruca sativa and Diplotaxis tenuifolia, acts very early after spraying, showing that this composition imitates the gene-for-gene relationship. For example, thirty minutes after spraying, the preferred composition leads to a series of metabolic events which show that the defence mechanisms triggered are similar to those described in a gene-for-gene relationship:

1/ The production of reactive oxygen forms (FAO or ROS), in the 30 minutes following foliar spraying on Arabidopsis thaliana. The transient production of reactive oxygen species or forms (ROS) constitutes one of the earliest responses following the gene-for-gene recognition of a pathogen by the plant. These activated forms of oxygen are produced in the first minutes, even several hours, after elicitation. They consist essentially of (O₂), (OH) and (H₂O₂). The significant accumulation of these molecules, commonly called an “oxidative burst”, is often correlated to the control of the cell proliferation and cell death, development of plants, and induction of the defence responses. In the case of the response to pathogens, these reactive oxygen forms play a role simultaneously of antimicrobial compounds, in the strengthening of the cell wall and in the signalling. The changes in the redox potential are incorporated by the cell, which is expressed by the activation of genetic programmes leading to the establishment of the HR.

2/ The release of intercellular signals (phytohormones such as salicylic acid, jasmonic acid, ethylene) to cells adjacent to infection sites bearing on an immunisation and an increase in their resistance (LAR, for “Local Acquired Resistance”) in the peach tree infected by the bacteriosis, and treated by the preferred composition.

3/ The immunisation of the entire plant (SAR, for “Systemic Acquired Resistance”) and the phenomenon of potentiation during a second attack by a parasite when the plant has been treated beforehand with this composition.

4/ The production of B-1,3 glucanase (PR2 Proteins) starting ten hours after spraying with the preferred composition.

This composition, which is the subject of the invention, is therefore able to act independently of the structure of the products of Resistance and Avirulence genes, making it possible to overcome any mutation of the virus.

In conclusion, while the interaction between plants and viruses is very specific and different from other plant/parasite interactions (no possible chemical solution), it has been shown that the composition that is the subject of the invention acts effectively against viruses, acting very early and stimulating a gene-for-gene interaction, which allows the plant to overcome all the weaknesses of a plant with regard to a virus (too-rapid emergence of variants, replication of the virus, etc.).

Given the rapid evolution of viruses and other pathogens, this composition puts the plants in a state of resistance, acting after the interaction between the R and AVR genes, to short-circuit the possible mutations of the pathogen. Therefore, the composition that is the subject of the invention has the ability to trigger all the defence mechanisms appearing “after” or downstream of a phenomenon of “gene-for-gene” recognition, for both viruses and the other pathogens, in particular bacteria and fungi (e.g., mushrooms).

The effectiveness of the present invention aims to reduce the effects of pathogens on vegetables, plants or trees, in order to enable the plant, especially a tree, to continue to grow properly despite this attack, overcoming the consequences of this attack, i.e. by allowing the plant or tree to develop despite the pathogen, by reducing or eliminating the impact of the pathogens. The plant extract can also, in certain use cases, allow the plant to eradicate certain pathogens. This use can be curative or preventive.

Note that the reduction of the effects of pathogens on the host plants or trees includes, in certain cases, the total or partial reduction of the symptoms. This is because, when their defence system is functioning (in particular thanks to the stimulation obtained by utilising the invention), the plants and trees have the ability to defeat a pathogen. The use of the composition that is the subject of the present invention aims to stimulate what the plants can already do, but fail to do in the case of “sensitivity” because they don't recognise their attacker. The decrease in pathology thus appears in some examples of the description.

In some preferred embodiments, the extract is obtained from at least one of the following plants: Rockets, including Eruca sativa, Diplotaxis, Erucastrum and Bunias, Cakile, broccoli, plants of the Allium genera (garlic, onion, shallot, leek or chive), common cabbage (Brassica oleracea), cauliflower, Brussels sprouts, kale, mustard, wasabi, watercress, horseradish, white cabbage, field mustard (Brassica rapa), including bok choi, Chinese cabbage and turnip, kohlrabi, collard, red cabbage, Chinese broccoli, broccoli rabe, colza, radish, Siberian wallflower, wallflower, Indian cress, hedge garlic, hedge mustard, papaya, especially its fruit.

An elicitor composition that is the subject of the invention can comprise a total crude extract obtained by grinding and extraction from the plant, a fraction enriched in the active compound(s) of such a total extract, or one or more active compound(s) in a mixture. Such a composition advantageously makes it possible, in an effective amount in a composition, to combat the symptoms of the attack on a plant or tree mentioned above by a pathogen mentioned above.

In some preferred embodiments, the extract is obtained from at least one of the following plants: Rockets, including Eruca sativa, Diplotaxis, Erucastrum and Bunias, Cakile, broccoli, common cabbage (Brassica oleracea), cauliflower, Brussels sprouts, kale, mustard, watercress, white cabbage, field mustard (Brassica rapa), including bok choi, Chinese cabbage and turnip, kohlrabi, collard, red cabbage, Chinese broccoli, broccoli rabe, radish and Siberian wallflower.

In some preferred embodiments, the extract is obtained from at least one of the following plants:
Rockets, including Eruca sativa, Diplotaxis, Erucastrum and Bunias,
Cakile.

In some preferred embodiments, the extract is obtained from at least one of the plants of the species Brassica oleracea.

In some preferred embodiments, the extract is obtained from at least one plant not containing the precursors of Methyl-isothiocyanate and/or Propenyl isothiocyanate.

The inventor has observed that these isothiocyanates may have adverse effects on the plant's growth, while reducing the effects of viruses and other pathogens.

In some embodiments, the extract is obtained from at least one plant containing precursors of butyl-isothiocyanate. The inventor has observed that these isothiocyanates have beneficial effects on the plant's growth, while reducing the effects of viruses and other pathogens.

In some embodiments, the extract is obtained from a plant containing precursors of 1,3-thiazepane-2-thione. The inventor has observed that this compound, because of its structure, is not an isothiocyanate, having beneficial effects on the plant's growth while reducing the effects of viruses and other pathogens.

The inventor has discovered that these extracts have at least one active substance that reduces the effects of a pathogen, the presence of their diffusion vector and/or their colonisation by insects.

In some embodiments, the extract of at least one plant part is an extract obtained from ground material of said plants, and:
said extract of at least one plant part comprises at least the leaves of said plants, preferably mainly leaves and flowers, and
the method making it possible to obtain said liquid extract comprises the following steps:
a) a step of grinding said plants;
b) filtering the ground material obtained; and
c) recovering the liquid extract obtained after filtering.

Here, the term “mainly comprises” means including at least 75%, preferably at least 95%, of leaves and flowers of said plants by weight, for example dry, relative to the total plant weight, before mixing with the aqueous solvent.

In some embodiments, the extract is obtained by a method also comprising a step of nebulising the liquid extract and passing the nebulised liquid extract in a flow of hot air.

According to a second aspect, the present invention relates to a method of reducing the effects of viruses on plants, including trees, comprising a step of applying the elicitor composition that is the subject of the invention.

In some embodiments, the method is applied to reduce the effects of an attack by one of the following viruses:
Beet yellowing viruses,
Tobacco mosaic virus,
Cassava mosaic virus,
Banana Bunchy Top Virus (BBTV),
Banana streak virus (BSV),
Barley yellows dwarf virus (BYDV),
Cucumber mosaic virus,
Sugarcane mosaic virus (SCMV),
Maize lethal necrosis (MLN) disease viruses (maize chlorotic mottle virus (MCMV) and sugarcane mosaic virus (SCMV)),
Potyviridae virus family,
Sweet potato feathery mottle virus (Potyvirus), or SPFMV,
Sweet potato chlorotic stunt virus (Crinivirus), or SPCSV and SPVD,
Sweet potato mild mottle virus, or SPMMV,
Sweet potato latent virus, or SPLV,
Sweet potato chlorotic fleck virus, or SPCFV,
Sweet potato virus G, or SPVG,
Sweet potato leaf curl virus, or SPLCV,
Tomato brown rugose fruit virus (ToBRFV),
Tomato spotted wilt virus, or TSWV,
Tomato mosaic virus, or ToMV,
Zucchini yellow mosaic virus, or ZYMV,
Rose mosaic virus.

In some embodiments, the method is applied to reduce the effects of an attack by at least one of the beet yellowing viruses.

In some embodiments, the method is applied to reduce the effects of an attack by at least one of the cucumber mosaic viruses.

In some embodiments, the method is applied to reduce the effects of an attack by one of the following bacteria:
Xylella fastidiosa
Pseudomonas syringae pv actinidiae bacteria
Xantomonas arboricola pv juglandis
Xanthomonas arboricola pv. pruni bacteria
phytoplasma bacteria
Candidatus phytoplasma pyri
Candidatus phytoplasma solani bacteria

In some embodiments, the method is applied to reduce the effects of one of the following bacterium-host combinations:
Xylella fastidiosa bacteria on myrtle-leaf milkwort, grape vines, olive trees, citrus trees, oleander, almond trees, coffee trees, peach trees and stone fruit trees, oak trees, lavender, rosemary, or broom,
Pseudomonas syringae pv actinidiae bacteria on plants of the Actinidia genus,
Xantomonas arboricola pv juglandis bacteria on walnut trees,
Xanthomonas arboricola pv. pruni bacteria on Prunus spp., and preferably the following group of fruit/nut trees: apricot trees, almond trees, cherry trees, peach trees, plum trees, P. salicina, cherry laurel and other exotic or ornamental Prunus species, including P. davidiana and P. laurocerasus,
Pear Decline phytoplasma bacteria or Candidatus phytoplasma pyri on pear trees,
Candidatus phytoplasma solani bacteria on grape vines, lavender, potato plants, tomato plants, aubergine plants, pepper plants and tobacco plants,
Plasmapora viticola fungus on grape vines, or Phytophtora infestans on potato plants and tomato plants, or Phytophtora citrophtora on citrus trees, or Phytophtora cactorum on pear trees and apple trees, or Bremia lactucae on artichokes. All these pathogenic fungi are responsible for mildew, or
oidium-type fungi such as Podosphaera pannosa on rose bushes, and Erysiphe necator, formerly Uncinula necator, on grape vines, and oidia on tomato plants, lettuces, cucumbers, strawberry plants, raspberry plants, currant bushes, peach trees, pear trees, privet, carnations.

In some embodiments, the method is applied to reduce the effects of an attack by a fungus.

In some embodiments, the method is applied to reduce the effects of an attack by a nematode.

In some embodiments, the application of the elicitor composition is a foliar application on the plants.

According to a third aspect, the invention relates to using the elicitor composition that is the subject of the invention for reducing on plants, including trees, the effects of an attack by one of the viruses listed above.

In some embodiments, the application on the plant or tree is achieved by foliar spray, drop-by-drop irrigation, hydroponic cultivation, seed treatment and/or seed coating.

In some embodiments, the application on the plant or tree is achieved with a dilution of the composition in water between 2 g/L and 2000 g/L expressed in grammes of plants on which the extraction was carried out per litre of product.

In some embodiments, the application on the plant or tree is achieved with a dilution of the composition in water between 5 g/L and 200 g/L expressed in grammes of plants on which the extraction was carried out per litre of product.

In some embodiments, said extract of at least one plant part is an extract obtained from ground material of said plants.

In some embodiments, the application on the plant or tree is achieved by foliar spray, drop-by-drop irrigation, hydroponic cultivation, seed treatment and/or seed coating.

In some embodiments, at least one active principle is obtained from leaves of said plants.

In some embodiments, at least one active principle is obtained from flowers of said plants.

In some embodiments, at least one active principle is obtained by grinding at least one part of said plants.

In some embodiments, at least one active principle is obtained by aqueous extraction.

In some embodiments, at least one active principle is obtained by oil extraction, solvent extraction, or by extraction of oil cakes or pastes.

In some embodiments, the composition is formulated in the form of powder, soluble powder, wettable powder, granules, dispersible granules, wettable granules or slow-diffusion granules, to be diluted in water at the time of use.

In some embodiments, the composition is formulated in the form of a liquid, soluble concentrated liquid, emulsifiable concentrate, concentrated suspension, or ready-to-use.

According to a fourth aspect, the present invention relates to a method for producing a composition that is the subject of the invention, comprising a step of grinding at least one part of said plants, to provide ground material, and a filtering step to extract solid parts from said ground material and obtain a liquid.

As the particular features, advantages and aims of this composition and this method are similar to those of the composition that is the subject of the present invention, they are not repeated here.

According to a fifth aspect, the present invention relates to a method for the physical simulation of the gene-for-gene interaction, a composition that can be extracted by aqueous extraction from a given plant in the claimed lists, especially from a rocket plant, and particularly from Eruca sativa or Diplotaxis types, or from plants genetically modified to produce this composition.

Thus, the method and the composition that are the subject of the invention carry out an action on the plant in the hours, even in less than one hour, after the gene-for-gene interaction with the virus or its variant, thereby avoiding the problem of mutations, and providing a response that immediately strengthens the resistances of the plants treated against viruses, bacteria, mushrooms and other pathogens.

Therefore, while the interaction between plants and viruses is very specific and different from other plant/parasite interactions, since no chemical solution is possible, it has been shown that the composition that is the subject of the invention, especially in its form extracted from rocket plants, in particular from Eruca sativa or Diplotaxis tenuifolia, acts effectively against viruses, acting very early and stimulating a gene-for-gene interaction, which allows the plant to overcome all the weaknesses of a plant with regard to a virus (too-rapid emergence of variants, replication of the virus, etc.) and, more generally, to a pathogen.

The particular features, advantages and aims of other aspects of the invention, especially those that are claimed, also apply to this method and this composition and to the use of this composition to simulate, in a plant whose resistances must be stimulated, a gene-for-gene interaction.

According to a sixth aspect, the present invention relates to an elicitor composition stimulating the defences of the plants and trees, reducing the effects of an attack by a pathogen, which composition comprises 1,3-thiazepane-2-thione.

The present invention reduces the effects of pathogens on vegetables, plants including trees, in order to enable the plant to continue to grow properly despite this attack, overcoming the consequences of this attack, i.e. by allowing the plant or the tree to develop despite the pathogen, by reducing or eliminating the impact of this pathogen. This use can be curative or preventive.

Note that 1,3-thiazepane-2-thione is not an isothiocyanate, since it does not include the isothiocyanate group, i.e. the —N═C═S group. On the contrary, it consists of a cyclised structure described in FIG. 24. 1,3-thiazepane-2-thione is a relatively stable compound, even under heat treatment.

Two main characteristics distinguish thiones (or thioketones) from other carbonyls: because of the higher energies of the p-orbitals of the sulphur, the thiocarbonyl group is more reactive and tends to form oligomers, except in specific cases such as for thiobenzophenone. In addition, the double bond between carbon and sulphur is less polarised because of a smaller difference in electronegativity between these two atoms. This reduces selectivity in the event of nucleophilic addition. Note that thiones are generally more stable than thioaldehydes. Their synthesis can be carried out by thionation: the thionation of ketone compounds is the most common route for the synthesis of thiones. Lawesson's reagent is most commonly used for this type of reaction.

Because of its mechanism of action described below, the composition that is the subject of the invention has an effect of potentiation on the defences and resistances of universal plants for the pathogens triggering gene-for-gene recognition, whether these pathogens are viruses, bacteria or fungi, or other types of pathogens.

In some embodiments, the elicitor composition comprises 1,3-thiazepane-2-thione as the principle active compound.

In some embodiments, the elicitor composition comprises 1,3-thiazepane-2-thione as the only active compound.

In some embodiments, the elicitor composition stimulating the defences of plants and trees that is the subject of the invention reduces the effects of an attack by one of the following viruses:
Beet yellowing viruses,
Tobacco mosaic virus,
Cassava mosaic virus,
Banana Bunchy Top Virus (BBTV),
Banana streak virus (BSV),
Barley yellows dwarf virus (BYDV),
Cucumber mosaic virus,
Tomato brown rugose fruit virus (ToBRFV),
Sugarcane mosaic virus (SCMV),
Maize lethal necrosis (MLN) disease viruses (maize chlorotic mottle virus (MCMV) and sugarcane mosaic virus (SCMV)),
Potyviridae virus family,
Sweet potato feathery mottle virus (Potyvirus), or SPFMV,
Sweet potato chlorotic stunt virus (Crinivirus), or SPCSV and SPVD,
Sweet potato mild mottle virus, or SPMMV,
Sweet potato latent virus, or SPLV,
Sweet potato chlorotic fleck virus, or SPCFV,
Sweet potato virus G, or SPVG,
Sweet potato leaf curl virus, or SPLCV,
Tomato brown rugose fruit virus (ToBRFV),
Tomato spotted wilt virus, or TSWV,
Tomato mosaic virus, or ToMV,
Zucchini yellow mosaic virus, or ZYMV,
Rose mosaic virus.

In some embodiments, the elicitor composition stimulating the defences of plants and trees that is the subject of the invention reduces the effects of an attack:
plants and trees infected by Xylella fastidiosa bacteria, in particular the following plants and trees:
Myrtle-leaf milkwort,
Grape vines,
Olive trees,
Citrus trees,
oleander,
Almond trees,
Coffee trees,
Peach trees and stone fruit trees,
Oak trees,
Lavender,
Rosemary, and
Broom.
plants of the Actinidia genus infected by Pseudomonas syringae pv actinidiae bacteria,
trees infected by Xantomonas arboricola pv juglandis bacteria, in particular walnut trees, or by Xanthomonas arboricola pv. pruni bacteria, especially Prunus spp., and in particular fruit/nut trees such as apricot trees, almond trees, cherry trees, peach trees, plum trees, P. salicina, cherry laurel and other exotic or ornamental Prunus species, including P. davidiana and P. laurocerasus,
pear trees infected by Pear Decline phytoplasma bacteria or Candidatus phytoplasma pyri,
an attack by Candidatus phytoplasma solani bacteria on grape vines, lavender, potato plants, tomato plants, aubergine plants, pepper plants and tobacco plants,
grape vines attacked by downy mildew (Plasmapora viticola), as well as potato plants and tomato plants (infected by Phytophtora infestans), citrus trees (infected by Phytophtora citrophtora), pear trees and apple trees (infected by Phytophtora cactorum), or artichokes (infected by Bremia lactucae),
rose bushes and grape vines attacked by powdery mildew (oidium), fungi respectively known as Podosphaera pannosa and Erysiphe necator, formerly Uncinula necator, and also tomato plants, lettuces, cucumbers, strawberry plants, raspberry plants, currant bushes, peach trees, pear trees, privet, carnations infected by oidium,
citruses attacked by huanglongbing (HLB, or citrus greening), for which the bacterial agent presumed responsible is Candidatus liberibacter spp,
plants attacked by the fungus Phyllosticta citricarpa, also known as citrus black spot (CBS),
vines attacked by grapevine flavescence dorée,
pear trees, apple trees, quince trees or medlar trees attacked by Fire Blight.

Note that the reduction of the effects of pathogens on the plants or trees attacked by these pathogens comprises, in certain cases, the total or partial reduction of the symptoms. This is because, when their defence system is functioning (in particular thanks to the stimulation obtained by utilising the invention), the plants and trees have the ability to defeat a pathogen. The use of the composition that is the subject of the present invention aims to stimulate what the plants can already do, but fail to do in the case of “sensitivity” because they don't recognise their attacker. The decrease in pathology thus appears in some examples of the description.

In some embodiments, the method is applied to reduces the effects of an attack by at least one of the beet yellowing viruses.

In some embodiments, the elicitor composition stimulating the defences of the plants or trees that is the subject of the invention, reduces the effects of an attack by at least one of the cucumber mosaic viruses.

Preferably, 1,3-thiazepane-2-thione is obtained from at least one part of a Rocket plant, including Eruca sativa and Diplotaxis tenuifolia.

In some embodiments, 1,3-thiazepane-2-thione is obtained from ground material of the rocket plant, and:
said extract of at least one part of rocket plants comprises at least the leaves of said plants, preferably mainly leaves and flowers; and
the method making it possible to obtain said liquid extract comprises the following steps:
a) a step of grinding said rocket plants in an aqueous medium;
b) filtering the ground material obtained; and
c) recovering the liquid extract obtained after filtering.

Here, the term “mainly comprises” means including at least 75%, preferably at least 95%, of leaves and flowers of said plants by weight, for example dry, relative to the total plant weight, before mixing with the aqueous solvent.

In some embodiments, the elicitor composition comprises 1,3-thiazepane-2-thione obtained by thionation.

In some embodiments, the elicitor composition comprises 1,3-thiazepane-2-thione obtained by aqueous extraction from at least one of the plants of the species Brassica oleracea.

In some embodiments, the application on the plant or tree is achieved by foliar spray, drop-by-drop irrigation, hydroponic cultivation, seed treatment and/or seed coating.

In some embodiments, the application on the plant or tree is achieved with a dilution of the composition in water between 2 g/L and 2000 g/L expressed in grammes of plants on which the extraction was carried out per litre of product.

In some embodiments, the application on the plant or tree is achieved with a dilution of the composition in water between 5 g/L and 200 g/L expressed in grammes of plants on which the extraction was carried out per litre of product.

In some embodiments, said extract of at least one plant part is an extract obtained from ground material of said plants.

In some embodiments, the application on the plant or tree is achieved by foliar spray, drop-by-drop irrigation, hydroponic cultivation, seed treatment and/or seed coating.

In some embodiments, at least one active principle is obtained from leaves of said plants.

In some embodiments, at least one active principle is obtained from flowers of said plants.

In some embodiments, at least one active principle is obtained by grinding at least one part of said plants.

In some embodiments, at least one active principle is obtained by aqueous extraction.

In some embodiments, at least one active principle is obtained by oil extraction, solvent extraction, or by extraction of oil cakes or pastes.

In some embodiments, 1,3-thiazepane-2-thione is a synthesised product.

In some embodiments, the composition is formulated in the form of powder, soluble powder, wettable powder, granules, dispersible granules, wettable granules or slow-diffusion granules, to be diluted in water at the time of use.

In some embodiments, the composition is formulated in the form of a liquid, soluble concentrated liquid, emulsifiable concentrate, concentrated suspension, or ready-to-use.

According to a seventh aspect, the present invention relates to a use of the elicitor composition that is the subject of the invention for reducing the effects of pathogens on the plants, including trees.

According to a eighth aspect, the present invention relates to a method of reducing the effects of pathogens on plants, including trees, comprising a step of applying the elicitor composition that is the subject of the invention on said plant.

According to a ninth aspect, the present invention relates to a method for producing a composition that is the subject of the invention, comprising a step of grinding at least one part of said plants, to provide ground material, and a filtering step to extract solid parts from said ground material and obtain a liquid.

As the particular features, advantages and aims of this composition and this method are similar to those of the composition that is the subject of the present invention, they are not repeated here.

According to a tenth aspect, the present invention relates to a method for the physical simulation of the gene-for-gene interaction by applying to the plant a composition comprising 1,3-thiazepane-2-thione. Thus, the method and the composition that are the subject of the invention carry out an action on the plant in the hours, even in less than one hour, after the gene-for-gene interaction with the virus or its variant, thereby avoiding the problem of mutations in the case of viruses, and providing a response that immediately strengthens the resistances of the plants treated against viruses, bacteria, fungi and other pathogens.

While the interaction between plants and viruses is very specific and different from other plant/parasite interactions, since there is no possible chemical solution, it has been shown that the composition that is the subject of the invention acts effectively against the pathogens, acting very early and stimulating a gene-for-gene interaction, which allows the plant to overcome all the weaknesses of a plant with regard to a virus (too-rapid emergence of variants, replication of the virus, etc.) and, more generally, to a pathogen.

The particular features, advantages and aims of other aspects of the invention, especially those that are claimed, also apply to this method and this composition and to the use of this composition to simulate, in a plant whose resistances must be stimulated, a gene-for-gene interaction.

The present invention also aims to find an effective solution for stimulating the growth of plants and their root development, thanks to a plant extract based on plants from the genus Rocket, which presents no hazardous toxicological profile, and respects the environment and all life forms.

To this end, according to an eleventh aspect, the present invention envisages a biostimulant that is the subject of claim 1, a use of crushed material that is the subject of claim 14, and a method for speeding up the growth of a plant that is the subject of claim 15.

It is noted here that rocket (“Eruca sativa”) is an annual plant of the Brassicaceae (or Cruciferae) family, with white or yellowish flowers veined with brown or purple, whose generally elongated, pinnately incised leaves have a pungent peppery flavor. Depending on the region, it is also known as rucola, arugula, rouquette or riquette. Riquette is a wild form of rocket with very tasty small leaves. Other related plants, from the genus Diplotaxis, are called rocket. When they need to be differentiated, Diplotaxis rockets are called “wild rocket” and Eruca rockets “garden rocket”. The present invention is not restricted to these rocket species, and extends beyond Eruca sativa. Rocket's description can also vary depending on its origin and regions. It is noted that common names for rocket plants also include Rucola and Arugula.

Preferably, the Rocket utilized by the present invention is of the genera Eruca (Eruca sativa, Eruca vesicaria, etc), Diplotaxis (Diplotaxis erucoides, Diplotaxis tenuifolia, Diplotaxis muralis, etc), Bunias (Bunias erucago, Bunias orientalis, etc), Erucastrum (Erucastrum nasturtiifolium, Erucastrum incanum, etc) or Cakile (Cakile maritima, etc). For the purposes of the present invention, Rocket comprises all these plants, possibly mixed. The Rocket plants mentioned belong to the Capparales order and to the Brassicaceae family . . . .

It is also noted that the active ingredient, or active substance, of a product for promoting a plant's development is all that product's ingredients that have a favorable effect on a plant's development.

Plant development comprises plant growth, including root growth, and the precocity of the plant in question.

Plant growth, for a plant, is all the plant's irreversible quantitative changes that occur over time. Growth is a datum that can be expressed as unit of length per unit of time, or as unit of mass per unit of time. Growth comprises, in particular, the lengthening of the internodes and roots, the multiplication of cells and/or their extension, and the growth of leaves.

Precocity refers to a living organism reaching its mature state more quickly than the average for the species under the same conditions (seasons, environmental parameters, etc). In plants, the precocity induced by the use of crushed material that is the subject of the present invention, can be measured/quantified by noting the appearance of different physiological stages (first leaves, first flowers, first fruit, etc) for the plants treated, compared to the physiological stages for plants of the same species that have not been treated by the use of crushed material that is the subject of the present invention.

The stimulation of root growth is characterized by a change in the root system (shortening or lengthening of the primary root, shortening or lengthening of the secondary roots, appearance of root hairs, etc). This stimulation by the use of crushed material that is the subject of the present invention can be measured by comparing the root system of treated and untreated plants.

Such a composition can consist of a total crude extract obtained by extraction from the plant of the genus Rocket, of a fraction enriched in the active compound(s) of such a total extract, or of one or a plurality of active compound(s) in a mixture. Such a composition advantageously makes it possible, when present in an effective amount, to speed up plant growth, in particular for lettuces, vegetables and other plants intended for human or animal consumption, and for ornamental plants, trees and shrubs.

In some embodiments, at least one active ingredient is obtained from leaves of plants from the genus rocket.

The inventor has discovered that the leaves of plants from the genus rocket contain particularly effective active ingredients for promoting plant growth.

In some embodiments, at least one active ingredient is obtained from seeds of plants from the genus rocket.

In some embodiments, at least one active ingredient is obtained from flowers of plants from the genus rocket.

In some embodiments, at least one active ingredient is obtained by grinding at least one part of plants from the genus rocket.

In some embodiments, at least one active ingredient is obtained by aqueous extraction solvent extraction, or by extraction of oil cakes or pastes. It is recalled here that oil cakes are the solid residue obtained after extracting oil from oleaginous seeds or fruit.

In some embodiments, the composition that is the subject of the present invention is formulated in the form of powder, granules, dispersible granules or slow-diffusion granules.

In some embodiments, the composition that is the subject of the present invention is formulated in liquid form.

According to a twelfth aspect, the present invention envisages a use of a composition that is the subject of the present invention for promoting plant growth or stimulating root growth.

According to a thirteenth aspect, the present invention envisages a method for speeding up the growth of a plant, comprising the application on said plant of a composition that is the subject of the present invention.

In some embodiments, the application on the plant is achieved by foliar spray, watering the soil, drop-by-drop irrigation, use in hydroponics, seed treatment and/or seed coating.

According to a fourteenth aspect, the present invention envisages a method for producing a composition, comprising a step of grinding at least one part of plants from the genus rocket to provide crushed material, and filtering solid portions of said crushed material to obtain a liquid.

As the particular features, advantages and aims of this use and of these methods are similar to those of the composition that is the subject of the present invention, they are not repeated here.

### BRIEF DESCRIPTION OF THE FIGURES

Other advantages, aims and features of the present invention will become apparent from the description that will follow, made, as a non-limiting example, with reference to the drawings included in an appendix, in which:

FIG. 1 shows, in the form of a logical diagram, steps in a particular embodiment of a method for producing and using ground material, which is a preferred example of the production of the composition that is the subject of the invention;

FIG. 2 shows the dates of evaluations of beet treatments;

FIG. 3 shows the numbers of Myzus persicae insects;

FIG. 4 shows the incidences of the Myzus persicae pest;

FIG. 5 shows the numbers of Aphis fabae insects;

FIG. 6 shows the incidences of the Aphis fabae pest;

FIG. 7 shows the evaluations of areas infected by the yellowing;

FIG. 8 shows a photograph of the untreated modality (control);

FIG. 9 shows a photograph of the modality treated with the PP1 product;

FIG. 10 shows a photograph of the modality treated with the PP1 product; and

FIG. 11 shows a descriptive table of the treatment modalities of the first Example.

FIG. 12 shows an effectiveness of the PP1 product against Pseudomonas syringae, 37 days after inoculation. The PP1 product was sprayed on the plants 8 days before the inoculation with Pseudomonas syringae. The controls were sprayed with water 8 days before inoculation.

FIG. 13 shows kinetics of the production of O₂⁻, in the Arabidopsis thaliana leaves, in response to infection with Pseudomonas syringae, to spraying with PP1, or to spraying with PP1 followed by inoculation with Pseudomonas syringae. The arrow corresponds to the time of the inoculation, when this was performed. PP1 was sprayed 24 hours before the experiment, when it was used in the modalities. The leaf disks were incubated in a cytochrome C medium, and the production of anion superoxide was measured periodically through the measurement of the reduction in cytochrome C. DPI (diphenyleneiodonium) was added to the reaction medium just before the immersion of leaf disks in the cytochrome C. Each value was the mean of 15 repetitions per plant.

FIG. 14 shows an oxidative activity of NADH in the crude extracts of Arabidopsis thaliana, in response to infection with Pseudomonas syringae, to spraying with PP1, or to spraying with PP1 followed by inoculation with Pseudomonas syringae. The arrow corresponds to the time of the inoculation, when this was performed. PP1 was sprayed 24 hours before the experiment, when it was used in the modalities. DPI was added to the reaction medium just before the addition of the extract. Each value was the mean of 5 repetitions per plant.

FIGS. 15 A and B show effects of the different treatments on the kinetics of the salicylic acid production. A: salicylic acid production, 0 to 9 days. B: salicylic acid production, 0 to 5 hours. The leaves were collected at the different times indicated. Salicylic acid production in the Arabidopsis thaliana leaves, in response to infection with Pseudomonas syringae, to spraying with PP1, or to spraying with PP1 followed by inoculation with Pseudomonas syringae. The arrow corresponds to the time of the inoculation, when this was performed. PP1 was sprayed 24 hours before the experiment, when it was used in the modalities.

FIGS. 16A and B show kinetics of the production of ethylene in the Arabidopsis thaliana leaves, in response to infection with Pseudomonas syringae, to spraying with PP1, or to spraying with PP1 followed by inoculation with Pseudomonas syringae. A: ethylene production, 0 to 9 days. The spraying with PP1 took place 24 hours before the inoculation. B: ethylene production, 0 to 96 hours. The green arrow corresponds to the treatment with PP1, the blue arrow corresponds to the time of the inoculation, when this was performed. PP1 was sprayed 24 hours before the experiment, when it was used in the modalities.

FIG. 17 shows kinetics of the production of jasmonic acid in the Arabidopsis thaliana leaves, in response to infection with Pseudomonas syringae, to spraying with PP1, or to spraying with PP1 followed by inoculation with Pseudomonas syringae. The arrow corresponds to the time of the inoculation, when this was performed. PP1 was sprayed 24 hours before the experiment, when it was used in the modalities.

FIG. 18 shows kinetics of the peroxidase activity in the Arabidopsis thaliana leaves, in response to infection with Pseudomonas syringae, to spraying with PP1, or to spraying with PP1 followed by inoculation with Pseudomonas syringae. The arrow corresponds to the time of the inoculation, when this was performed. PP1 was sprayed 24 hours before the experiment, when it was used in the modalities.

FIG. 19 is a schematic diagram showing role of the WRKY29 factor in the immune response of plants and the triggering of defences of the WRKY29 gene as a marker of plant resistance.

FIG. 20 shows images after stimulation with PP1. Arrows and circles indicate the blue regions of the plant.

FIG. 21 represents, schematically, a first synthesis reaction.

FIG. 22 represents, schematically, a second synthesis reaction.

FIG. 23 represents, in the form of a logical diagram, steps in a particular embodiment of the method for producing and using the elicitor composition that is the subject of the present invention.

FIG. 24 represents a cyclised structure of 1,3-thiazepane-2-thione.

FIGS. 25 to 33 show, in the form of graphs, comparisons of results obtained with the use of the crushed material that is the subject of the present invention.

FIGS. 34 to 42 show, in the form of photographs, roots of plants treated without and with the use of the crushed material that is the subject of the present invention.

FIG. 43 represents, in the form of a time diagram, a trial procedure testing the use and the method that are the subjects of the present invention on maize.

FIGS. 44 and 45 represent, in the form of tables, measurements of various ecophysiological parameters during the use and the method that are the subjects of the present invention.

FIGS. 46A to 46F show, in the form of photographs, roots of plants treated with the use and the method that are the subjects of the present invention.

FIGS. 47A to 47C show, in the form of graphs, crop yield, digestibility and lignin of maize under water stress.

FIGS. 48A and 48B show, in the form of graphs, the length and density of absorbent hair in Arabidopsis thaliana exposed to various treatments.

FIG. 49 shows dry matter masses per plant in Arabidopsis thaliana exposed to various treatments.

FIGS. 50A and 50B show, in the form of graphs, the length and density of absorbent hair in Arabidopsis thaliana exposed to various treatments.

FIG. 51 shows primary root lengths in Arabidopsis thaliana exposed to various treatments.

FIGS. 52A and 52B show, in the form of graphs, the length and density of absorbent hair in Arabidopsis thaliana exposed to various treatments.

FIGS. 53A to 53E show, in the form of photographs, a branch, a cutting, a dried-dip cutting, planted cuttings and cultures boxes.

FIG. 54A shows, in the form of graphs, results of counts performed on the 13th day of culture of cuttings.

FIG. 54B shows, in the form of photographs, basal parts of cuttings treated with different treatments, on the 13th day of culture.

FIG. 55A shows, in the form of graphs, results of counts performed on the 28th day of culture of cuttings.

FIG. 55B shows, in the form of photographs, basal parts of cuttings treated with different treatments, on the 28th day of culture.

FIG. 56A shows, in the form of photographs, apical parts of cuttings treated with different treatments, on the 28th day of culture.

FIGS. 56B and 56C show, in the form of graphs, counts and measurements performed on buds on the 28th day of culture.

FIG. 57 shows liquids obtained with and without additional water according to the method shown in FIG. 1.

### DETAILED DESCRIPTION

US2020128833, U.S. Ser. No. 18/494,791, and U.S. Ser. No. 18/494,842 are herein incorporated by reference. PCT/EP2022/078282 (published as WO 2023/062025) and PCT/EP2022/078302 (published as WO 2023/062033) are herein incorporated by reference.

In some embodiments, the described elicitor composition comprises at least one part of at least one of the following plants: Rockets, including Eruca sativa, Diplotaxis, Erucastrum and Bunias genera, Cakile, plants of the Allium genera, mustard (Sinapis alba, Brassica nigra, Sinapis arvensis, Brassica juncea), wasabi (Eutrema japonicum), horseradish (Armoracia rusticana), watercress (Nasturtium officinale), plants of the species Brassica rapa, Brassica ruvo, Brassica napus, Raphanus sativus, Barbarea verna, Erysimum allionii, Erysimum cheiri, Tropaeolum majus L, Alliaria petiolata, Salvadora persica, Carica papaya and Brassica oleracea.

In certain embodiments, the described composition stimulates the defences of a plant or tree against a pathogen attack. In other embodiments, the composition reduces the effects of an attack by a pathogen.

In certain embodiments, the elicitor composition is applied to the plant or tree between 1 hour and 8 days prior to exposure to the pathogen; in other embodiments, between 1 hour and 20 days; in other embodiments, between 1 hour and 15 days; in other embodiments, between 1 hour and 10 days; in other embodiments, between 2 hours and 20 days; in other embodiments, between 4 hours and 20 days; in other embodiments, between 4 hours and 15 days; in other embodiments, between 4 hours and 10 days; or in other embodiments, between 4 hours and 8 days prior to exposure to the pathogen.

In certain embodiments, the elicitor composition is applied to the plant or tree at least once every 8 days during a time of risk of exposure to the pathogen; in other embodiments, at least once every 10 days; in other embodiments, at least once every 15 days; in other embodiments, at least once every 20 days; in other embodiments, at least once every 30 days; or in other embodiments, at least once every 5 days during a time of risk of exposure to the pathogen. Times of risk of exposure to a pathogen can be identified by those skilled in the art, and include, without limitation, periods of relatively high infestation of pathogen vectors (e.g., insects known to carry the pathogen), periods during which farming tools are used to contact multiple trees or plants, and periods during which the pathogen replicates and/or is known to actively spread between plants.

The risk of exposure to a pathogen can be identified by using models of pathogens, data such as weather forecast date, and sensors, for example humidity and temperature sensors and sensors positioned in the field or on the agricultural holding. The estimated time of exposure may also be estimated by using such models.

In certain embodiments, the elicitor composition is applied to the plant or tree between 1 hour and 8 days after exposure to the pathogen; in other embodiments, between 1 hour and 20 days; in other embodiments, between 1 hour and 15 days; in other embodiments, between 1 hour and 10 days; in other embodiments, between 2 hours and 20 days; in other embodiments, between 4 hours and 20 days; in other embodiments, between 4 hours and 15 days; in other embodiments, between 4 hours and 10 days; or in other embodiments, between 4 hours and 8 days after exposure to the pathogen.

In certain embodiments, the elicitor composition is applied to the plant or tree between 1 hour and 8 days after a time of risk of exposure to the pathogen; in other embodiments, between 1 hour and 20 days; in other embodiments, between 1 hour and 15 days; in other embodiments, between 1 hour and 10 days; in other embodiments, between 2 hours and 20 days; in other embodiments, between 4 hours and 20 days; in other embodiments, between 4 hours and 15 days; in other embodiments, between 4 hours and 10 days; or in other embodiments, between 4 hours and 8 days after a time of risk of exposure to the pathogen.

In certain embodiments, the plant or tree is a strain compatible with the pathogen. In certain embodiments, a compatible plant or tree does not exhibit active a gene-for-gene interaction with the pathogen.

As provided herein, the described compositions enhance the ability of host plants and trees to recognize and mount rapid and effective immune responses to pathogens, even when the host plant or tree is ordinarily compatible with the pathogen. The enhanced ability to recognize and react to pathogens is triggered rapidly (within 1 hour, at least for certain aspects) and remains elevated for at least several hours or days, for different elements of the response, as described in detail herein, e.g., in the Examples.

Each mentioned method element (e.g., timing or frequency of administration, target plant strains, target pathogens, etc.) may be freely combined with other mentioned method elements and other mentioned composition elements (e.g., source species of plant material for elicitor composition, method of production, etc.). Each method limitation or element mentioned in the context of a composition may be freely imported into any method embodiments mentioned herein.

Certain preferred embodiments and certain pathogens (viruses, bacteria, fungi, nematodes, etc.) are mentioned herein.

Before presenting the various aspects of the present invention, certain pathogens on which the elicitor composition that is the subject of the invention has been tested successfully are described below:

For clarity and conciseness, the Examples of the description that will follow do not cover all the combinations of plants indicated above, but illustrate the effectiveness of the present invention in all these combinations.

### Example 1

Effect of the Elicitor Composition that is the Subject of the Invention Against the Beet Yellowing Virus.

Beet is the major reservoir of the yellowing viruses. It is therefore important to remove all the crop residues (harvest cords, beets missed) because the regrowing leaves can become sources of infection. Good weed management is also important in the plots and in the edges of fields, as a number of species are hosts of aphid vectors and sometimes also of the yellowing viruses.

To fight against this virus, the following techniques are used:

Preventive control by using seeds treated with a systemic insecticide in the coating (imidacloprid). This technique has by far the best results for effectiveness and persistence. However, it is important to note that neonicotinoids were prohibited in 2018. 2020 was the second year without neonicotinoid (NNI) on seeds since 1993. Imidacloprid was authorised in seed treatments that year. It is a very effective neurotoxic insecticide. As a consequence, the aphid only bites once, thus cutting the circle of contamination (INRAE, 2020).

In Europe, imidacloprid will no longer be approved as of 31 Jul. 2022, but some countries have retained it or have granted exemptions, whereas, in France, ANSES (the French Agency for Food, Environmental and Occupational Health & Safety) has withdrawn all MAs for agricultural purposes. Two other NNIs were withdrawn at the end of 2019 (thiamethoxam, clothianidin). Only thiamethoxam and Imidacloprid were used in France for coating beet seeds.

Preventive control by the application, during sowing, of long-lasting micro-granular insecticides, suitable for controlling the aphid vectors of the yellowing.

Curative control by sprays based on aphicide products.

At the present time, the following products are available:
Teppeki (50% Flonicamid), registered trademark, has been authorised since 21 Dec. 2018 with the following conditions of use (marketing authorisation, or “MA”, no. 2050046):
Approved dose 0.14 kg/ha;
One application per year from the six-true-leaf stage;
Effective only on aphids (selective for auxiliaries);
May be mixed with herbicides;
Minimum persistence of two weeks;
Add one litre of oil according to regulations.
Movento (Spirotetramat, 100 g/l), registered trademark, obtained an exemption MA of 120 days for use in 2020 with the following conditions of use:
Approved dose 0.45 l/ha;
Two applications per year (minimum interval of 14 days) from the two-leaf stage through to ground cover of the beets;
Effective only on aphids (selective for auxiliaries);
Not to be used in a mixture as this could decrease effectiveness; and
Minimum persistence of two weeks.

However, the use of these two active substances in 2020 did not enable sufficient control of aphid populations throughout France. These two substances do not provide a lasting solution. As it stands, no chemical or non-chemical solution is as effective as the chemical treatments based on NNI, nor do they make it possible to deal with an exceptional situation (INRAE, 2020).

In the light of the urgent need to find an effective solution for controlling beet yellowing, the fully bio-based elicitor composition that is the subject of the invention is able to significantly reduce, even eliminate, the effects caused by severe viral diseases of plants, incurable thus far. Toxicity tests on this composition have shown that it is not toxic. A trial was set up with the company Ephydia (registered trademark), BPE-certified for good environmental practices, for tests against the beet yellowing virus, the results of which are presented below.

### Material and Methods

Plant material: Beta vulgaris is a plant species of the family Amaranthaceae.

It is grown throughout the world for the production of sugar and, accessorily, for the manufacture of ethanol or baker's yeast from the molasses produced using residues from the manufacture of white sugar.

### Cultivation Conditions

Planting date: 25 Mar. 2021
Depth: two metres
Spacing between the rows: 45 cm
Spacing in the row: 18.5 cm
Planting rate: 100,000 plants/ha
Planting method: seeding
Trial carried out by: Ephydia
Width of the treated plot: 2.7 m
Length of the treated plot: 9.25 m
Surface area of the treated plot: 24.975 m²
Number of repetitions: four
Soil texture: Loamy

### Trial Location:

Town/Municipality: Combles (Somme département, France)
Country: France
Postcode: 80360

### Description of the Treatments:

Control (plot not treated),
Application of PP1, at 50% V/V,
Application of PP1, at 50% V/V, and Teppeki, at 0.14 kg/ha,
Application of Teppeki, at 0.14 kg/ha.

In this first Example, extracts of Eruca sativa and Diplotaxis tenuifolia were used. As the results were very similar, these two extracts have been grouped together under the generic term “PP1” below.

### Description of the Treatment Modalities

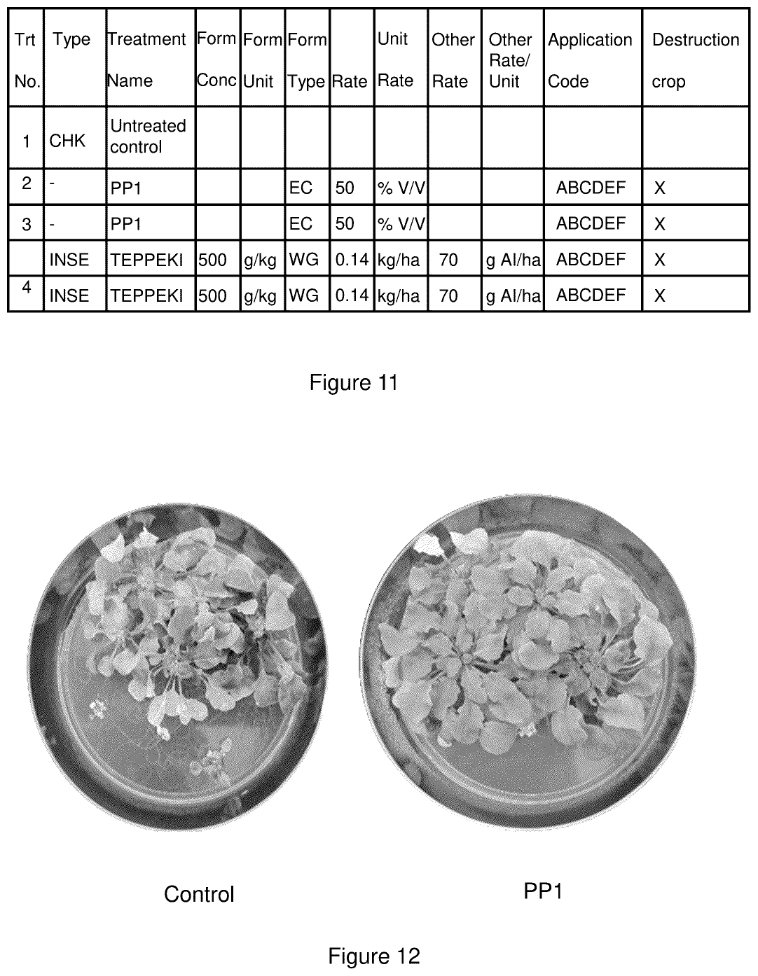

Type of application: Foliar application
Table 1 in FIG. 11: Description of the treatment modalities (or “Trt”)

TABLE 2
Date and stage of application of the treatments

| | A | B | C | D | E | F |
|---|---|---|---|---|---|---|
| Date | 14 May | 24 May | 4 Jun. | 14 Jun. | 24 Jun. | 2 Jul. |
| d′application | 2021 | 2021 | 2021 | 2021 | 2021 | 2021 |
| Stade BBCH | 12 | 16 | 18 | 32 | 39 | 39 |

### Description of the Teppeki Product:

MA no.: 2050046
Date of the 1st authorisation of the product: 21 Apr. 2005
Active substance: Flonicamid 500 g/kg
Function: Insecticide
Use: 15053106 Industrial and fodder beet*Trt Part.Aer.*Aphids
Date of authorisation for use: 12 Aug. 2021
Maximum application dose: 0.14 kg/ha
Maximum number of applications: One
Application stage: Minimum: BBCH 12
Maximum: BBCH 49
Pre-harvest interval: 60 days

It is important to note that the Teppeki product is only authorised to be applied just once on the beetcrop; however, during the trial the programme received three applications of the Teppeki product and six applications of the Teppeki product on its own for the reference modality. Therefore, the results that follow will have to be qualified, with the understanding that these levels of effectiveness with the reference are never obtained in fields under real conditions.

Description of the evaluations carried out during the trial.

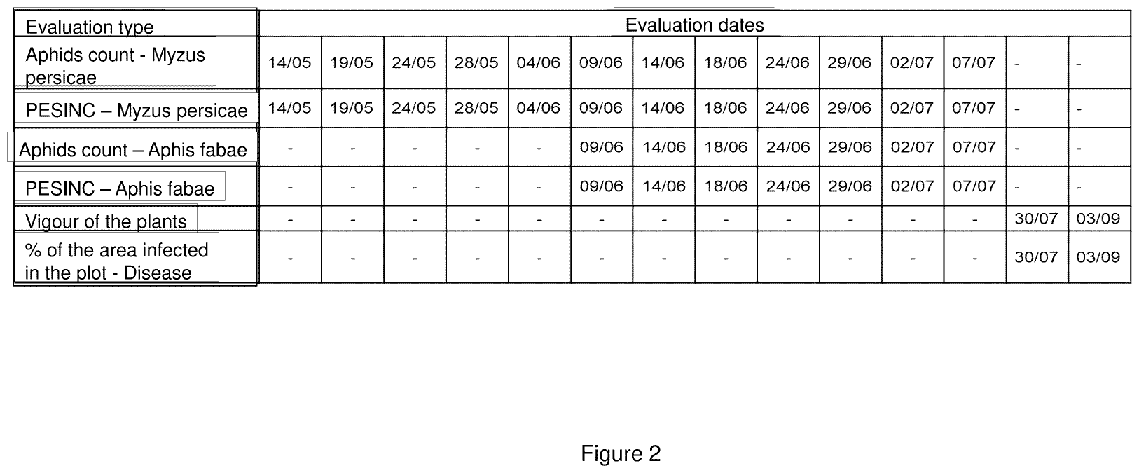

Observation aphids at each application and five days after each treatment:
Myzus persicae: green peach aphid
Aphis fabae: black bean aphid
Observation at the appearance of symptoms, during summer and after harvest
Harvest gross weight and sugar content
FIG. 2: date of the evaluations.

### Results and Discussion.

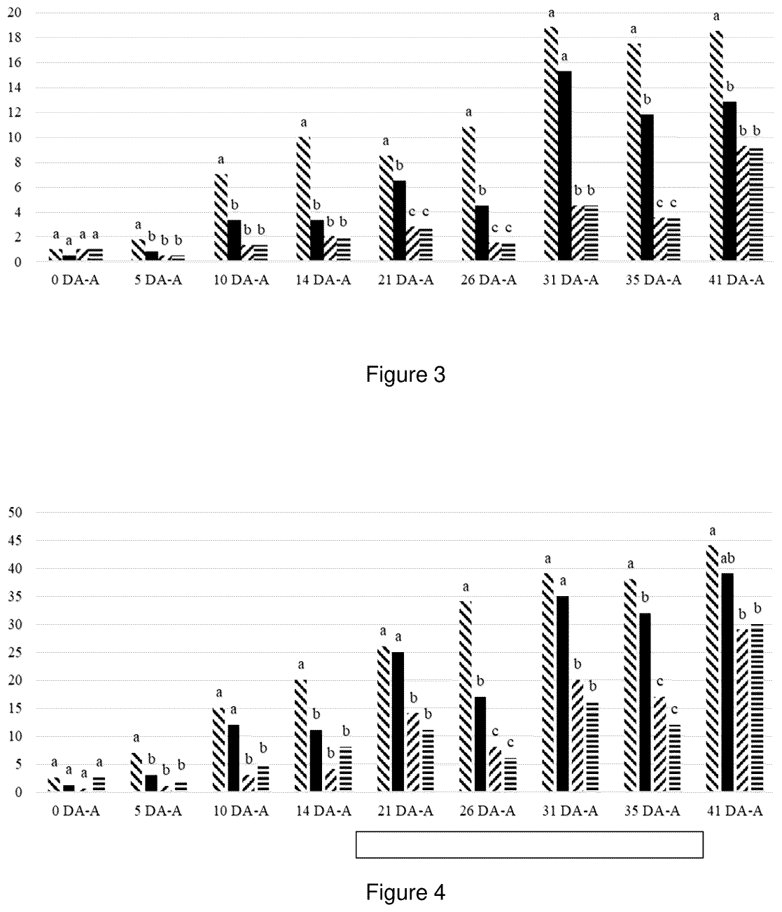

In FIGS. 3 to 6, each set of four vertical bars represents, from left to right, the untreated control, the treatment with the composition that is the subject of the invention, the combination of this composition and Teppeki, and Teppeki on its own.

Evaluation of the number of aphids and of the incidence of the attacker—Myzus persicae.

FIG. 3: Number of Myzus persicae insects.

FIG. 4: Incidence of the attacker—Myzus persicae.

Note: “DA-A” means “Day after treatment A”, etc.

The green peach aphid, Myzus persicae, is the principal vector of beet yellowing. Its ability to transmit the mild yellowing viruses (BChV and BMYV) and also the severe yellowing virus (BYV) is very high.

The results illustrated in FIG. 3 show that the PP1 treatment enables a statistical reduction in the number of aphid vectors of the yellowing (except for the 31 DA-A observation, associated letter “a”) compared to the untreated modality. All the treated modalities are statistically identical up to 14 DA-A and at observation 41 DA-A (associated letters “b”), and different from 21 DA-A to 35 DA-A of the modality treated with Teppeki at significant overdose.

In addition, the results illustrated in FIG. 4 show that the PP1 treatment enables a reduction in the incidence in relation to the control, except for the observations 10 DA-A, 21 DA-A and 31 DA-A. These results show that PP1 has an effect on the presence of the vector for beet yellowing—Myzus persicae.

The aphid presence values are directly correlated with the appearance of the symptoms of the yellowing. Because of this, the results obtained show that PP1 enables the symptoms to be reduced.

Evaluation of the number of aphids and of the incidence of the attacker—Aphis Fabae.

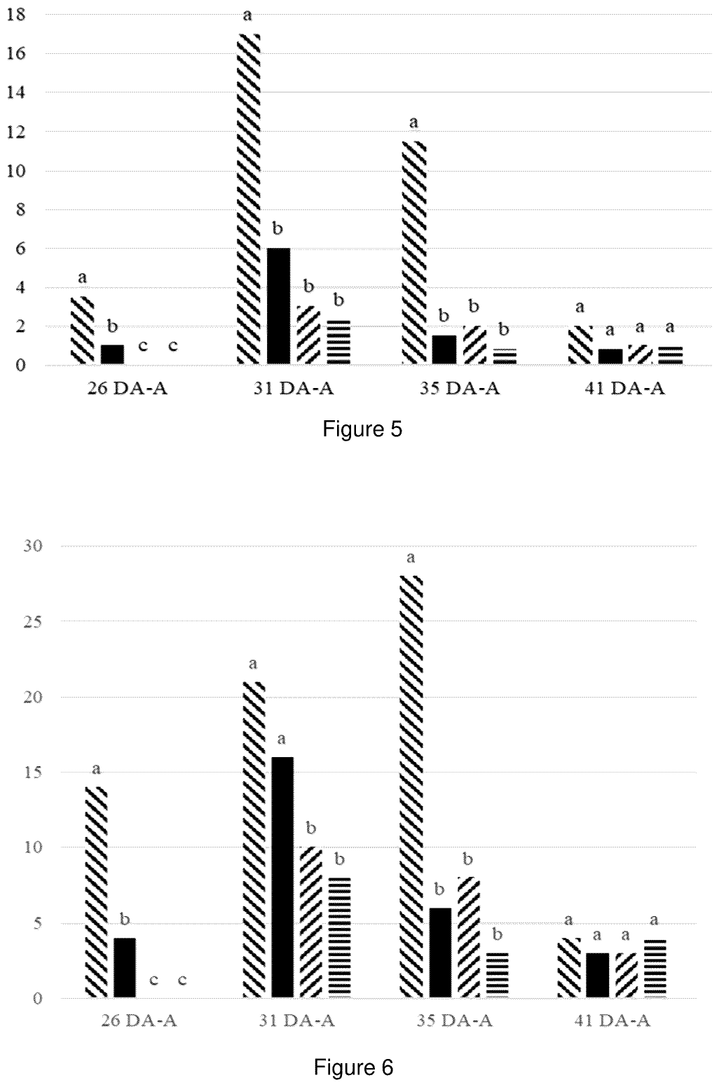

FIG. 5: Number of Aphis fabae insects

FIG. 6: Incidence of the attacker—Aphis fabae

The black bean aphid, Aphis fabae, is a secondary vector of BYV (severe yellowing), but transmits neither BChV nor BMYV (mild yellowing viruses). The yellowing is never transmitted to the descendants of contaminated aphids.

The results illustrated in FIG. 5 show that the PP1 treatment enables a statistical reduction in the number of aphid vectors of the yellowing compared to the untreated modality, except for 41 DA-A observation (associated letters “a”). In addition, we can see that, starting from 31 DA-A, the PP1 product is statistically equivalent to the Teppeki reference, even applied at significant overdose (associated letters “b”).

In addition, the results illustrated in FIG. 6 show that the PP1 treatment enables a reduction in the incidence in relation to the control, except for the observation 31 DA-A (associated letters “a”).

These results show that PP1 has an effect on the presence of the vector for beet yellowing Aphis fabae. In addition, the aphid presence values are directly correlated with the appearance of the symptoms of the yellowing. Because of this, these results show that PP1 enables the symptoms to be reduced.

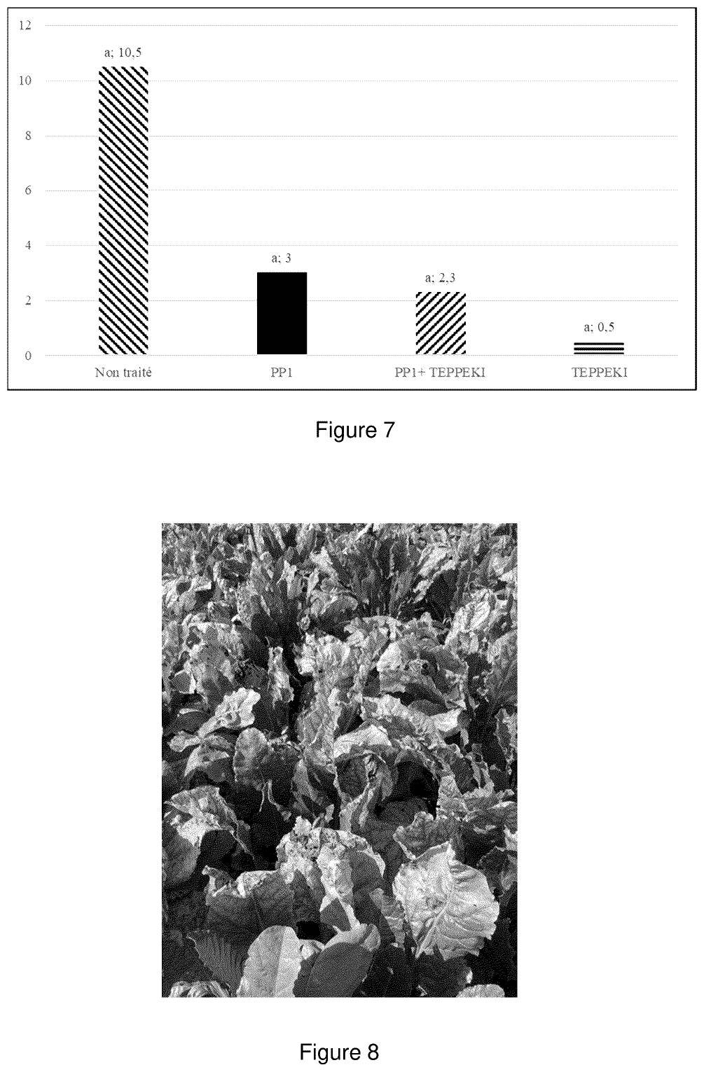

Areas infected by beet yellowing (FIG. 7). FIG. 7 shows an evaluation of the area infected by the yellowing as a function of the treatments. The risk period begins as of the appearance of the first aphid in the plots, at the earliest in late April/early May, i.e. from the two-leaf stage, through to ground cover, late June. The latency period is generally two to four weeks, but would be shorter for the severe yellowing (one to two weeks) than for the mild yellowing (four to six weeks).

In the case of this trial, the Myzus persicae aphids were detected in the 14 May 2021 to 24 Jun. 2021 trial, and the Aphis fabae aphids were detected in the 9 Jun. 2021 to 24 Jun. 2021 trial. The first symptoms of the disease were observed on 3 Sep. 2021, as indicated in FIG. 7. These results demonstrate that the plots start to show the beet yellowing symptoms and that the PP1 product is as effective as the TEPPEKI reference (which was applied six times whereas it is only applied once under normal conditions) and enables a reduction in the symptoms compared to the untreated modality.

Therefore, PP1 may prove to be more effective than the reference product Teppeki under normal condition of application. PP1 thus enables the presence of aphid vectors to be reduced, and also the appearance of symptoms to be limited.

FIG. 8: Photograph of the untreated modality—plot 401

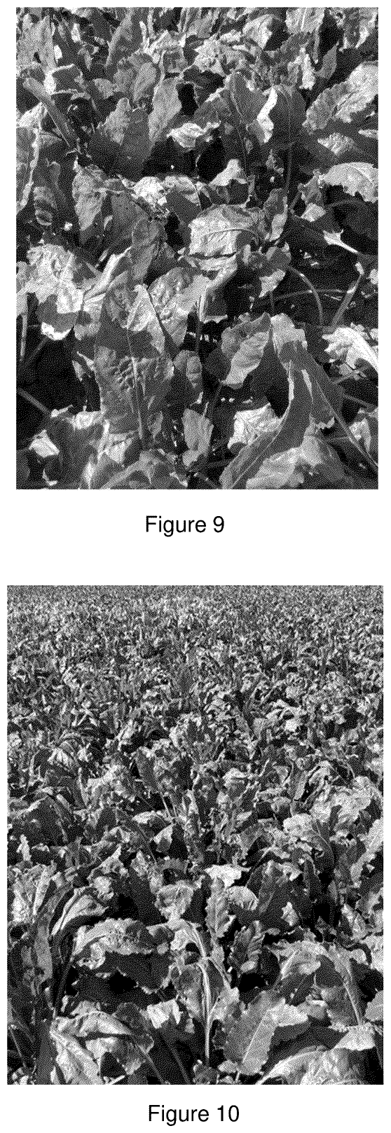

FIG. 9: Photograph of the modality treated with the PP1 product—plot 101

FIG. 10: Photograph of the modality treated with the PP1 product—plot 403

### Conclusions of the First Example

The data of this trial indicate that the application of the PP1 plant extract by foliar application make it possible to reduce the presence of the two varieties of aphid vectors of severe yellowing and mild yellowing. These data are linked to the fact that PP1 makes it possible to reduce the symptoms of the yellowing. Plants that have not been bitten by the aphids continue their photosynthesis, have good strength and continue their cycle of development.

### Beet Harvest as a Function of the Modalities:

Control: 0.8 tonnes
PP1: 1.2 tonnes
PP1+Teppeki: 1.3 tonnes
Teppeki: 1.2 tonnes

Therefore, PP1 could be a solution to the problem of the yellowing, and a replacement solution for neonicotinoids. The PP1 product is able to significantly reduce the incidence of the beet yellowing virus.

### Example 2

### Effect of PP1 Against Cucumber Mosaic Virus

This trial was carried out in an area known to be contaminated with the cucumber mosaic virus.

The control methods are generally the following:
Limit the presence of banker plants;
Immediately eliminate and destroy the plants that show symptoms;
Limit the presence of aphids;
Use clean tools during pruning and gardening work;
Choose healthy seeds or plants; and
Choose resistant cucumber varieties.

A trial was carried out to evaluate the effectiveness of PP1 against cucumber mosaic.

### Plant Material:

STYX variety, organic plants,
Schedule: planting 11 Apr. 2021,
Harvested 23 May 2021 to 15 Jul. 2021,
Apparatus: Eight-metre tunnel, micro-perforated opaque thermal mulch, four double rows (0.35 m apart),
Irrigation: one spray boom per row crop
Modalities: Untreated controls (T) and plants treated with PP1
Trial block with four repetitions
Treatments: six treatments were carried out at a frequency of 14 days.

### Symptoms:

Chlorotic spots (mosaic more or less pronounced) appear on the young leaves; these can become distorted, crinkled, even dried out in serious cases. In the plots, circular outbreaks of disease are observed, which gradually expand.

An early attack causes the complete dieback of the young plants. The plants affected exhibit reduced growth and a modified habit.

A plant infected by this virus continues to be a carrier of the virus until it dies.

Observations and measurements made: —Observations: Agronomic measurements 23 May 2021 to 15 Jul. 2021:

The incidence represents the percentage of leaves or fruit contaminated.

The severity represents the percentage of the surface covered by the symptoms of the disease.

TABLE 3
Incidence and severity on cucumber leaves - 23 May 2021

| Modalities | Incidence | Severity |
|---|---|---|
| Controls | 0a | 0a |
| PP1 | 0a | 0a |

The severity and the incidence were measured on 20 leaves collected randomly, for each modality.

TABLE 4
Incidence and severity on cucumber leaves - 15 Jul. 2021

| Modalities | Incidence | Severity |
|---|---|---|
| Controls | 25a | 30a |
| PP1 | 5b | 5b |

The severity and the incidence were measured on 20 leaves collected randomly, for each modality.

TABLE 5
Incidence and severity on cucumbers (Fruits) - 15 Jul. 2021

| Modalities | Incidence | Severity |
|---|---|---|
| Controls | 35a | 40a |
| PP1 | 10b | 5b |

The severity and the incidence were measured on 20 fruits collected randomly, for each modality. The analyses were performed according to Newman and Keuls. The different letters indicate results that differed significantly with a threshold of 5%.

For both the leaves and the fruits, it is seen that the elicitor composition that is the subject of the invention (PP1) significantly reduces both the incidence and severity of the effects of the viruses and significantly increases the quantity of beets harvested.

The results show the effectiveness of PP1 against the cucumber mosaic virus. This is because the observations on the leaves and on the fruits show that the treated plants have significantly fewer symptoms than the control plants.

### Example 3

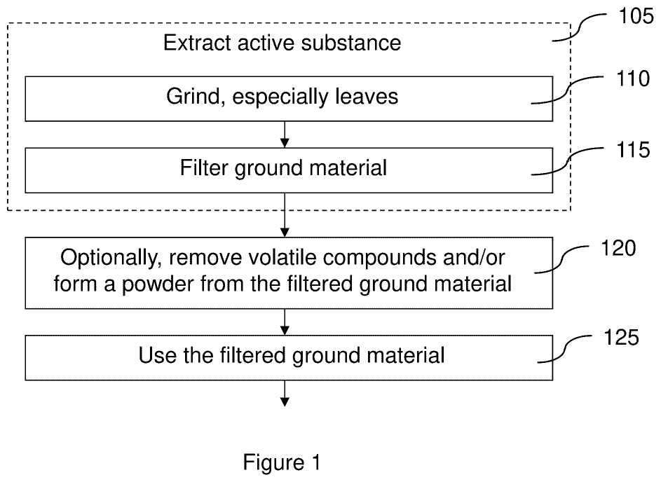

B1/Broccoli extract (“PP2”) against cucumber mosaic virus (CMV). An extract of broccoli leaves was produced according to the protocol illustrated in FIG. 1, in liquid form, without concentration. This trial was carried out in an area known to be contaminated with the cucumber mosaic virus (presence of the vector). There is currently no known biocontrol solution for eradicating the disease.

In this context, a trial was carried out to evaluate the effectiveness of PP2 against cucumber mosaic virus (CMV).

### Symptoms:

Chlorotic spots (mosaic) appear on the young leaves, which can become distorted, crinkled, even dried out in serious cases. An early attack causes the complete dieback of the young plants. The plants affected exhibit reduced growth and a modified habit. A plant infected by this virus continues to be a carrier of the virus until it dies.

### Material and Method

Cucumber variety: TYRIA, organic plants, not mosaic virus tolerant. Schedule: planting 8 Apr. 2020
Harvested: 28 May 2020 to 30 Jul. 2020
Apparatus: Eight-metre tunnel, trellised on twine, two double rows (0.35 m apart). Irrigation: one spray boom per row crop
Modalities: Untreated controls (T) and plants treated (PP2)
Arrangement: Trial block with four randomised repetitions
Treatments: six treatments were carried out at a frequency of 14 days.

### Results:

TABLE 6
Incidence and severity on cucumber leaves - 30 May 2020

| Modalities | Incidence | Severity |
|---|---|---|
| Controls | 0a | 0a |
| PP2 | 0a | 0a |

The severity and the incidence were measured on 20 leaves collected randomly, for each modality.

TABLE 7
Incidence and severity on cucumber leaves - 20 Jul. 2020

| Modalities | Incidence | Severity |
|---|---|---|
| Controls | 16a | 10a |
| PP2 | 9b | 5b |

The severity and the incidence were measured on 20 leaves collected randomly, for each modality.

TABLE 8
Incidence and severity on cucumbers (Fruits) - 20 Jul. 2020

| Modalities | Incidence | Severity |
|---|---|---|
| Controls | 12a | 15a |
| PP2 | 5b | 8b |

The severity and the incidence were measured on 20 fruits collected randomly, for each modality. The analyses were performed according to Newman and Keuls. The different letters indicate results that differed significantly with a threshold of 5%.

The results show the effectiveness of PP2 against the cucumber mosaic virus. This is because the observations on the leaves and on the fruits show that the treated plants have significantly fewer symptoms than the control plants.

### Example 4

Brussels sprouts extract (PP3) on cucumber mosaic virus (CMV). An extract of Brussels Sprouts leaves was produced according to the protocol illustrated in FIG. 1, in liquid form, without concentration.

This trial was carried out in an area known to be contaminated with the cucumber mosaic virus (presence of the vector).

There is currently no known biocontrol solution for eradicating the disease.

In this context, a trial was carried out to evaluate the effectiveness of PP3 against cucumber mosaic virus.

### Material and Method

Cucumber variety: TYRIA, organic plants, not mosaic virus tolerant.
Schedule: planting 8 Apr. 2020
Harvested: 28 May 2020 to 30 Jul. 2020
Apparatus: Eight-metre tunnel, trellised on twine, two double rows (0.35 m apart). Irrigation: one spray boom per row crop
Modalities: Untreated controls (T) and plants treated (PP3)
Arrangement: Trial block with four randomised repetitions
Treatments: six treatments were carried out at a frequency of 14 days.

### Results:

TABLE 9
Incidence and severity on cucumber leaves - 30 May 2020

| Modalities | Incidence | Severity |
|---|---|---|
| Controls | 0a | 0a |
| PP3 | 0a | 0a |

The severity and the incidence were measured on 20 leaves collected randomly, for each modality.

TABLE 10
Incidence and severity on cucumber leaves - 20 Jul. 2020

| Modalities | Incidence | Severity |
|---|---|---|
| Controls | 27a | 20a |
| PP3 | 15b | 10b |

The severity and the incidence were measured on 20 leaves collected randomly, for each modality.

TABLE 11
Incidence and severity on cucumbers (Fruits) - 20 Jul. 2020

| Modalities | Incidence | Severity |
|---|---|---|
| Controls | 32a | 25a |
| PP3 | 20b | 15b |

The severity and the incidence were measured on 20 fruits collected randomly, for each modality.

### Conclusion:

The analyses were performed according to Newman and Keuls. The different letters indicate results that differed significantly with a threshold of 5%. The results show the effectiveness of PP3 against the cucumber mosaic virus. This is because the observations on the leaves and on the fruits show that the treated plants have significantly fewer symptoms than the control plants.

### Example 5

### Rocket Extract (“PP1”) on Tomato Spotted Wilt Virus (TSWV)

The tomato spotted wilt virus (TSWV) is widely distributed around the world in the temperate and subtropical areas, where it is has been on the rise since the early 1980s. Found in France since 1987, it has a large range of potential hosts. It is transmitted by at least nine species of thrips.

The symptoms of tomato spotted wilt virus (TSWV) can take various forms on the tomato plant's foliage, such as deformation of leaves with apical curving of the apex, blockage of the vegetation, mosaic more or less contrasted, spots and chlorotic lesions becoming necrotic, chlorosis and bronzing more or less pronounced of the leaf blade or veins, accompanied by rings, small dark lesions becoming necrotic also visible on the petioles and stem, anthocyanosis of the leaf blade.

The fruits are also affected. They can be “bronzed” and have broad arabesques and chlorotic rings, more or less concentric. Sometimes dry necrotic changes and cracks are visible. Early contaminations result in a reduction in the number and size of the fruits; if contaminations are late the fruits develops normally but are discoloured and more or less deformed.

There is currently no known biocontrol solution for eradicating the disease.

In this context, a trial was carried out to evaluate the effectiveness of the elicitor composition that is the subject of the invention against the TSWV tomato virus. Extracts of rocket leaves (Diplotaxis) were obtained according to the protocol illustrated in FIG. 1 in their unconcentrated liquid form (extracts referred to as “PP1”).

### Material and Method

The experiment took place in a 250 m² rigid greenhouse equipped with openings and lateral aerations.

Experiment apparatus: “Complete blocks with four repetitions” type. Elementary plot of 10 plants.

Technical sequence: Sown on 30 Dec. 2021 for planting on 26 Jan. 2022. Harvested over four months from early March to the end of June 2022.

Modalities: Controls (untreated), PP1 (applied by foliar spray)

Treatments: Foliar spray

Six applications of PP1, at a frequency of 14 days.

Analysis method: Analysis of variance with a 5% threshold of risk. The observations with the same letter are not significantly different.

### Results:

TABLE 12
Incidence and severity on tomato leaves - 20 Mar. 2022

| Modalities | Incidence | Severity |
|---|---|---|
| Controls | 10a | 5a |
| PP1 | 10a | 1a |

The severity and the incidence were measured on 20 leaves collected randomly, for each modality.

TABLE 13
Incidence and severity on tomatoes (Fruits)-20 Mar. 2022

| Modalities | Incidence | Severity |
|---|---|---|
| Controls | 0a | 0a |
| PP1 | 0a | 0a |

The severity and the incidence were measured on 20 fruits collected randomly, for each modality.

TABLE 14
Incidence and severity on tomato leaves-25 Apr. 2022

| Modalities | Incidence | Severity |
|---|---|---|
| Controls | 35a | 70a |
| PP1 | 10b | 30b |

The severity and the incidence were measured on 20 leaves collected randomly, for each modality.

TABLE 15
Incidence and severity on tomatoes (Fruits)-25 Apr. 2022

| Modalities | Incidence | Severity |
|---|---|---|
| Controls | 25a | 55a |
| PP1 | 5b | 10b |

The severity and the incidence were measured on 20 fruits collected randomly, for each modality.

TABLE 16
Incidence and severity on tomato leaves-5 Jun. 2022

| Modalities | Incidence | Severity |
|---|---|---|
| Controls | 90a | 80a |
| PP1 | 10b | 40b |

The severity and the incidence were measured on 20 leaves collected randomly, for each modality.

TABLE 17
Incidence and severity on tomatoes (Fruits)-Jun. 5, 2022

| Modalities | Incidence | Severity |
|---|---|---|
| Controls | 50a | 60a |
| PP1 | 10b | 15b |

The severity and the incidence were measured on 20 fruits collected randomly, for each modality.

The results show the effectiveness of PP1 against the tomato virus (TSWV). This is because the observations on the leaves and on the fruits show that the treated plants have significantly fewer symptoms than the control plants. The progression of the disease was significantly slowed by the PP1 foliar treatments.

### Example 6

Rocket extract on tomato mosaic virus (ToMV). Tomato mosaic virus (ToMV) is present an all continents. It is frequently found on tomatoes and peppers. It is severe in both field crops and covered cultivation. While its incidence has been reduced considerably with the spread of resistant varieties of tomatoes, the recent introduction of new sensitive varieties has shown how the ToMV has already been ready to attack sensitive plant material.

There is currently no known biocontrol solution for eradicating the disease.

In this context, a trial was carried out to evaluate the effectiveness of PP1 against the ToMV tomato virus.

The symptoms caused by the presence of this virus are very varied and broadly similar. A decline in the growth of the plants can be observed, and colour anomalies can also appear on the leaflets and leaves. Other symptoms can also be expressed on leaves, such as vein clearing, marbling, mosaic of green, or yellow, areas with the leaf blade becoming crinkled and withered.

Blossom drop can also be observed. When the fruits reach maturity, they are smaller and are sometimes more or less bumpy. They also exhibit yellow discolourations, sometimes in rings. These symptoms can be present on unripe or ripe fruits even though the plant appears healthy. Late infections have no impact on production.

Extracts of rocket leaves (Diplotaxis) were obtained according to the protocol illustrated in FIG. 1 in their unconcentrated liquid form (extracts subsequently referred to as “PP1”).

The experiment took place in a greenhouse, soil-less culture.

Experiment apparatus: “Complete blocks with four repetitions” type. Elementary plot of 10 plants.

Technical sequence: planting in pots on 5 Feb. 2020. Harvested over five months from early March to the end of July 2020.

Modalities: Controls (untreated), PP1 (foliar spray)

Treatments: Foliar spray—six applications of PP1, at a frequency of 14 days.

Analysis method: Analysis of variance with a 5% threshold of risk. The observations with the same letter are not significantly different.

### Results:

TABLE 18
Incidence and severity on tomato leaves - 05 Mar. 2020

| Modalities | Incidence | Severity |
|---|---|---|
| Controls | 5a | 5a |
| PP1 | 5a | 5a |

The severity and the incidence were measured on 20 leaves collected randomly, for each modality.

TABLE 19
Incidence and severity on tomatoes (Fruits)-5 Mar. 2020

| Modalities | Incidence | Severity |
|---|---|---|
| Controls | 0a | 0a |
| PP1 | 0a | 0a |

The severity and the incidence were measured on 20 fruits collected randomly, for each modality.

TABLE 20
Incidence and severity on tomato
leaves-Jun. 30, 2020

| Modalities | Incidence | Severity |
|---|---|---|
| Controls | 55a | 60a |
| PP1 | 12b | 20b |

The severity and the incidence were measured on 20 leaves collected randomly, for each modality.

TABLE 21
Incidence and severity on tomatoes (Fruits) - 30 Jun. 2020

| Modalities | Incidence | Severity |
|---|---|---|
| Controls | 28a | 30a |
| PP1 | 8b | 10b |

The severity and the incidence were measured on 20 fruits collected randomly, for each modality.

The results show the effectiveness of PP1 against tomato mosaic virus (ToMV). This is because the observations on the leaves and on the fruits show that the treated plants have significantly fewer symptoms than the control plants. The progression of the disease was significantly slowed by the PP1 foliar treatments.

### Example 7

### Rocket Extract on Zucchini Yellow Mosaic Virus (ZYMV)

ZYMV is a potyvirus transmitted by aphids in the non-persistent mode. It is one of the best examples of viruses emerging in plants. Isolated for the first time in Italy and then in France in the 1970s, it has spread throughout the world in a few years, sometimes causing epidemics of exceptional severity. This recent and rapid dissemination in various types of crops (intensive, extensive, under cover, open field) and very varied ecosystems (temperate, tropical, Sahelian, island) is attested by the fact that ZYMV causes very strong symptoms.

This virus is now reported on cucurbits in virtually all of their production areas around the world. However, its frequency can vary a lot depending on the region. Regularly encountered in tropical or subtropical regions, its epidemics are more irregular in temperate countries such as France. A survey carried out from 2004 to 2008 in the main French production areas showed that ZYMV was only present in 11% of 2,660 samples analysed, mainly on squash (23% of samples tested), zucchini (14%) and melon (8%), and to a lesser extent on cucumber (3%). In areas where this virus was detected, outbreaks were generally severe, with a strong impact on yield. ZYMV causes very severe symptoms of mosaicism, yellowing, stunting and deformity on the foliage of virtually all cucurbits. It also causes discolourations and spectacular deformation of the fruits, which are then non-marketable. Early attacks can lead to a total loss of crops.

The experiment took place in the field.

Experiment apparatus: “Complete blocks with four repetitions” type. Elementary plot of 10 plants.

Technical sequence: planting in pots on 15 Apr. 2022. Harvested 30 Jun. 2022.

Modalities: Controls (untreated), PP1 (foliar spray)

Treatments: Foliar spray—six applications of PP1, at a frequency of 14 days.

Analysis method: Analysis of variance with a 5% threshold of risk. The observations with the same letter are not significantly different.

### Results:

TABLE 22
Incidence and severity on zucchini leaves-30 Jun. 2022

| Modalities | Incidence | Severity |
|---|---|---|
| Controls | 25a | 15a |
| PP1 | 8b | 5b |

The severity and the incidence were measured on 20 leaves collected randomly, for each modality.

TABLE 23
Incidence and severity on zucchini (Fruits)-30 Jun. 2022

| Modalities | Incidence | Severity |
|---|---|---|
| Controls | 20a | 10a |
| PP1 | 5b | 5b |

The severity and the incidence were measured on 20 fruits collected randomly, for each modality.

The results show the effectiveness of PP1 against zucchini yellow mosaic virus ZYMV. This is because the observations on the leaves and on the fruits show that the treated plants have significantly fewer symptoms than the control plants. The progression of the disease was significantly slowed by the PP1 foliar treatments.

### Example 8

### Radish Extract (“PP4”) on Rose Mosaic Virus

Rose mosaic is a viral disease that affects roses (Rosa sp.). It is caused by several viruses of the Ilarvirus and Nepovirus genera, which operate separately or, more frequently, in combination, leading some authors to talk of the “rose mosaic virus complex”. Among some cultivars, these viruses can cause variegation of the flowers. Other infected cultivars can remain asymptomatic.

The disease is not lethal for the roses, but the infection has the effect of reducing the vigour of the plants and weakening them, so that they are more vulnerable to transplant stress or to winter injury.

This disease causes various symptoms on the leaves: ring spots, chlorotic lines, watermarking, marbling of the leaves, as well as yellow mosaic patterns.

The disease indices are the following: bright yellow zigzag patterns on the leaves, arranged symmetrically in relation to the main vein; the yellow to cream spots can be diffuse and take the shape of a marbling; local browning can resemble a drying of the leaves.

Radish extracts were obtained according to the protocol illustrated in FIG. 1 in their unconcentrated liquid form (extracts subsequently referred to as “PP4”).

The experiment took place in a heated greenhouse.

Experiment apparatus: “Complete blocks with four repetitions” type. Elementary plot of 10 plants.

Technical sequence: the experiment was carried out on rose plants producing roses, four years old. Six applications, at a frequency of 14 days.

Modalities: Controls (untreated), PP4 (foliar spray)

Analysis method: Analysis of variance with a 5% threshold of risk. The observations with the same letter are not significantly different.

### Results:

TABLE 24
Incidence and severity on leaves-Jun. 30, 2022

| Modalities | Incidence | Severity |
|---|---|---|
| Controls | 18a | 20a |
| PP4 | 5b | 5b |

The severity and the incidence were measured on 20 leaves collected randomly, for each modality.

The results show the effectiveness of the extract against the rose mosaic virus. This is because the observations on the leaves and on the fruits show that the treated plants have significantly fewer symptoms than the control plants. The progression of the disease was significantly slowed by the PP4 foliar treatments.

### Example 9

### Effectiveness of the PP1 Product Against Pseudomonas syringae

In the framework of the study of the PP1 product, the purpose of this and the following Examples is to determine the key defence mechanisms induced, following the treatment of plants with PP1. The plant model chosen was Arabidopsis thaliana, infected with Pseudomonas syringae in a compatible interaction (sensitivity of the plant to the pathogen). The studies of the effects of PP1 were carried out with the pathogen present or absent. The biochemical approach was preferred, followed by a genetic approach (Arabidopsis mutant).

To test effectiveness of the PP1 product against Pseudomonas syringae, 37 days after inoculation. The PP1 product was sprayed on the plants 8 days before the inoculation with Pseudomonas syringae. The controls were sprayed with water 8 days before inoculation. FIG. 12 and Table 25 demonstrate the effectiveness of PP1 against Pseudomonas syringae.

TABLE 25
Effectiveness of the PP1 product against Pseudomonas syringae,
37 days after inoculation (5,106 cfu · mL-1).
The PP1 product was sprayed on the plants 8 days before
the inoculation with Pseudomonas syringae.
The controls were sprayed with water. The mean
percent of attack frequency represents the
mean percentage of leaves attacked by
Pseudomonas. The mean percent of attack intensity
represents the mean percentage of the
surface of leaves affected by the symptoms. A replicate
of 10 plants was used. An analysis of
variance (ANOVA) was performed. The analyses
were performed with a threshold of 5%.
When the results were significantly different at a
confidence level of 95%, this is indicated by
different letters.

| | mean % Attack frequency | mean % Attack intensity |
|---|---|---|
| Control | 82 a | 70 a |
| PP1 | 5 b | 0.5 b |

While the controls had a mean percent of attack intensity of 82%, the plants given a preventive treatment had an attack frequency of only 5%. While the controls had a mean severity of 70%, the plants treated with PP1 had a mean severity of 0.5%. The differences are significant.

Spraying with the PP1 product, as a preventive treatment, provided very strong protection of the Arabidopsis plants, while the parasite pressure was high. The protection provided by spraying with PP1 allowed the plant to develop normally, while the control plants showed growth retardation, linked to disease.

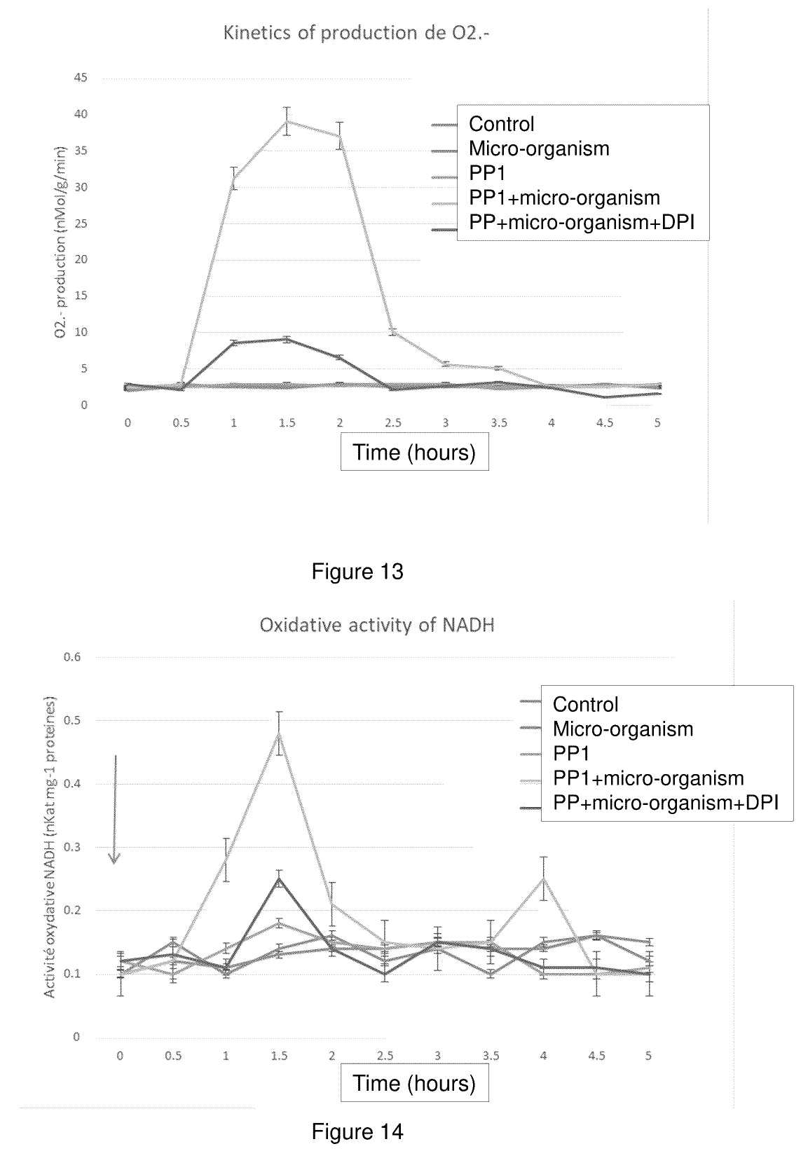

As described below or with regards to FIGS. 13 to 19, even when no pathogen attacks the plant, this plant reacts when treated by the composition of the invention. This reaction leads to promoting of the plant growth and speeding up its growth as described in U.S. Ser. No. 18/494,791 and U.S. Ser. No. 18/494,842, herein incorporated by reference.

As such, the composition of the invention is not only an elicitor composition but also a composition for promoting of the plant growth and speeding up its growth and the method of applying said composition to the plant is a method promoting of the plant growth and speeding up its growth and not only a method to reduce the effects of pathogens on said plant.

### Example 10

### Production of Anion Superoxide O₂⁻, Reactive Oxygen Species, after

PP1 Treatment

In addition to protecting against infection (FIG. 12, table 25), the PP1 treatment also caused a significant production of O₂⁻, starting 1 hour after the inoculation (FIG. 13). This oxidative burst continued up to 2 hours after the inoculation. Only this modality, “PP1+microorganism”, showed an oxidative burst. The addition of DPI, an NADPH oxidase inhibitor, allowed a sharp reduction in the production of anion superoxides, indicating the involvement of NADPH oxidase in the production of O₂⁻ after treatment with PP1 followed by the inoculation.

The spraying with PP1 with no subsequent inoculation did not cause any anion superoxide production.

Nor did the inoculation of the pathogen on its own cause any reactive oxygen species production.

### Example 11

### Activity of the NADH Oxidation in the Crude Extracts of Arabidopsis thaliana

The results in FIGS. 12-13 showed a strong correlation between the kinetics of O₂⁻ production, and that of the NADH oxidative activity for the “PP1+microorganism” modality. In this context, the production of the oxidative burst is linked to the NADPH Oxidase activity. Note that the addition of DPI strongly inhibited this oxidative activity, and also the production of O₂⁻, confirming this hypothesis.

Only the “PP1+Microorganism” modality showed an NADH oxidative activity, in line with the production of O₂⁻.

Four hours after inoculation, another NADH oxidation activity was noted which, this time, was not linked to a reactive oxygen species production under the experimental conditions.

### Example 12

### Salicylic Acid Production

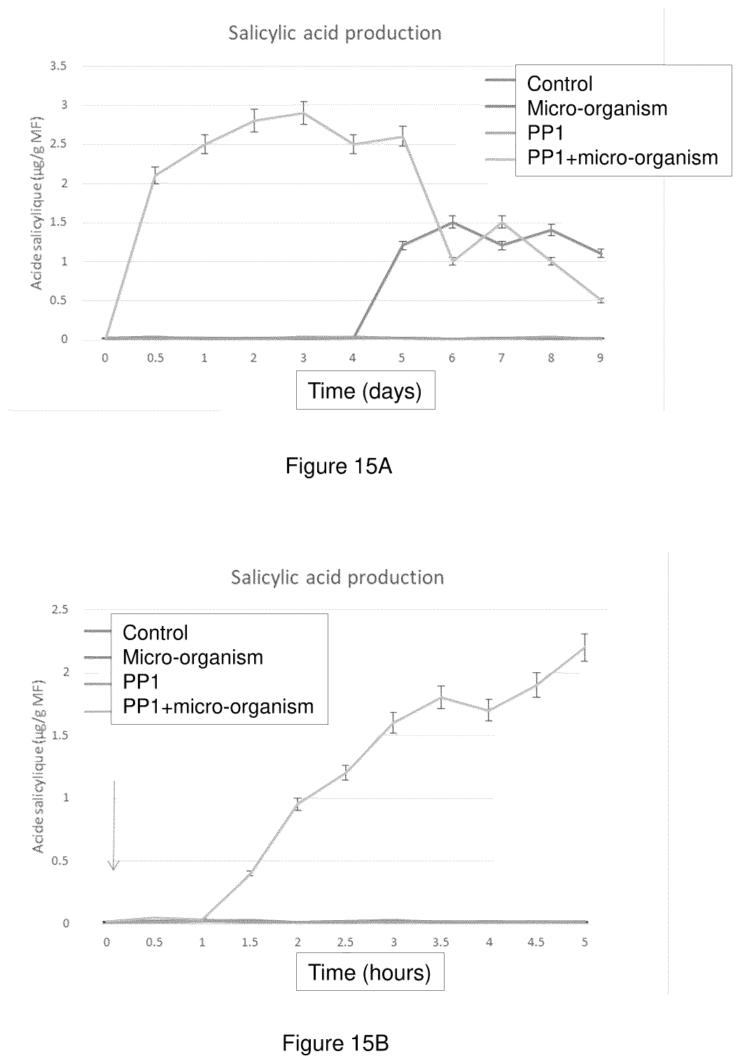

In line with the preceding results, only the “PP1+microorganism” modality caused an early production of salicylic acid, starting 12 hours (0.5 days) after the infection (FIG. 15A). The production of salicylic acid continued for 5 days after the inoculation, then decreased gradually. In the light of these results, and in order to determine the kinetics of the salicylic acid production in the first hours after the infection, the experiment was performed again, under the same conditions, but taking samples 0 to 5 hours after the inoculation (FIG. 15B).

When PP1 was used in a preventative treatment relative to the inoculation, production of salicylic acid was observed starting 1 hour after the infection.

When the parasite was inoculated without PP1 treatment, a late and low production of salicylic acid was observed.

The PP1 treatment on its own did not cause any salicylic acid production.

### Example 13

### Ethylene Production

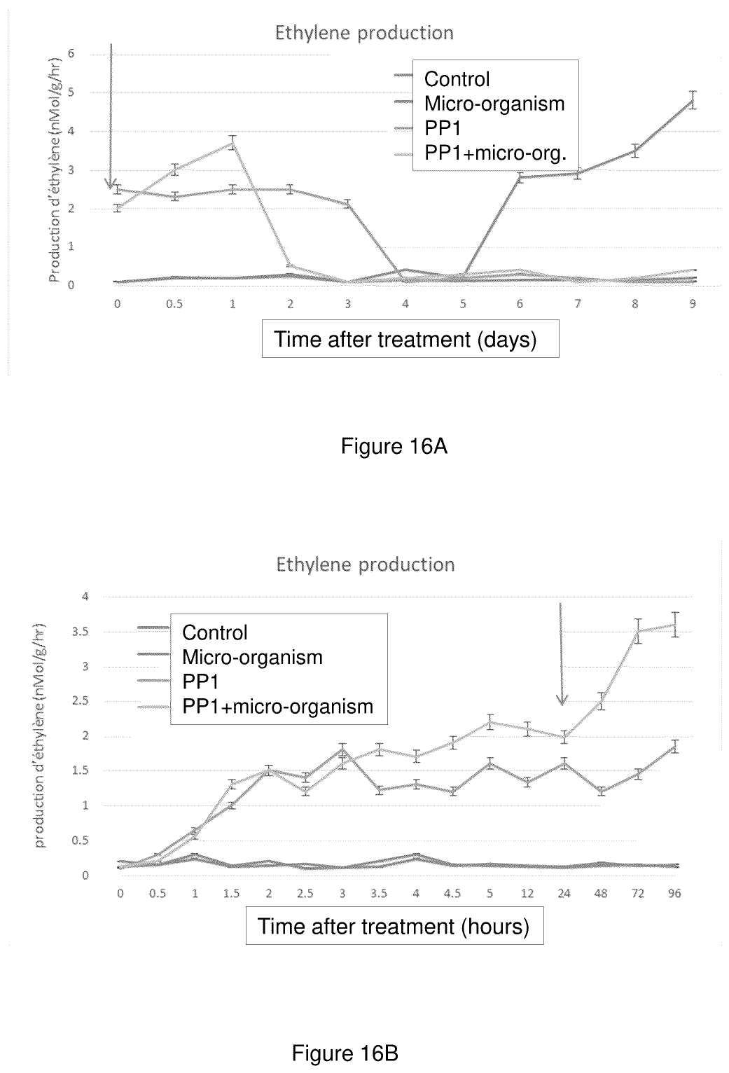

In this experiment, PP1 used on its own caused a high production of ethylene (FIG. 16A), and this production began 1 hour after spraying (FIG. 16B). In the absence of inoculation with the parasite, the level of ethylene is maintained and then falls 3 days after the start of the experiment.

The use of PP1 followed by the inoculation also caused a high production of ethylene (FIGS. 16A-B) which started 1 hour after the product was applied. However, the inoculation with Pseudomonas syringae caused increased production of ethylene (blue arrow, FIGS. 16A-B). In this “PP1+microorganism” modality the level of ethylene then fell rapidly, 2 days after the inoculation (FIG. 16A).

In the case of the inoculation on its own, a high production of ethylene only appeared very late, 6 days after the inoculation.

### Example 14

### Jasmonic Acid Production

In this study, a high production of jasmonic acid was triggered by the spraying with PP1 used on its own. In the absence of the pathogen, the level of jasmonic acid then starts to fall, beginning on the 2nd day, to reach its lowest level 5 days after the start of the experiment.

In the “PP1+microorganism” modality, during the inoculation, the level of jasmonic acid, already high in the plants treated 24 hours earlier with PP1, starts to rise in the 12 hours after the infection (0.5 days). The level of jasmonic acid then starts to fall rapidly, beginning 0.5 days after inoculation, to reach its lowest level 2 days after inoculation.

In the case of the infection with the microorganism on its own, a low peak of jasmonic acid was observed 24 hours after the inoculation. A second, later production of jasmonic acid was also observed, beginning 6 days after the inoculation.

### Example 15

### Peroxidase Activity

Using PP1 on its own caused an increase in the peroxidase activity from 7 days.

Only the “PP1+microorganism” modality showed an early peroxidase activity, beginning 12 hours after the inoculation (0.5 days). This enzymatic activity continued up to 5 days after the inoculation, reaching its lowest level 6 days after the inoculation.

The “microorganism” modality showed a late increase in the enzymatic activity, only beginning 4 days after the inoculation.

### Example 16

### Involvement of the WRKY29 Gene

For carrying out these experiments, the young Arabidopsis thaliana plants were sprayed with the PP1 solution (trials) or water (controls) prior to the inoculation, which was itself carried out by spraying with the bacterial suspension (5,106 cfu·mL-1).

Transgenic Arabidopsis thaliana/GUS Reporter Gene:

An approach was carried out using different transgenic plant lines containing gene promoters (Note: one promoter per gene) involved in controlling the defence, fused to the GUS reporter gene coding the E. coli β-glucuronidase. A blue colouration appears on the plant tissues each time the gene of interest is activated by PP1.

As a result, we were able to study pathways controlled by different hormones such as
1/ transcription factors such as WRKY29 involved in triggering the immune response in Arabidopsis.
2/ or pathways controlled by different hormones, such as salicylic acid (SA), jasmonic acid (JA)

### 1/ The WRKY29 Transcription Factor:

The transgenic Arabidopsis line with the following construction—WRKY29 promoter fused with the GUS gene (P WRKY29:GUS)—was kindly provided by Prof. Dr. Paul Schulze-Lefert (Max Planck Institute for Plant Breeding Research, Department of Plant-Microbe Interactions, Cologne, Germany), and used in the test of PP1's capacity to trigger the defence of plants.

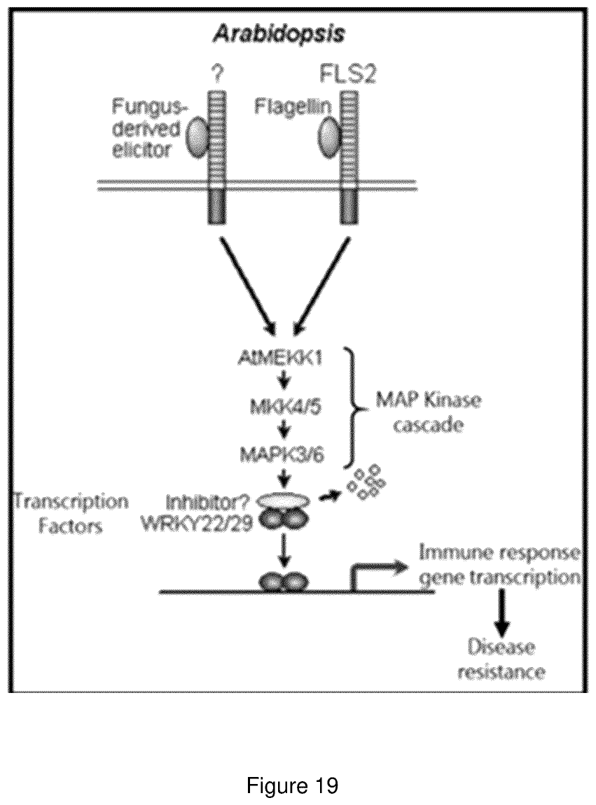

Activation of the WRKY29 gene is a marker of plant resistance (FIG. 19).

In the framework of the defence induced by PP1, our results indicate that PP1 stimulates defence pathways controlled by WRKY29.

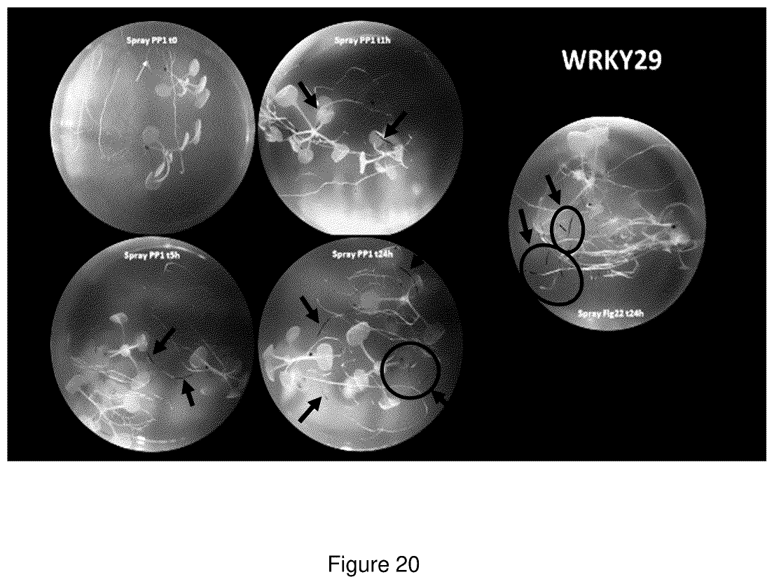

In effect, after stimulation with PP1, the cells are clearly visible in blue (FIG. 20).

### 2/ Salicylic Acid (SA), Jasmonic Acid (JA)

In the same way, PP1 triggers the physiological pathways controlled by jasmonic acid JA, in the absence of the parasite.

However, PP1 does not trigger the pathways under the control of salicylic acid SA in the absence of the pathogen.

### Discussion (Examples 9-16)

The plant/parasite model chosen, Arabidopsis thaliana wild type, showed a compatible relationship with the Pseudomonas syringae bacterial strain. In this context, FIG. 12 and table 25 show the progression of the symptoms and confirm the sensitivity of plants to the pathogen.

When PP1 is sprayed 24 hours before the inoculation, very strong protection of the plants against the parasite is observed, since the plants continue to develop normally with almost no symptoms.

To evaluate the level of resistance induced, several experiments measuring key events in the metabolism of the defence were carried out.

Twenty-four hours after spraying with PP1, the kinetics of O2·− production were observed. When the inoculation occurred after the treatment with PP1, a high production of O2·− was observed beginning 30 minutes after the infection (FIG. 13). Generally, this oxidative burst reaction is characterised by an incompatible relationship between the parasite and its host (resistance situation).

For its part, the inoculation on its own did not cause any oxidative burst, which corresponds to a compatible interaction between the plant and the pathogen.

The treatment of the medium with DPI caused a sharp decrease in O2·− production, indicating that the O2·− production is mainly produced by an NADPH Oxidase.

To confirm this observation, an assay of the oxidative activity of the NADH was carried out (FIG. 14). A strong kinetic correlation can be observed, making it possible to conclude that the oxidative burst observed was indeed generated by an NADPH Oxidase. No oxidative activity was caused by the inoculation with the parasite without PP1 pre-treatment, or by the spraying with PP1 on its own, confirming the results of FIG. 13.

These observations are interesting, because pre-treating with PP1 24 hours before the inoculation seems to enable the plant to react strongly against the parasite. The very early production of O2·− acts not only as a generator of signals for inducing the triggering of defence mechanisms, but also as a compound able to destroy the plant's cells and trap the pathogen at the site of infection, a well-known phenomenon with gene-for-gene relationships in plant/microorganism relationships.

To study the molecular signalling linked to defence, salicylic acid production kinetics were realised. The PP1 spraying on its own, without inoculation, did not cause any salicylic acid production (FIG. 14). This result was then confirmed by the approach using transgenic Arabidopsis thaliana lines (px::GUS, line XCS1).

In contrast, the bacterial inoculation of the plants treated with PP1 caused a very high production of salicylic acid, in the 12 hours after the inoculation (0.5 days) (FIG. 15A). To determine the production timelines of the salicylic acid, a second experiment was carried out over much earlier time intervals (FIG. 15B). After bacterial inoculation of the plants pre-treated with PP1, production of salicylic acid was observed beginning 1 hour after the inoculation (FIG. 15B). This production of salicylic acid continued for up to 5 days after the inoculation, and then decreased gradually.

For its part, the bacterial inoculation caused a late and lower production of salicylic acid, only beginning 4 days post-inoculation (FIG. 15A). This late reaction is not surprising, given that we were studying a compatible plant/pathogen relationship.

On the other hand, and in line with the previous results, pre-spraying with PP1 seemed to give the plant, under the experimental conditions, the ability to recognise its attacker and trigger effective defence mechanisms, making a resistance situation possible.

Ethylene production kinetics were then realised. In this experiment, PP1 used on its own caused a high production of ethylene as of the application of the product (FIG. 16A), a phytohormone known to be involved in the defence mechanisms.

To determine the kinetics of the ethylene production in earlier time intervals, a second experiment was carried out, with sampling between 0 and 96 hours (FIG. 16B). Following the spraying with PP1 (green arrow), a high production of ethylene was observed, beginning 30 mins. after the PP1 treatment. The production of ethylene then falls gradually, to reach its lowest level 4 days after the start of the experiment (FIG. 16A).

The inoculation with Pseudomonas syringae caused increased production of ethylene (FIGS. 16A and 16B, blue arrows) when the plants were pre-treated with PP1. In this case, the production of ethylene fell rapidly, reaching its lowest level 2 days after the inoculation.

In contrast, the bacterial inoculation on its own caused a late production of ethylene, beginning 5 days post-inoculation.

These results confirm the hypothesis suggesting that PP1 enables the plant to recognise its attacker and trigger the same mechanisms as during an incompatible reaction.

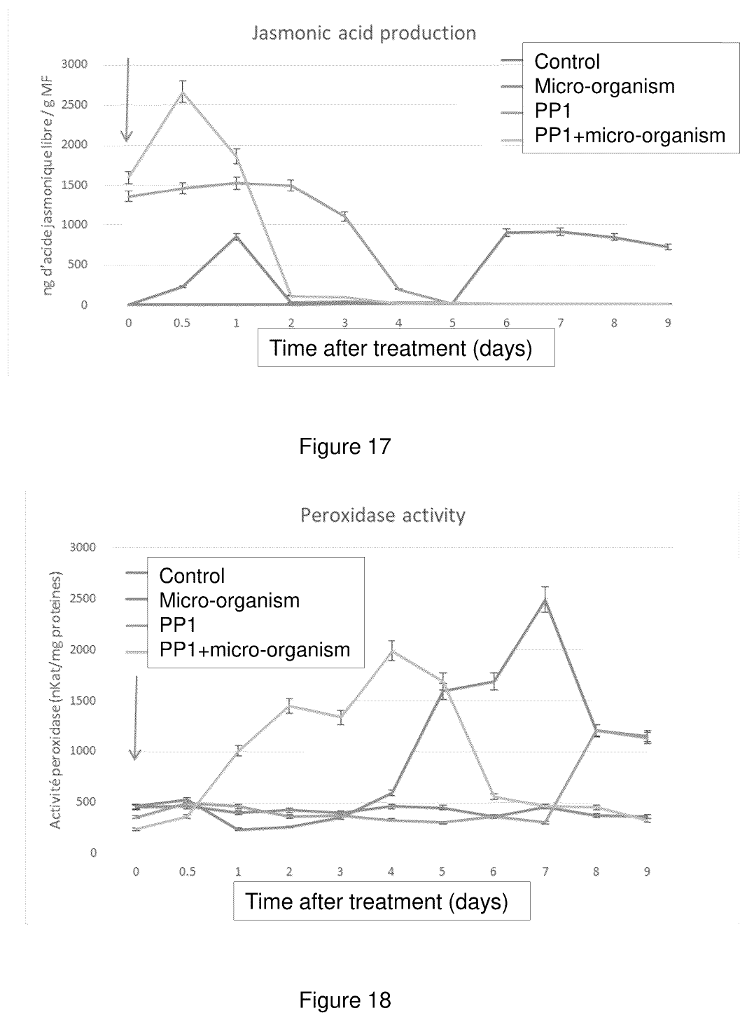

Monitoring the jasmonic acid kinetics showed a high production of this compound as of treatment with PP1 (FIG. 17). This result was also confirmed by the approach using transgenic Arabidopsis thaliana lines which showed a production of jasmonic acid after treatment with PP1, in the absence of the bacteria. The level of jasmonic acid then falls to reach its lowest level 4 days after the start of the experiment.

After inoculation, a high production of jasmonic acid was observed in the 12 hours post inoculation in the plants pre-treated with PP1 (FIG. 17, blue arrow). The level of jasmonic acid then fell rapidly to reach its lowest level 2 days after the start of the experiment.

The bacterial inoculation on its own caused a low peak of jasmonic acid 1 day after inoculation, and a late and slow increase beginning 5 days after the inoculation.

The treatment with PP1 caused a late peroxidase activity (known to be involved in the defence), 7 days after the start of the experiment, in the absence of the pathogen. The peroxidase activity increased significantly 12 hours (0.5 days) after the start of the experiment, in the plants treated with PP1 then inoculated with the bacteria (FIG. 18).

For its part, the bacterial inoculation caused a late increase in the peroxidase activity, 4 days after the start of the experiment.

All the assays carried out suggest that treatments with the described compositions enable the plant to recognise its attacker, even in the compatible interactions. The experiments showed that the mechanisms triggered in the plants pre-treated with PP1 and inoculated with the bacteria are those known to be involved in incompatible relationships and gene-for-gene relationships (oxidative burst, generation of O₂⁻ produced by an NADPH oxidase, and early production of salicylic acid in the hour following the infection). These results were confirmed by the high levels of ethylene, and jasmonic acid, produced in the case of pre-treatment with PP1 followed by the bacterial inoculation. Monitoring of the infection confirmed this hypothesis, given that the level of protection of the described compositions used in a preventive treatment was very high. 2 different signalling pathways are clearly induced, that of salicylic acid, and that of the pathway of ethylene and jasmonic acid.

In contrast, the bacteria inoculated alone showed that the plant, in the absence of treatment with the described compositions, was incapable of defending itself (no oxidative burst, late and low production of the 3 phytohormones tested (salicylic acid, ethylene, jasmonic acid)). The infection on its own, without pre-treatment, showed strong symptoms in, and the decline of, the plants.

The described compositions represent a major advance in the field of plant protection, using biocontrol products. In effect, in line with the results obtained, the described compositions can trigger a genuine “gene-for-gene-like” relationship in the framework of a compatible interaction between the plant and the parasite.

The advantage of this method lies in the fact that only the arrival of the pathogen is able to trigger the defence mechanisms in the plants pre-treated with the described compositions.

The perspectives for use are significant, for example transformation of sensitive plants into resistant plants, by using the described compositions.

Various messengers and mediators, such as salicylic acid, jasmonic acid, ethylene, systemic, and reactive oxygen species, are mentioned above. We gave above detailed scientific data about the role of these messengers and mediators, including the time courses of their induction. Further, the scientific data shows that PP1 in the absence of bacterial pathogen triggers the physiological pathways controlled by jasmonic acid, but not those controlled by salicylic acid.

Note that the results obtained in the context of a bacterial infection can be generalized to viral infections. With few exceptions, defense mechanisms are generalized to all plants and pathogens (sensitivity, tolerance, resistance). The signals are generally the same (i.e., oxidative burst, phytohormones, defense molecules in the case of plant resistance against a pest), but with variations in time, in the sequence of phytohormones, as well as in the induction and feedback of signals between them. It has been shown in some models that certain phytohormones have the ability to inhibit certain metabolic signals, while in other species, the same phytohormones induce them. Each species has its own way of reacting, but overall the similarities between all plant species are very great, in the face of the multitude of pathogens (bacteria, viruses, fungi).

In this context, the Examples given above show that the mechanisms induced by PP1 apply as well to bacteria as to viruses. There are also plant/pathogen specificities, but these specificities are in the details.

The difference between bacteria and viruses is based more on the mode of replication of the virus, totally different from that of bacteria, as described.

In the presence of a pathogen, two different signaling pathways are clearly induced, the salicylic acid pathway and the ethylene-jasmonic acid pathway.

Although the molecular signaling leading to plant resistance is universal, it is also different in detail. Sometimes all the hormones are triggered at the same time (salicylic acid, ethylene, jasmonic acid), and sometimes they are triggered differentially, and sometimes one signaling pathway controls another. We find the same molecules each time, with once again specificities in some species.

The time courses presented may affect the frequency that the extracts would need to be applied, or the amount of time before pathogen exposure at which they could be applied.

These findings inform at the practical level on two points:

1/ There is a need to “retreat” the plant or tree after a certain time on a regular basis, and this is what is observed in the field. In the context of stimulating defense mechanisms, it is necessary to repeat the treatment.

2/ It is preferred to treat the plant or tree before the arrival of the pathogen, to give the plant “the key” to recognize the pathogen. However, the described compositions also work in the case of already contaminated plants.

One exemplified embodiment of the described composition, herein called “CEI” (comprising in particular PP1 to PP4), does not correspond to what the literature describes:

1/ The CEI composition is extracted from leaves, stems, flowers, seeds and/or roots, according to a preferred mode of extraction, with or without added water, according to the method described with reference to FIG. 1. In field use, the composition is preferably diluted in the spray tanks to be sprayed at foliar level (or other methods of application described in the description of uses)

2/ The CEI composition, obtained under these conditions of extraction, has no direct antimicrobial activity.

In the method for producing CEI, the leaves, stems, flowers, seeds and/or roots undergo an extraction of compounds, by a known technique, for example by pressing, by ultrasound, and/or by using solvents, especially oily or aqueous.

In some embodiments of this method, parts of plants are ground and highly diluted in water. In some embodiments of this method, parts of plants are ground without addition of water. Possibly, the filtered ground material is then formulated in the form of powder, by nebulisation in a rising flow of hot, dry air, preferably at a temperature below 60° C. Possibly, the extract in liquid form is sterilised by treatment at a high temperature for a short period of time, according to known techniques.

The elicitor composition that is the subject of the invention is in particular used, by application, for stimulating the defences of plants or trees and reduce the effects of viruses, in particular beet yellowing and cucumber mosaic viruses.

CEI works by stimulating the plants' defences, and by enabling the treated plants to defend themselves against these viruses.

CEI can be defined as an elicitor, given that molecules having the property of inducing in the plant a cascade of defence reactions against the pathogenic agents are called elicitors.

The demonstration of the elector activity of defence mechanisms was also demonstrated at several levels: The demonstration of the production of defence molecules, such as jasmonic acid, salicylic acid, or peroxidases, was carried out after treatment with CEI, under infection conditions on the beet (Beta vulgaris subsp. vulgaris)

CEI has the characteristic of stimulating plants' defences and enabling them to react effectively, even in the case of invasive viruses that are difficult to fight.

As shown in FIG. 1, in an embodiment, the method for producing and using the composition that is the subject of the present invention comprises a step 105 of extracting an extract of said plants.

In some preferred embodiments, the extract is obtained from at least one plant note containing the precursors of Methyl-isothiocyanate and/or Propenyl isothiocyanate.

The inventor has observed that these isothiocyanates may have adverse effects on the plant's growth, while reducing the effects of viruses.

In some embodiments, the extract is obtained from at least one plant containing precursors of butyl-isothiocyanate. The inventor has observed that these isothiocyanates have beneficial effects on the plant's growth, while reducing the effects of viruses.

In some embodiments, the extract is obtained from a plant containing 1,3-thiazepane-2-thione. The inventor has observed that this compound, because of its structure, is not an isothiocyanate, having beneficial effects on the plant's growth while reducing the effects of viruses.

For example, this extraction is performed according to the following procedure:
During a grinding step 110, the leaves, roots, stems, seeds, and/or flowers of said plants are finely ground in tap water, for fifteen minutes, in a suitable mixer device to obtain a homogeneous ground material;
During a filtration step 115, the ground material is filtered to separate waste material from the organs used and obtain a green-coloured liquid without residue (the filtrate), which is the basis of the composition that is the subject of the present invention.

In a variant, water is not added before grinding the source plant parts. In a variant, at least one of the active principles of the ground material is obtained by oil extraction. In a variant, at least one of the active principles of the ground material is obtained by solvent extraction, by mechanical extraction, by microwaves, or by extraction of oil cakes or pastes. In a variant, at least one of the active principles is obtained by mechanical extraction or by microwave extraction.

In a variant, the extraction step 105 comprises a step of compressing the leaves, roots, stems, seeds or flowers of said plants and collecting the liquid extract by gravity or by centrifugation. In a variant, simple centrifugation is utilised during the extraction step 105 to extract the liquid from the parts of said plants used.

As described in the following description, the inventor has discovered that using this composition has a significant effect on the plants and trees mentioned above and infected by one of the viruses mentioned above. The inventor has also discovered that the elicitor composition that is the subject of the invention has biostimulant effects on the growth of the plants treated without constituting, at the doses used, a fertilizer or feeding the plants treated.

Note that the liquid composition obtained at the end of step 105 can be formulated to make it easier to use. For example, it can be used in the form of powder, soluble powder, wettable powder, granules, dispersible granules, wettable granules or slow-diffusion granules, to be diluted in water at the time of use, liquid, soluble concentrated liquid, emulsifiable concentrate, concentrated suspension, or ready-to-use, depending on the formulation chosen and the use envisaged, or infused in to a substrate dispersed in the crop's soil. The formulations are realised using the product from the extraction step 105 according to techniques well known to the person skilled in the art.

Active fractions can possibly be purified, by any means, to facilitate the formulation. Different extraction steps can be added to improve its quality. The composition that is the subject of the invention can be diluted in water, according to the required dose, at the time of its use.

During an optional step 120, volatile extracts are removed from the extract obtained. For example, this extract is transformed into a powder, e.g. by nebulisation and passage of the nebulised extract in a flow of hot air, preferably rising.

With respect to the use, during step 125 the biostimulant is applied in any form whatsoever (liquid, powder, soluble powder, granules, dispersible granules, slow-diffusion granules, etc. formulation) depending on the uses and formulation envisaged. The use of the biostimulant that is the subject of the invention is preferably achieved by foliar application or foliar spraying. Other ways for using the biostimulant that is the subject of the present invention are via a soil drench, irrigation of the soil, drop-by-drop irrigation, hydroponics, seed treatment and/or seed coating.

Preferably, the leaves and the flowers of said plants represent at least 75%, preferably at least 95%, of the part of said plants on which the extraction is carried out, percent by dry weight, relative to the total weight of these plants.

The composition that is the subject of the invention can be used as a single application; at a frequency of between one day and one hundred and twenty days; continuously; according to the key growth stages of the plant; or in accordance with best agricultural practices and the treatment schedules for each plant species. The composition of the present invention can be mixed with other products (phytosanitary products, growing mediums and fertilizing materials, fertilizers, biocides or any other product intended for agriculture).

The application doses and the application frequencies are adjusted to the uses and the plant types. The application doses are, for example, between 0.001 g/L and 2000 g/L of plant extracts, preferably between 2 g/L and 2000 g/L of plant extracts and, more preferably, between 5 g/L and 200 g/L of plant extracts, expressed in grams of plants on which the extraction was carried out per litre of product.

The doses per litre or per hectare may be adjusted to the types of plant infected, to the level of infection and to the level of symptoms caused by the viruses. The doses and the rates of treatment with the product of the present invention will also be adjusted to the strategy of curative or preventive action against these viruses.

With regard to the plants from which the extracts used in the present invention are obtained, they are preferably freshly collected. Alternatively, the plants or the parts of interest are suitably dried, in a way well known to the person skilled in the art. The grinding can be performed with two grinders, which are used with different blade speeds. The first ground material, obtained with 10 min of grinding, is then deposited in the second grinder, which has a faster blade speed. The ground material is homogeneous, with no visible residue of part of the leaves, stems or flowers. The quantity of water added during the grinding is between 0 and 200 mL of water, preferably between 20 and 150 mL of water, and, even more preferably, between 50 and 120 mL of water, at ambient temperature per 100 g of leaves, stems, roots, flowers or seeds.

Two successive filtrations are performed, with a filtration fabric made of nylon (Dutcher, registered trademark) of 1000 μm and then of 500 μm. The filtration is performed at ambient temperature, without pressure. To recover the filtrate that is active, depending on the quantity to be sprayed, the dilution (dose per hectare) is adjusted. Depending on uses, between 5 g of plant extracts per litre of slurry to be sprayed and 2000 g of plant extracts per litre of slurry to be sprayed, as described with reference to examples.

The inventor has observed that the filtrate obtained can be kept for at least six days in a container at ambient temperature without losing its property of stimulating the defences of plants and trees.

The extract of at least one part of said plants can therefore be a liquid extract obtained from ground material of said plants, and:
said extract of at least one plant part comprises at least the leaves of said plants, preferably mainly leaves, and
the method making it possible to obtain said liquid extract comprises the following steps:
a) a step of grinding said plants in an aqueous medium;
b) filtering the ground material obtained; and
c) recovering the liquid extract obtained after filtering.

For the formulation in the form of powder, granules, dispersible granules or slow-diffusion granules, a drying temperature is utilised and, in some embodiments, the coating of particles by other natural molecules (preferably very hydrophilic) that enable very good dissolution in water. The formulations are standard formulations in agriculture, in particular for phytosanitary products, intended to be transported and stored in the form of powder, etc., and diluted in water just before application. The present invention concerns the use of an elicitor composition comprising a plant extract obtained as described above in order to stimulate the defences of plants or trees and reduce the effects of viruses on these plants.

In some embodiments, the elicitor composition that is the subject of the invention also comprises at least one of the following substances, obtained by synthesis or by extraction from plants, in particular the plants mentioned above:
1,3-thiazepane-2-thione, and/or
a brassinosteroid.

The inventor has also discovered that 1,3-thiazepane-2-thione is a powerful elicitor for plants infected by the pathogens described above, whether used as a curative treatment or as a preventive treatment.

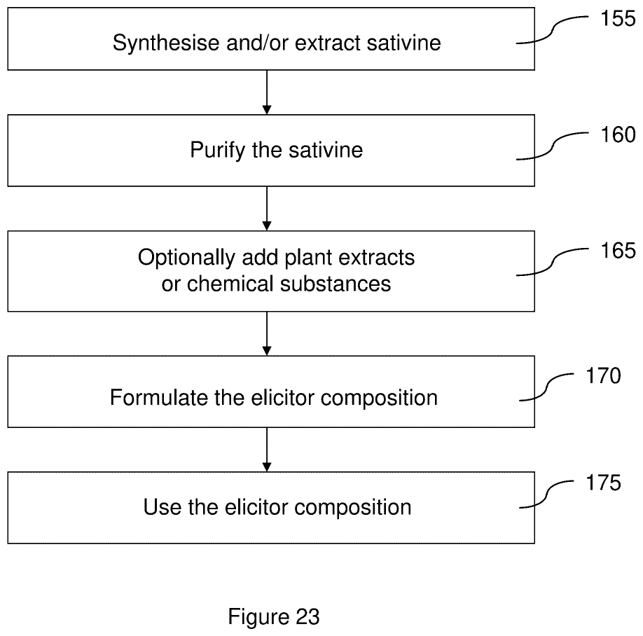

1,3-thiazepane-2-thione has a cyclised structure described in FIG. 23. 1,3-thiazepane-2-thione is a relatively stable compound, even under heat treatment. The 1,3-thiazepane-2-thione used in the elicitor composition that is the subject of the present invention can be obtained by purification of a plant extract. However, in some embodiments, the 1,3-thiazepane-2-thione used in the elicitor composition that is the subject of the present invention is a synthesised 1,3-thiazepane-2-thione.

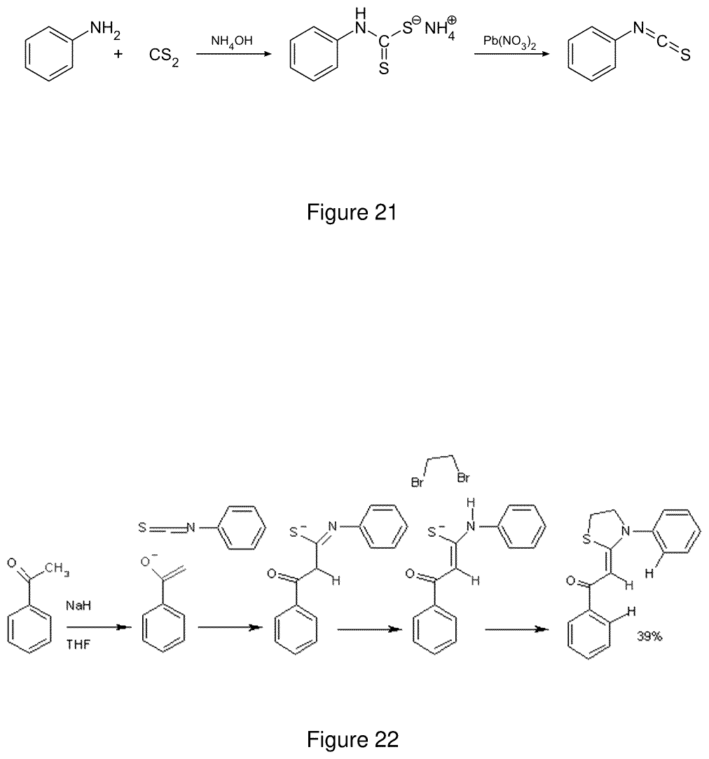

The general method for synthesising isothiocyanates consists of reacting a primary amine (e.g. aniline) with carbon disulphide in aqueous ammonia, which results in the precipitation of the ammonium dithiocarbamate salt, which is then treated with lead nitrate to yield the corresponding isothiocyanate. Another method is based on the decomposition of the dithiocarbamate salts generated in the first step above by tosyl chloride (4-toluenesulfonyl chloride, commonly called tosyl chloride, is a sulfonic acid chloride with the semi-developed formula CH3C6H4SO2Cl·) as illustrated in FIG. 21.

The isothiocyanates are also synthesised by the fragmentation reactions of 1,4,2-oxathiazoles induced thermally. This synthesis methodology has been applied to a polymer-supported synthesis of isothiocyanates, as illustrated in FIG. 22.

The isothiocyanates are also synthesised by the reactions of glucosinolates and the myrosinase enzyme, which acts on the glucosinolates to release the isothiocyanates.

In embodiments, the composition that is the object of the invention is produced by means of a biological reactor or a photo-bioreactor known in the prior art. Particularly, plant cells may be produced according to the membrane reactor described in WO8401959 (PCT/US83/01786) herein incorporated by reference, or within a reactor for cultivating biological material as described in U.S. Pat. No. 4,693,983 herein incorporated by reference, or a cell culture system as described in U.S. Pat. No. 4,661,458 herein incorporated by reference, or a combination thereof. The composition is then extracted from the plant cells as already described.

Note that the elicitor composition can be formulated to make it easier to use. For example, it can be used in the form of powder, soluble powder, wettable powder, granules, dispersible granules, wettable granules or slow-diffusion granules, to be diluted in water at the time of use, liquid, soluble concentrated liquid, emulsifiable concentrate, concentrated suspension, or ready-to-use, depending on the formulation chosen and the use envisaged. The formulations are realised using isothiocyanates according to techniques well known to the person skilled in the art.

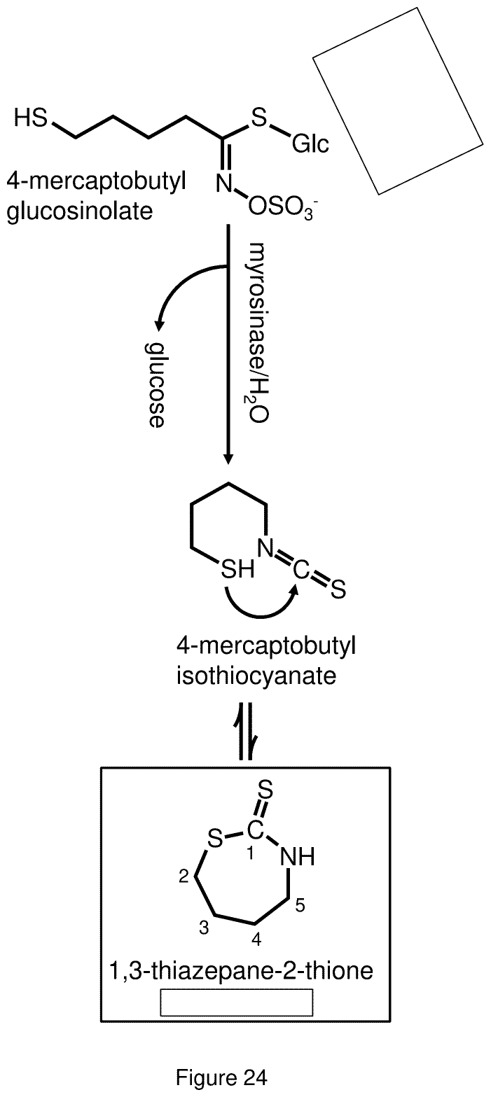

Following the reaction illustrated in FIG. 24, the 4-mercaptobutyl ITC takes the form of its tautomer with a cyclised structure, 1,3-thiazepane-2-thione.

1,3-thiazepane-2-thione can also be synthesised by thionation: the thionation of ketone compounds is the most common route for the synthesis of thiones. Lawesson's reagent is most commonly used for this type of reaction.

The results of the reactions mentioned above can be purified, by any means, to facilitate the formulation.

The elicitor composition comprising said thione (“CEI”) has shown an absence of antibacterial and antifungal effects. To test the antimicrobial effect of CEI, the effect of CEI was evaluated on the growth of six microbial strains:
Bacteria: Burkholderia cepacia, Pseudomonas cichorii, Pseudomonas fluorescens
Moulds: Alternaria alternata, Aspergillus brasiliensis, Aureobasidium melanogenum (formerly A. pullulans)
Viruses: Beet Chlorosis Virus (BChV) and tomato brown rugose fruit virus (ToBRFV).

The sample analysed is the ready-to-use CEI product, at the dosage of use.

### Experimental Conditions:

The protocol followed is based on the European Pharmacopoeia—9th edition § 5.1.3. Effectiveness of the antimicrobial preservation.

The sample was filtered at 0.22 μm and kept refrigerated before use.

For each strain, an inoculum at 104-106 CFU/ml was placed in contact with the product during three to seven days at 22° C.±2° C. Physiological water (NaCl 9 g/l) was subjected to the same treatment as control.

To quantify the contamination at each measurement time, a count was performed by distribution on the surface or in mass of decimal dilutions from 0.1 ml of sample on the following media:
TSA (Tryptic Soy Agar, registered trademark) agar for the bacterial count (incubation: 2-5 days at 30° C.±2° C.);
Sabouraud (registered trademark) agar for the mould count (incubation: 3-7 days at 23° C.±2° C.).

The results were expressed in “colony-forming units” per millilitre (CFU/ml).

This analysis method makes it possible to detect a contamination from 10 CFU/ml (detection limit). Contamination below 10 CFU (<10) cannot be detected.

### Results:

With respect to the bacteria and the viruses, the same behaviour was observed for the three strains. Populations were maintained in the physiological water and increased on contact with the CEI sample.

With respect to the moulds:
For A. alternata, a decrease in populations over time in the physiological water and in the CEI sample was observed.
For A. melanogenum, a maintenance of the population in the physiological water and an increase in the CEI sample was observed.
For A. brasiliensis, a slight decrease of the population in the physiological water and a maintenance in the CEI sample was observed.

However, it has to be noted that the results for the moulds should be tempered by the fact that the formation of filaments makes the count less accurate than that of the bacteria.

Under laboratory analysis conditions, after three and seven days of contact, the CEI sample showed no toxic effect on the strains studied.

In addition, in these same trials, the CEI product was also tested under in vitro conditions on other main fungal species associated with “CoDiRO” disease: Phaeoacremonium, Phaeomoniella, Pleurostomophora, Colletotrichum, Botryosphaeriaceae. The CEI product did not seem to directly inhibit fungal growth in vitro, and each microorganism developed. Nevertheless, in the field, none of these microorganisms was found on the drupes of the treated trees, whereas they were found on the control trees.

In the absence of antibacterial and antifungal effects, CEI works by stimulating the plants' defences, and by enabling the treated plants to defend themselves against the pathogens. The CEI can be defined as an elicitor, given that molecules having the property of inducing in the plant a cascade of defence reactions against the pathogens are called elicitors.

The demonstration of the elicitor activity of defence mechanisms was also demonstrated at several levels: CEI presented no direct antibacterial or antifungal activity as described above. The demonstration of the production of defence molecules, such as jasmonic acid, salicylic acid, or peroxidases, was carried out after treatment with CEI, under infection conditions on the plants and trees treated. In the absence of direct antibacterial and antifungal activities, CEI has the characteristic of stimulating plants' defences and enabling them to react effectively, even in the case of invasive pathogens that are difficult to fight.

The effectiveness of CEI was demonstrated in the following cases, in parallel with a stimulation of the plants' defences:
effectiveness of CEI against Xanthomonas campestris pv juglandis: An in vitro test showed that CEI had no antibacterial activity against Xanthomonas. A high production of salicylic acid and peroxidase was observed in the plants treated and infected.
effectiveness of CEI against Candidatus phytoplasma solani (Stolbur phytoplasma) on Grape Vines (Vitis vinifera). Jasmonic acid was detected in the trees treated with CEI and infected.
In the case of attack by the quarantine organism Xylella fastidiosa in grape vines, CEI was shown to have had no effect on the bacteria's growth in vitro. But, as for the other models, CEI showed significant effectiveness against Xylella fastidiosa in grape vines, by allowing them to regain vigour, and to recommence producing new shoots and fruit.
To understand the operation of CEI on diseased vines, it is very important to decipher how the symptoms observed in the infected vines are produced through infection by Xylella fastidiosa. Plants deploy various defence responses after infection by a specific xylem pathogen, including compounds involved in the constitution of physical barriers (such as the formation of tyloses, for example) or compounds including metabolic pathways linked to defence (such as phenolic compounds, PR proteins, phytoalexins and peroxidases, for example). These compounds are aimed at stopping the spread of pathogens and thus inhibiting their replication (Rapicavoli et al., 2018).

In certain very specific cases, the xylem cells undergo programmed cell death and, as a consequence, are unable to trigger defence responses by their own means (Yadeta and Bart, 2013; Hilaire et al., 2001; Berne and Javornik, 2016; Rep et al., 2002). The vascular pathogens are then probably recognised by receptors in the living parenchyma surrounding the xylem (Yadeta and Bart, 2013; Berne and Javornik, 2016).

In the specific case of Xylella fastidiosa, the bacteria colonise the vessels of the host plant's xylem and cause the production of prolific occlusions in the xylem, which reduces hydraulic conductivity in the plant (Sun et al., 2013; Choat et al., 2009). Wilting of plant parts as a result of xylem dysfunction is the most conspicuous symptom of this type of disease. Daugherty (2010) has shown clearly in his studies that Xylella induces hydric stress in alfalfa. Many factors can contribute to xylem occlusion, such as the high- and low-molecular weight polysaccharides secreted by the bacteria during xylem colonisation, or the presence of pathogen biomass (bacterial cells) (Yadeta and Bart, 2013).

However, the defence responses of plants can also contribute to xylem occlusion, such as the formation of tyloses by the parenchymatous cells and the secretion of gums and gels (Fradin and Thomma, 2006; Klosterman et al., 2009; Beattie, 2011). Embolism (the formation of air bubbles) in xylem vessels is another factor that can reduce the hydraulic conductivity of the xylem (Pérez-Donoso et al., 2007).

Nevertheless, this effective stress response can turn against the plant itself. Various studies, in particular on grape vines (Vitis vinifera), have shown that the extensive formation of vascular occlusions in the plant does not hinder the systemic spread of the pathogen, but can significantly reduce the plant's water conduction and thus contribute to the development of symptoms of the disease (Sun et al., 2013).

Thanks to studies carried out on other crops attacked by Xylella fastidiosa, such as grape vines, by Pérez-Donoso (2007) showed (by using magnetic resonance imaging) that the vascular obstructions resulting from the grape vine's active responses to the presence of Xylella, introduce a reduction in xylem conductivity and probably other aspects of the disease. These blockage symptoms may be linked to the plant's defence rather than the direct action of the bacteria.

However, the results obtained with CEI showed that the vines infected and treated with CEI were able to overcome these occlusions in the vessels caused by the formation of tyloses, gums or gels, and the blockage syndrome therefore became reversible. The infected trees resumed their growth after treatment with CEI. This allows us to formulate two hypotheses, which may be complementary rather than exclusive:

1. CEI enables the implementation of mechanisms to break down tyloses, gums or gels obstructing vessels in the vine by specific enzymes or processes (in association with metabolic mechanisms linked to defence, such as phenolic compounds, PR proteins, phytoalexins, etc.).

2. CEI enables the active development, in response to the infection, of new xylem vessels that will conduct the sap.

Although it has no antimicrobial activity, CEI has significant effectiveness against various pathogens in the field that are difficult to defeat.

As described in the following description, the inventor has discovered that using this product has a significant effect on the plants and trees mentioned above and infected by one of the pathogens mentioned above.

The composition comprising the thione, subsequently called “CEI”, does not correspond to what the literature describes:

1/ The CEI composition may be extracted from leaves, stems, flowers, seeds and/or roots, according to a preferred mode of extraction, with or without added water, according to the method described with reference to FIG. 21. In field use, the composition is preferably diluted in the spray tanks to be sprayed at foliar level (or other methods of application described in the description of uses)

2/ The CEI composition, obtained under these conditions of extraction, has no direct antimicrobial activity.

In the method for producing CEI, the leaves, stems, flowers, seeds and/or roots undergo an extraction of compounds, by a known technique, for example by pressing, by ultrasound, and/or by using solvents, especially oily or aqueous.

In some embodiments of this method, parts of plants are ground and highly diluted in water. In some embodiments of this method, parts of plants are ground without addition of water. Possibly, the filtered ground material is then formulated in the form of powder, by nebulisation in a rising flow of hot, dry air, preferably at a temperature below 60° C. Possibly, the extract in liquid form is sterilised by treatment at a high temperature for a short period of time, according to known techniques.

The elicitor composition comprising the thione is in particular used, by application, for stimulating the defences of plants or trees and reduce the effects of viruses, in particular beet yellowing and cucumber mosaic viruses.

CEI works by stimulating the plants' defences, and by enabling the treated plants to defend themselves against these viruses.

CEI can be defined as an elicitor, given that molecules having the property of inducing in the plant a cascade of defence reactions against the pathogenic agents are called elicitors.

The demonstration of the elector activity of defence mechanisms was also demonstrated at several levels: The demonstration of the production of defence molecules, such as jasmonic acid, salicylic acid, or peroxidases, was carried out after treatment with CEI, under infection conditions on the beet (Beta vulgaris subsp. vulgaris)

CEI has the characteristic of stimulating plants' defences and enabling them to react effectively, even in the case of invasive viruses that are difficult to fight.

1,3-thiazepane-2-thione is a relatively stable compound, even under heat treatment, while the ITCs of Eruca sativa are broken down.

FIG. 23 illustrates a particular embodiment of the method for producing and using the elicitor composition comprising the thione. During a step 155, the synthesis or the extraction, from a plant, of 1,3-thiazepane-2-thione is carried out. For example, the extraction is carried out according to one of the methods described above with regard to synthesis. According to another example, the extraction is carried out according to the method described above with regard to FIG. 1, by grinding, possibly in the presence of water, filtration and purification. As illustrated in FIG. 1, in an embodiment, the method for producing and using the composition comprising the thione comprises a step 105 of extracting an extract of plants containing a precursor of 1,3-thiazepane-2-thione, for example a rocket plant, in particular Eruca sativa, Diplotaxis tenuifolia or broccoli, or a plant genetically modified to produce this precursor.

For example, this extraction is performed according to the following procedure:
During a grinding step 110, the leaves, roots, stems, seeds, and/or flowers of said plants are finely ground in tap water, for fifteen minutes, in a suitable mixer device to obtain a homogeneous ground material;
During a filtration step 115, the ground material is filtered to separate waste material from the organs used and obtain a green-coloured liquid without residue (the filtrate), which is the basis of the composition.

In a variant, water is not added before grinding the source plant parts. In a variant, at least one of the active principles of the ground material is obtained by oil extraction. In a variant, at least one of the active principles of the ground material is obtained by solvent extraction, by mechanical extraction, by microwaves, or by extraction of oil cakes or pastes. In a variant, at least one of the active principles is obtained by mechanical extraction or by microwave extraction.

In a variant, the extraction step 105 comprises a step of compressing the leaves, roots, stems, seeds or flowers of said plants and collecting the liquid extract by gravity or by centrifugation. In a variant, simple centrifugation is utilised during the extraction step 105 to extract the liquid from the parts of said plants used.

As described in the following description, the inventor has discovered that using this composition has a significant effect on the plants and trees mentioned above and infected by one of the viruses mentioned above. The inventor has also discovered that the elicitor composition comprising the thione has biostimulant effects on the growth of the plants treated without constituting, at the doses used, a fertilizer or feeding the plants treated.

Note that the liquid composition obtained at the end of step 105 can be formulated to make it easier to use. For example, it can be used in the form of powder, soluble powder, wettable powder, granules, dispersible granules, wettable granules or slow-diffusion granules, to be diluted in water at the time of use, liquid, soluble concentrated liquid, emulsifiable concentrate, concentrated suspension, or ready-to-use, depending on the formulation chosen and the use envisaged, or infused in to a substrate dispersed in the crop's soil. The formulations are realised using the product from the extraction step 105 according to techniques well known to the person skilled in the art.

Active fractions can possibly be purified, by any means, to facilitate the formulation. Different extraction steps can be added to improve its quality. The composition comprising the thione can be diluted in water, according to the required dose, at the time of its use.

During an optional step 120, volatile extracts are removed from the extract obtained. For example, this extract is transformed into a powder, e.g. by nebulisation and passage of the nebulised extract in a flow of hot air, preferably rising.

During an optional step 160, purification on the products of the reaction or the extraction is carried out, to increase the 1,3-thiazepane-2-thione content and, possibly, reduce the content of impurities and of potentially toxic products.

In some embodiments, the elicitor composition comprises, as the only active compound, 1,3-thiazepane-2-thione. The step 160 is therefore not carried out.

During an optional step 165, 1,3-thiazepane-2-thione coming from other sources, GLS precursors, (poly)phenolic compounds and/or at least one brassinosteroid is added to the composition comprising 1,3-thiazepane-2-thione.

However, preferably, the elicitor composition comprises, as principal active compound, 1,3-thiazepane-2-thione.

During a step 170, the elicitor composition is formulated.

With respect to the use of the elicitor composition, during the step 175 it is applied in any form whatsoever (liquid, powder, soluble powder, granules, dispersible granules, slow-diffusion granules, etc. formulation) depending on the uses and formulation envisaged. The use of the elicitor composition comprising the thione is preferably used by means of foliar application or spraying. In other modes of application, a soil drench, irrigation of the soil, drop-by-drop irrigation, hydroponic cultivation, seed treatment and/or seed coating are utilised. The elicitor composition can be diluted in water depending on the required dose, at the time of its use.

The elicitor composition can be used in a single application, at a rate of between one day and one hundred and twenty days, or continuously, or according to the key growth stages of the plant, in accordance with best agricultural practices and the treatment schedules for each plant species. The elicitor composition can comprise other products (phytosanitary products, growing mediums and fertilizing material, fertilizers, or any other product intended for agriculture). The application doses and the application frequencies are adjusted to the uses and the plant types.

The doses per litre or per hectare may be adjusted to the types of plant infected, to the level of infection and to the level of symptoms caused by the viruses. The doses and the rates of treatment with the product comprising the thione will also be adjusted to the strategy of curative or preventive action against these viruses.

With regard to the plants from which the extracts used are obtained, they are preferably freshly collected. Alternatively, the plants or the parts of interest are suitably dried, in a way well known to the person skilled in the art. The grinding can be performed with two grinders, which are used with different blade speeds. The first ground material, obtained with 10 min of grinding, is then deposited in the second grinder, which has a faster blade speed. The ground material is homogeneous, with no visible residue of part of the leaves, stems or flowers. The quantity of water added during the grinding is between 0 and 200 mL of water, preferably between 20 and 150 mL of water, and, even more preferably, between 50 and 120 mL of water, at ambient temperature per 100 g of leaves, stems, roots, flowers or seeds.

Two successive filtrations are performed, with a filtration fabric made of nylon (Dutcher, registered trademark) of 1000 μm and then of 500 μm. The filtration is performed at ambient temperature, without pressure.

For the formulation in the form of powder, granules, dispersible granules or slow-diffusion granules, a drying temperature is utilised and, in some embodiments, the coating of particles by other natural molecules (preferably very hydrophilic) that enable very good dissolution in water. The formulations are standard formulations in agriculture, in particular for phytosanitary products, intended to be transported and stored in the form of powder, etc., and diluted in water just before application.

The present invention also concerns the use of crushed material obtained from at least one part of “rocket” plants for:
stimulating the root growth of plants;
stimulating plant growth;
precocity of plant growth;
increasing the production of flowers and/or seeds and/or fruit; and/or
the resistance of plants subjected to water stress.

The crushed material, which serves to supply the biostimulant that is the subject of the present invention, can be used by foliar spray or watering the soil.

In a variant, at least one active ingredient of the crushed material is obtained by aqueous extraction or solvent extraction.

In a variant, at least one active ingredient of the crushed material is obtained by extraction of oil cakes or pastes of rocket.

For the use of this crushed material, during a step 120, this liquid crushed material is sprayed at foliar level on the plants to be treated, or used in watering the soil.

The inventor has discovered that the use of crushed material has a significant effect on the growth of plants.

It is noted that the liquid crushed material obtained at the end of step 115 can be formulated to make it easier to use. For example, it is used in the form of powder, granules, dispersible granules or slow-diffusion granules, depending on the formulation chosen and the envisaged uses. The formulations are realized using the crushed material from the extraction step 105.

Active fractions may potentially be purified, by any means whatsoever, to facilitate the formulation. Different extraction steps can be added to improve its quality.

The crushed material can be diluted in water depending on the required dose, at the time of its use.

With respect to the use and formulation of the crushed material, the finished product, or biostimulant which is formed from this crushed material, can be applied in any form whatsoever (liquid, powder, soluble powder, granules, dispersible granules, slow-diffusion granules, etc formulation) depending on the uses and the formulation chosen. The crushed material that is the subject of the present invention can be used by foliar spray, watering the soil, drop-by-drop irrigation, use in hydroponics, seed treatment, seed coating, etc.

The crushed material can be used at a rate of between one day and one hundred and twenty days, or continuously, or according to the key growth stages of the plant, in accordance with best agricultural practices and the treatment schedules for each plant species. The crushed material can be mixed with other products (phytosanitary products, growing mediums and fertilizing material, fertilizers, or any other product intended for agriculture). The application doses and the rates of application are adapted to the uses and the plant types. The application doses are, for example, between 0.01 g/L and 12 g/L.

The crushed material can be used as root growth stimulator and for stimulating plant growth. The crushed material, used for watering the soil, or as a foliar spray, seed treatment or seed coating, makes it possible to increase root growth (growth of secondary roots, production of root hairs, etc) and stimulates the growth of the plant (increased number and size of fruit, earliness of the harvest, increased foliar growth, etc).

The BBCH method is widely employed in smart farming and recommended by the vast majority of scientists working to establish a link between phenology and industrial agriculture. In the BBCH scale, plant development is broken down into principal and secondary plant growth stages, both numbered 0-9. To avoid substantial shifts from the phenological approach widely used earlier, BBCH adopted a decimal code based on the well-known Zadoks cereal scale. The standard BBCH scale is used for any species that lacks a dedicated scale or serves as a framework within which individual scales can be developed. The following are ten stages of plant growth in the BBCH scale:

### Stage 0: Germination, Sprouting, Bud Development

Despite their distinct biological processes, germination, sprouting, and bud development were all lumped under the same primary plant growth stage. Depending on the type of crop, growth phase 0 can last anywhere from a few days to a few weeks. At this point in the plant's development, the seed has sprouted and produced what are called “seed leaves,” which are easily distinguished from the mature leaves. Primarily, the germination and budding stage of plant growth requires the right temperature and oxygen levels. Additionally, it depletes the nutritional reserves of plants, potentially leading to nutrient deficiency without additional fertilization. A state of dormancy is often needed beforehand. At growth phase 0, the crop constantly requires water to kickstart a healthy metabolism. A shoot becomes a seedling when it is above ground.

### Stage 1: Leaf Development

The leaf's photosynthetic power is the foundation upon which the entire plant builds. Thus, stage 1 of plant growth is essential for the crop's normal development. All the plant nutrients by this stage of growth will help it through the next phases of its development. At growth stage 1, the plant produces “genuine” or “mature” leaves, which are miniature copies of the fully developed leaves. Leaf development is guided by a universal fundamental program, varying a little to suit the needs of individual species and environmental conditions. Leaves develop into flat structures of varying sizes and shapes, beginning on the shoot's apical meristems. Hormones in plants, as well as transcriptional regulators and mechanical qualities of the tissue, all play a role in controlling this process.

### Stage 2: Side Shoots Formation or Tillering

Tillering is the plant growth stage during which new aerial shoots form. Rather than spreading out like rhizomes and stolons, tillers grow vertically. The outcome is a considerable rise in the number of new shoots occurring immediately adjacent to the initial shoot. “Daughter plants” occasionally refer to the new shoots that develop from the “parent plant.” Tillering can also mean the development of side shoots. Each new shoot comprises a central growth point, which eventually develops into a jointed stem defined by nodes and internodes similar to a bamboo pole.

### Stage 3: Stem Elongation or Rosette Growth and Shoot Development

Some parts of the plant, like stems and roots, keep growing throughout the plant's life: this process is called indeterminate growth. New cells are produced at the tips of growing shoots. Growth in stems occurs at many different sites, unlike just a few in the root system. The duration and intensity of these changes vary between species, but individual crops within a single species tend to comply with some norms. Global warming significantly impacts the plant at growth stage 3 of its growth due to the direct correlation between temperature and stem elongation.

### Stage 4: Development of Vegetative Plant Parts or Booting

The development of strong stems and plenty of green leaves characterizes the vegetative stage of plant growth. These processes are critical because photosynthesis relies on sufficient leaf surface area to absorb light. Notably, healthy leaf development usually follows strong root growth.

### Stage 5: Inflorescence, Emergence or Heading

Inflorescence emergence is the process by which a cluster of flowers is arranged along a floral axis. Heading refers to the process by which a seed head emerges from the sheath formed by the flag leaf. The fact that this is the start of the reproductive growth phases is the unifying factor that groups these two different biological processes into one phase of plant development. At growth stage 5, a plant's primary focus shifts from vegetative expansion to developing reproductive structures such as flowers and then fruits.

### Stage 6: Flowering

During growth stage 6, flowering plants create the reproductive structures necessary for sexual reproduction. Annuals only live for one year, and their flowering and subsequent demise coincide. In biennials, the first year is spent in the vegetative phase, and the second is devoted to flowering and dying. Most perennials will continue to bloom every year if the conditions allow. Flowering is among the critical stages of crop growth for irrigation. The advent of gibberellin, a plant hormone, a specific temperature, and the length of day and night (photoperiod) are the most common triggers for flowering in many plants. Without a period of wintertime cold, the flowering time of many annual plants (such as winter wheat) and biennial plants is delayed. Vernalization describes the transformation that results from this extended period of frigid temperatures.

### Stage 7: Development of Fruit

There has been a lot of focus in plant biology and horticulture on the plant growth stage when fruits are developing. In most flowering plants, fruit development occurs in the ovary after fertilization. A mature ovary is called a “fruit” because of its edible qualities. The fruit is a safe haven for the growing embryo and its seeds since it encloses them.

Fleshy fruit development is generally broken down into four phases
In the first phase, known as floral development, the identity, number, and shape of floral organs are established.
With fertilization comes the onset of the second phase, cell division.
In the third phase, cells undergo fast expansion and endoreduplication until ripening begins.
The fruit's flavor, texture, nutritional components, and appearance are determined during the ripening stage, the fourth phase that begins after fruit growth stops.

At this point, plants can continue to develop without the need for nitrogen.

### Stage 8: Ripening and Maturity of Fruit and Seed

At the ripening stage of plant growth, fruits typically respond to a ripening signal: a surge in ethylene production. Infection with bacteria or fungi, as well as harvesting the fruit, can stimulate the synthesis of ethylene, signaling the ripening process. As soon as the fruit gets this ethylene signal, it goes through a series of changes that lead to it ripening. To put it another way, new enzymes are manufactured. Enzymes such as amylase and pectinase aid in the digestion of starch and pectin, respectively, and hydrolases assist in breaking down compounds within the fruits. The genes responsible for the transcription and translation of these enzymes are turned on by ethylene. Enzymes catalyze reactions that modify the fruit's properties: color, texture, flavor, and scent.

### Stage 9: Senescence and Beginning of Dormancy

There are telltale signs of senescence: degenerative alterations in the cells, commonly linked to an increase in waste products and a change in metabolism. Plant senescence is regulated by many environmental factors, the most prominent of which are photoperiod and temperature. The onset of winter dormancy is signaled by leaf drop in perennial plants. Towards the end of the growing season, shorter days and cooler temperatures trigger leaf senescence in many trees. The green chlorophyll disappears, and the yellow and orange carotenoid pigments become more noticeable. The length of the day may govern leaf senescence in deciduous trees through its effect on hormone metabolism.

Trees are particular plants. Their development is similar but vocabulary may differ.

### Tree Seed.

Some tree seeds have a protective shell like a nut. Other seeds are contained in fleshy fruits. Certain maples and sycamores have helicopter-like seeds that twirl to the ground called “samaras.” Over millennia, seeds have evolved into different types and shapes so they can be dispersed by wind, water or animals. Each seed has all the resources it needs to survive until it reaches a favorable place to sprout and grow.

### Tree Sprout.

If certain environmental conditions are met, germination of the embryo contained in the seed can occur. The embryo depends on the supply of food stored in the seed for the energy necessary to grow, expand, and break through the seed coat. Once the seed has found the right conditions, it needs to secure itself. The first root breaks through the seed, anchoring it and taking in water for the developing plant. The next stage in germination is the emergence of the embryonic shoot. The shoot pushes up through the soil, with the shoot leaves either poking above ground or rotting underneath as the rest of the shoot grows above. The root grows down into the soil to search for water and nutrients, while the sprout pushes upward seeking sunlight. If the sprout succeeds, the leaves will develop and allow the tree to create its own food through photosynthesis.

### Seedling

A shoot becomes a seedling when it is above ground. The sprout grows and gradually takes on woody characteristics. The soft stem begins to harden, change from green to gray or brown, and develop a thin bark. More leaves or needles sprout from newly formed branches seeking light. The tree roots also continue to grow and branch out. The majority of the tree's roots are near the surface of the soil, in order to absorb available water and nutrients and to breathe, as roots also require oxygen.

### Sapling

A tree becomes a sapling when it is over 3 feet tall. The length of the sapling stage depends on the tree species, but saplings have defining characteristics: flexible trunks, smoother bark than mature trees and inability to produce fruit or flowers. However, according to the Texas A&M Forest Service, a tree is generally considered to be in the sapling stage when it is between 1 and 4 inches in diameter at 4.5 feet. This is the standard height where a tree's diameter is measured, known as the “DBH” or “diameter at breast height.” It is in the juvenile stage of its life, when it is yet unable to produce fruit or flowers. The length of this stage depends on the species of tree, and trees with longer overall lifespans will generally be saplings for a longer period.

### Mature Tree.

A tree becomes mature when it starts producing fruits or flowers, and can begin the reproductive process of dispersing seeds. Again, how long it remains in this productive stage will depend on the species. During this stage in the life cycle, a tree will grow as much as its species and site conditions will permit.

### Decline and Snag.

Many factors can contribute to the death of trees. Usually it is a combination of conditions, such as injury, drought, disease, rot, and insects, to name a few.

The biostimulant and the method that are the subject of this invention can be applied to the plants and trees at any stage of their development. However, the application of this biostimulant and this method are particularly efficient for germinated plants and trees and more particularly after stage 0 of the BBCH code of development, or during and after seedling, and even more particularly after stage 1 and before stage 9, or between (and including) side shoots formation and maturity of fruits and/or seeds. As shown in many examples given in the description, the biostimulant and process that are the subject of the invention proves particularly efficient during stages 3 to 8 of the BBCH code of development.

Elements showing the effectiveness of the composition that is the subject of the present invention are given below.

Statistical processing of the data: An analysis of variance was performed on the results of each reading. For each reading, the analyses were performed without including the control. When the assumptions of the analysis of variance were met, a mean comparison was performed using the Newman-Keuls test with the 5% threshold. The ranking produced by this test is presented with the results in the form of letters (a, b, c). The means followed by the same letter are not significantly different.

### 1/ Tomatoes

The finished product produced from the rocket (Eruca sativa) crushed material, applied at a rate of ten days, allowed the number of tomatoes per plant and the total harvest weight to be increased significantly. Using the crushed material that is the subject of the present invention (here labeled “FERTI01”) was more effective than using the chosen baseline product, Osiryl (registered trademark) root growth stimulator, approved in France under marketing authorization number 1030003, referred to, below, as the baseline.

For tomatoes, the application methods comprised watering the soil utilizing a liquid formulation. Table 1 shows the effectiveness of using crushed material that is the subject of the present invention on tomatoes, for a control plant, a plant treated with the baseline product.

TABLE 1
Effectiveness on tomatoes (20 plants/method)

| | | | | | FERTI |
|---|---|---|---|---|---|
| Crop | Reading | Dates | Control | Baseline | 01 |
| Tomato | Mean number | Harvests | 9 a | 11.25 ab | 14.50 b |
| Lycopersicon | of tomatoes | Jul. 2, | | | |
| esculentums | per plant over | 2011 to | | | |
| MILL. | the harvest | Jul. 30, | | | |
| | period | 2011 | | | |
| | Total harvest | | 25.65 a | 31.75 ab | 43.80 b |
| | weight (kg) | | | | |
| | per method | | | | |

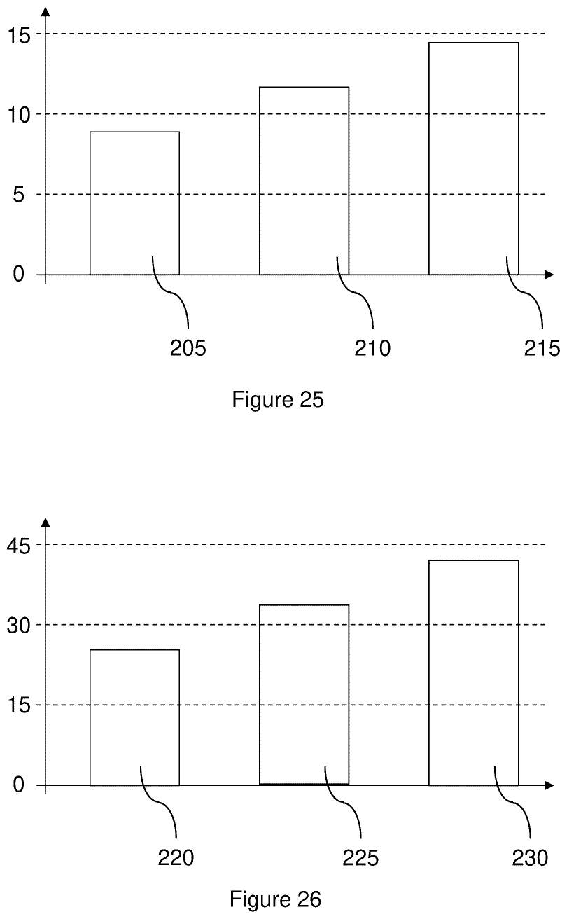

FIG. 25 shows the mean number of tomatoes per plant and per method, from table 1. It shows the mean number of tomatoes per control plant 205; the mean number of tomatoes per plant treated with the baseline product 210; and the mean number of tomatoes per plant treated with the finished product from the crushed material 215.

FIG. 26 shows the total weight (in Kg) of tomatoes harvested per method over the harvest period, from table 1. It shows the total weight of tomatoes harvested in the method of control plants 220; the total weight of tomatoes harvested in the method of plants treated with the baseline product 225; and the total weight of tomatoes harvested in the method of plants treated with the finished product from the crushed material 230.

In the trial conditions, the effectiveness of using crushed material that is the subject of the present invention on tomatoes has therefore been demonstrated, in comparison to the baseline product approved in France, which is a root growth stimulator.

For this trial, seven applications were carried out, at ten-day intervals. The observations were recorded for the tomatoes harvested over a 28-day harvest period.

The results show that the mean number of tomatoes per plant for the plots treated using crushed material that is the subject of the present invention (14.50 tomatoes/plant) was higher than the mean number of tomatoes per plant in the plots not treated, or treated with the baseline product (9 and 11.25 tomatoes/plant, respectively) (table 1 and FIG. 25).

The observations also show that the total harvest weight of the plots treated using crushed material that is the subject of the present invention (43.80 kg) was higher than the total harvest weight in the plots not treated, or treated with the baseline product (25.65 and 31.75 kg, respectively) (table 1 and FIG. 26).

Seven applications, at ten-day intervals, of the finished product from the crushed material allowed the number of tomatoes per plant and the total harvest weight of the treated tomato plants to be increased significantly.

Lastly, it is noted that the results of this trial were obtained over a short harvest period (28 days).

### 2/ Lettuces

The finished product from the rocket (Eruca sativa) crushed material (here labeled “FERTI01”), applied at a rate of ten days, allowed the diameter of the lettuces and the weight of the treated lettuces to be increased significantly. Using crushed material that is the subject of the present invention was statistically more effective than using the baseline product Osiryl mentioned above.

For lettuces, the methods of applying the finished product from the crushed material comprised watering the soil utilizing a liquid formulation. Table 2 shows the effectiveness of using crushed material that is the subject of the present invention on lettuces, for a control plant, a plant treated with the baseline product, and the lettuce treated using crushed material that is the subject of the present invention.

TABLE 2
Effectiveness on lettuces (10 plants/method)

| | | | | | FERTI |
|---|---|---|---|---|---|
| Crop | Reading | Dates | Control | Baseline | 01 |
| Lettuce | Mean diameter of | At harvest: | 20.1 a | 21.2 a | 25.33 b |
| Lactuca | the lettuces (cm) | Mar. 12, | | | |
| sativa | Mean weight of | 2011 | 280.5 a | 283.1 a | 295.3 b |
| | the lettuces (g) | | | | |

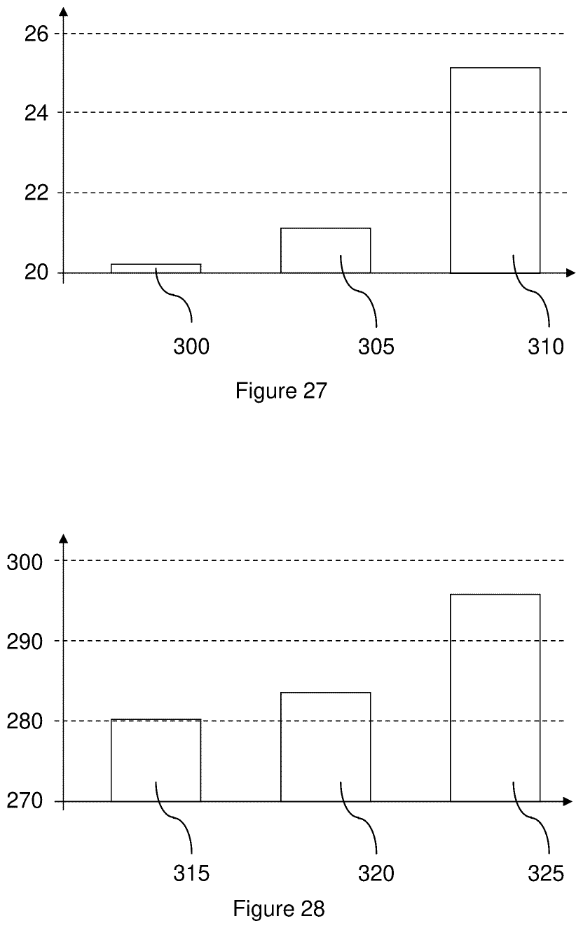

FIG. 27 shows the mean diameter of the lettuces per method, from table 2. It shows the mean diameter of the control lettuces 300; the mean diameter of the lettuces treated with the baseline product 305; and the mean diameter of the lettuces treated using crushed material that is the subject of the present invention 310.

FIG. 28 shows the mean weight of the lettuces per method, from table 2. It shows the mean weight of the control lettuces 315; the mean weight of the lettuces treated with the baseline product 320; and the mean weight of the lettuces treated using crushed material that is the subject of the present invention 325.

For this trial, seven applications were carried out at ten-day intervals. The observations were recorded for the lettuces harvested.

In the trial conditions, the observations show that the mean weight of the lettuces was statistically higher for the lettuces treated using crushed material that is the subject of the present invention (295.3 g/lettuce) than for the lettuces not treated, or treated with the baseline product approved in France as root growth stimulator (280.5 and 283.10 g/lettuce, respectively) (Table 2 and FIG. 28).

Seven applications, at ten-day intervals, of the crushed material allowed the diameter and weight of the lettuces to be increased. Using crushed material that is the subject of the present invention was statistically more effective than using the baseline product.

### 3/ Cucumbers

The finished product from the rocket (Eruca sativa) crushed material (here labeled “FERTI01”), applied at a rate of ten days, allowed the number of cucumbers per plant and the total harvest weight of the treated plants to be increased significantly. Using crushed material that is the subject of the present invention was statistically more effective than using the baseline product described above.

For cucumbers, the methods of applying the finished product from the crushed material comprised watering the soil utilizing a liquid formulation.

Table 3 shows the effectiveness of using crushed material that is the subject of the present invention on cucumbers, for a control plant, a plant treated with the baseline product approved in France, and a plant treated with the crushed material.

TABLE 3
Effectiveness on cucumbers (20 plants per method)

| | | | | | FERTI |
|---|---|---|---|---|---|
| Crop | Reading | Dates | Control | Baseline | 01 |
| Cucumber | Mean number | Harvests | 4.10 a | 7.20 b | 10.12 c |
| Cucumis | of cucumbers | Jun. 11, | | | |
| sativus | harvested | 2011 to | | | |
| L. (CUMSA) | per plant | Jul. 30, | | | |
| | Total harvest | 2011 | 10.25 a | 22.22 b | 29.15 c |
| | weight (kg) | | | | |

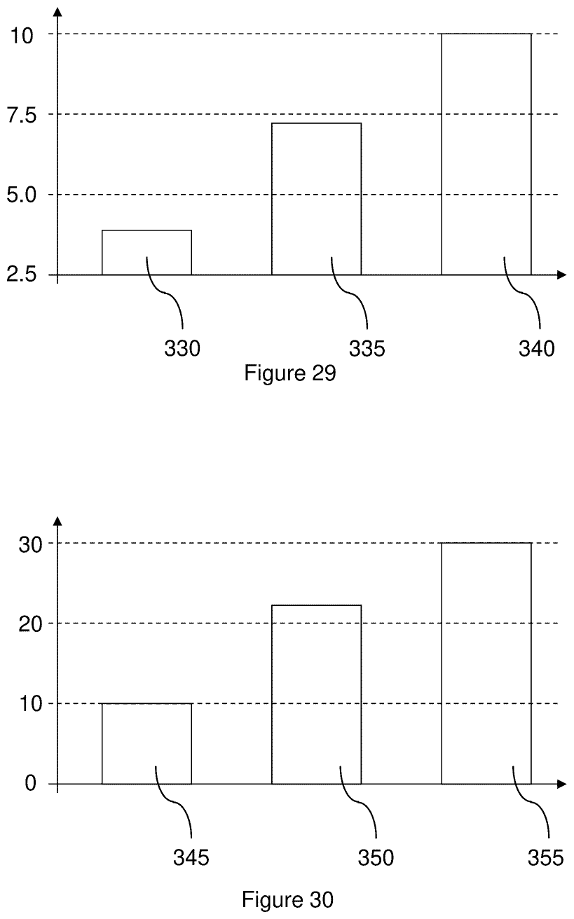

FIG. 29 shows the mean number of cucumbers per plant and per method, from table 3. It shows the mean number of cucumbers per control plant 330; the mean number of cucumbers per plant treated with the baseline product 335; and the mean number of cucumbers per plant treated using crushed material that is the subject of the present invention 340.

FIG. 30 shows the total weight (in kg) of cucumbers per plant and per method, from table 3. It shows the total weight of cucumbers per control plant 345; the total weight of cucumbers per plant treated with the baseline product 350; and the total weight of cucumbers per plant treated using crushed material that is the subject of the present invention 355.

For this trial, eight applications were carried out at ten-day intervals. The observations were recorded for the cucumbers harvested over a 40-day harvest period.

The results show that the mean number of cucumbers per plant during the harvest period in the plots treated using crushed material that is the subject of the present invention (10.12 cucumbers/plant) was statistically higher than from the plots not treated, or treated with the baseline product approved in France (4.10 and 7.20 cucumbers/plant, respectively) (Table 3 and FIG. 29).

The observations also show that the total harvest weight of the cucumbers harvested from the plots treated using crushed material that is the subject of the present invention (29.15 kg) was statistically higher than from the plots not treated, or treated with the baseline product (10.25 and 22.22 kg, respectively) (Table 3 and FIG. 30).

Eight applications, at ten-day intervals, of the finished product from the crushed material allowed the number of cucumbers per plant and the total harvest weight of the treated plants to be increased significantly. In addition, using crushed material that is the subject of the present invention was statistically more effective than using the baseline product.

### 4/ Cucumbers

The finished product from the rocket (Eruca sativa) crushed material (here labeled “FERTI01”), applied at a rate of ten days, allowed the total harvest weight of the treated plants to be increased significantly. Using crushed material that is the subject of the present invention was statistically more effective than using the baseline product mentioned above.

Using crushed material that is the subject of the present invention also allowed the number of fertile flowers to be increased significantly. In addition, using crushed material that is the subject of the present invention was statistically more effective than using the baseline product mentioned above.

For cucumbers, the methods of applying the finished product from the crushed material comprised watering the soil utilizing a liquid formulation.

Table 4 shows, in the trial conditions, the effectiveness of using crushed material that is the subject of the present invention on cucumbers, for a control plant, a plant treated with the baseline product, and a plant treated using crushed material that is the subject of the present invention.

TABLE 4
Effectiveness on cucumbers (10 plants/method)

| | | | | | FERTI |
|---|---|---|---|---|---|
| Crop | Reading | Dates | Control | Baseline | 01 |
| Cucumber | Mean number | Before | 12.25 a | 10.10 a | 16.12 b |
| Cucumis | of fertile | harvesting | | | |
| sativus | flowers | 09/15 to | | | |
| | per plant | 07/10 | | | |
| | Mean number | At | 3.5 a | 5.1 ab | 8.5 b |
| | of cucumbers | harvesting | | | |
| | harvested | 10/08 to | | | |
| | per plant | 10/31 | | | |
| | Total harvest | At | 3.9 a | 6.1 a | 10.2 b |
| | weight (kg) | harvesting | | | |
| | over the | 10/08 to | | | |
| | period | 10/31 | | | |

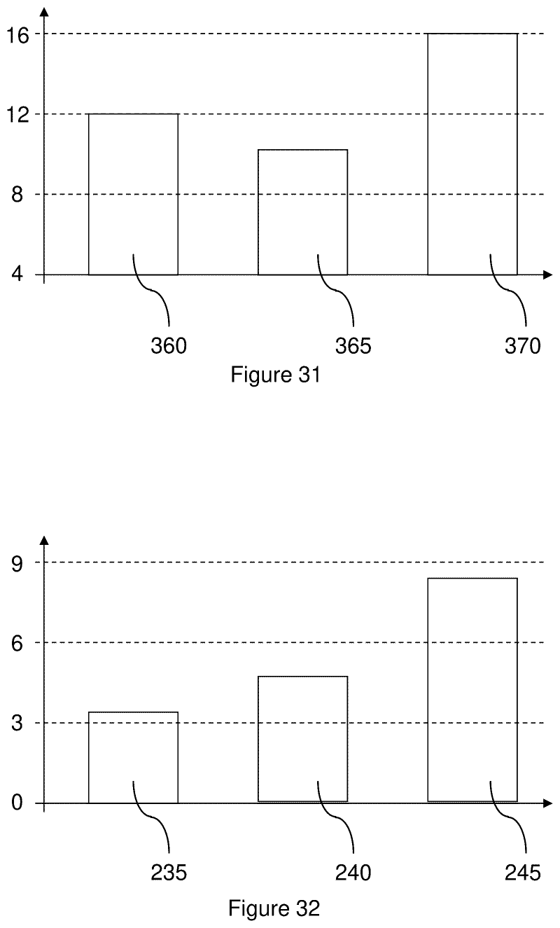

FIG. 31 shows the mean number of fertile flowers per plant and per method, from table 4. It shows the mean number of fertile flowers per control plant 360; the mean number of fertile flowers per plant treated with the baseline product 365; and the mean number of fertile flowers per plant treated using crushed material that is the subject of the present invention 370.

FIG. 32 shows the mean number of cucumbers harvested per plant and per method, from table 4. It shows the mean number of cucumbers harvested per control plant 235; the mean number of cucumbers harvested per plant treated with the baseline product 240; and the mean number of cucumbers harvested per plant treated using crushed material that is the subject of the present invention 245.

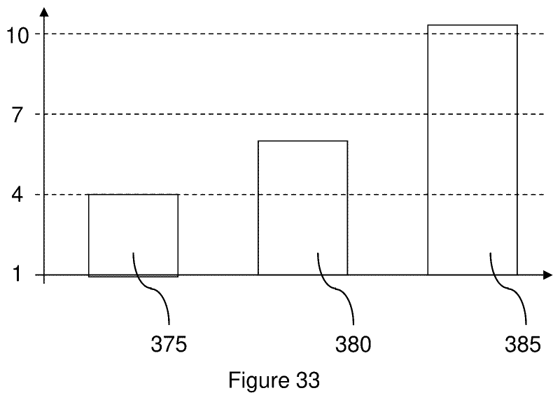

FIG. 33 shows the total weight of cucumbers harvested over the period per method, from table 4. It shows the total weight of cucumbers in the method of control plants 375; the total weight of cucumbers in the method of plants treated with the baseline product 380; and the total weight of cucumbers in the method of plants treated using crushed material that is the subject of the present invention 385.

For this trial, four applications of the tested products were carried out at ten-day intervals. The observations were recorded for the cucumbers harvested over a 23-day harvest period.

The results show that the mean number of fertile flowers per plant from plots treated using crushed material that is the subject of the present invention (16.12 flowers/plant) was statistically higher than from the plots not treated, or treated with the baseline product (12.25 and 10.10 flowers/plant, respectively) (Table 4 and FIG. 31).

The observations also show that the total harvest weight from the plots treated using crushed material that is the subject of the present invention (10.2 kg) was statistically higher than from the plots not treated, or treated with the baseline product (3.9 and 6.1 kg, respectively) (Table 4 and FIG. 33).

Four applications, at ten-day intervals, of the finished product from the crushed material allowed the number of fertile flowers per plant and the total harvest weight of the treated cucumber plants to be increased significantly. In addition, using crushed material that is the subject of the present invention was statistically more effective than using the baseline product.

It should be noted that the results of this trial were obtained over a short harvest period (23 days).

An in vitro study of cucumbers was carried out in the laboratory to support the hypothesis that the crushed material might be classified in the category of root growth stimulators. In this study, use of crushed material that is the subject of the present invention was compared to use of the baseline product Osiryl (registered trademark) root growth stimulator, approved in France under marketing authorization number 1030003.

The products tested were included in the Murashige & Skoog culture medium (0.5×) at the start of the study. The cucumber seeds were sterilized with a bleach solution, then washed three times in water. The sterilized seeds were placed on the culture medium and the Petri dishes were placed in an in vitro culture growth room for 15 days.

The observations were made at seven days and fourteen days after sowing. The results obtained are presented below.

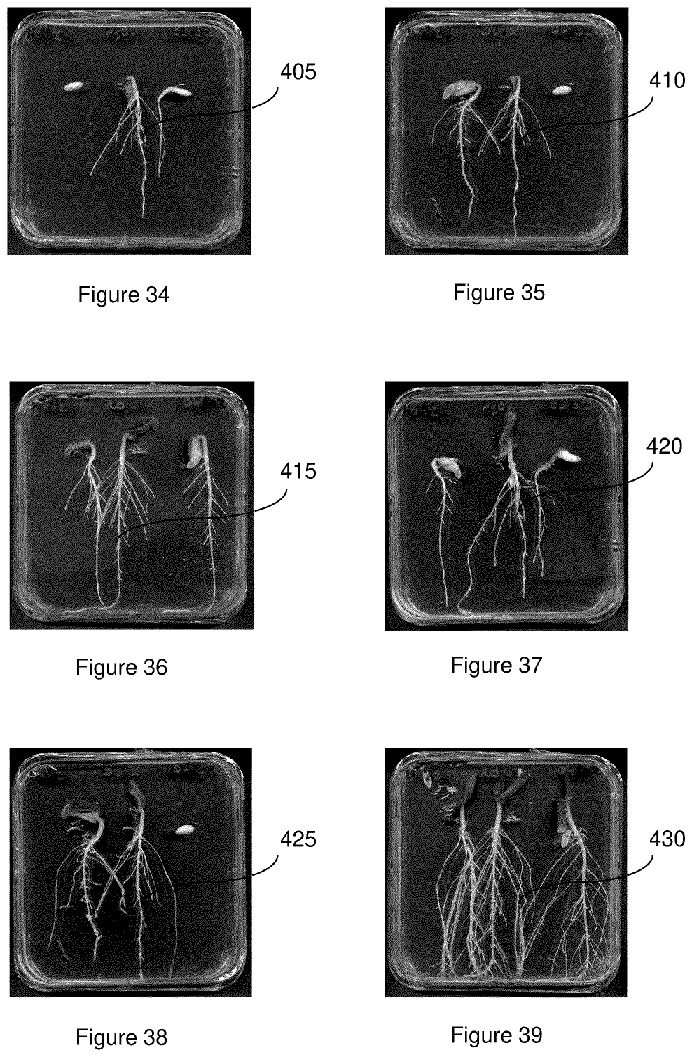

FIGS. 34, 35 and 36: photos of an observation of the products tested in an in vitro culture on cucumbers seven days after sowing. FIG. 34 shows the control 405; FIG. 35 the plant treated with the baseline product 410; and FIG. 36 the plant treated using crushed material that is the subject of the present invention 415.

FIGS. 37, 38 and 39: photos of an observation of the products tested in an in vitro culture on cucumbers fourteen days after sowing. FIG. 37 shows the control 420; FIG. 38 the plant treated with the baseline product 425; and FIG. 39 the plant treated using crushed material that is the subject of the present invention 430.

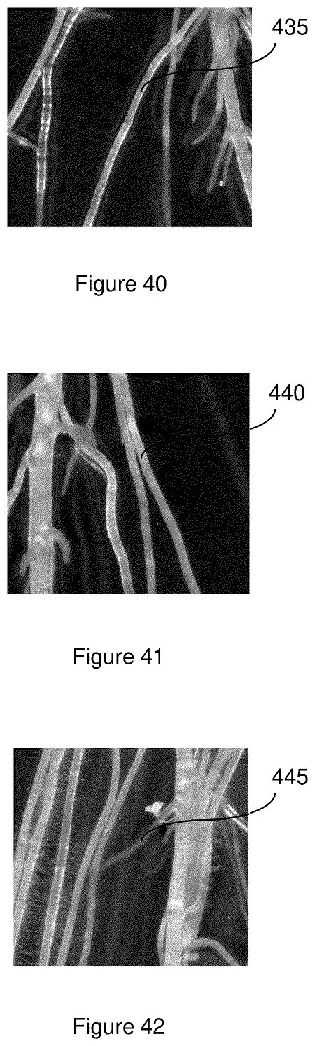

FIGS. 40, 41 and 42: photos of an observation of the products tested in an in vitro culture on cucumbers fourteen days after sowing. FIG. 40 shows the control 435; FIG. 41 the plant treated with the baseline product 440; and FIG. 42 the plant treated using crushed material that is the subject of the present invention 445.

The in vitro study on cucumbers was carried out in France, to test the finished product obtained from the crushed material compared to the baseline product Osiryl.

The observations made it possible to show that the root system was more developed when the finished product from the crushed material was included in the culture medium, compared to the control and to the baseline product. In effect, the number and size of the side roots and secondary roots were greater using crushed material that is the subject of the present invention than for the control or using the baseline product (FIGS. 34 to 39).

In addition, 14 days after sowing, root hairs were only observed in the Petri dishes containing the finished product from the crushed material (FIGS. 40 to 42).

The observations of this in vitro study show that the cucumber seeds that germinated in a culture medium with the finished product from the crushed material added, showed a much more developed root system than the seeds that germinated in the “control” medium.

### 5/ Soft Winter Wheat

In this preliminary experimental field trial, the finished product from the rocket (Eruca sativa) crushed material (here labeled “FERTI01”), applied at key physiological stages to soft winter wheat (shoot 1 cm, 2 nodes, GFT/fragment, stamen emergence), allowed the total harvest weight of the treated plants to be increased significantly compared to the plots not treated (standard control).

Table 5 shows the effectiveness of using crushed material that is the subject of the present invention on the wheat harvest and on the protein content of the harvest, for a plot of standard control plants not treated, and a plot of plants treated with the present invention.

TABLE 5
Effectiveness on soft winter wheat

| | Yield | | | |
|---|---|---|---|---|
| Crop | readings | Dates | Control | FERTI01 |
| Soft winter | Qx/Ha | July 2010 | 74.9 a | 78.8 b |
| wheat | | | | |
| | Proteins | | 10.8 a | 11.3 b |

The general observations were:

a/ No phytotoxicity was observed, in particular no leaf burn, which is frequently observed when triazoles are used.

b/ Slight precocity (one to two days) of stages was observed, especially for heading.

c/ The difference in the harvest weight was significantly higher (four quintals more seeds per hectare) for the method treated using crushed material that is the subject of the present invention.

d/ The level of proteins, a decisive criterion in the bread wheat market for example, was significantly higher in the harvest from plots treated using crushed material that is the subject of the present invention.

The trial conditions of this preliminary trial will be improved to optimize the effects of the use of crushed material that is the subject of the present invention.

For wheat, the methods of applying the finished product from the crushed material comprised a foliar spray utilizing a liquid formulation.

### 6/ Maize

A trial was carried out on young maize plants in a culture room over a 52-day period (from sowing to final reading).

Below is a description of the trials concerning use of the finished product from the rocket (Eruca sativa) crushed material, and of the method that is the subject of the present invention.

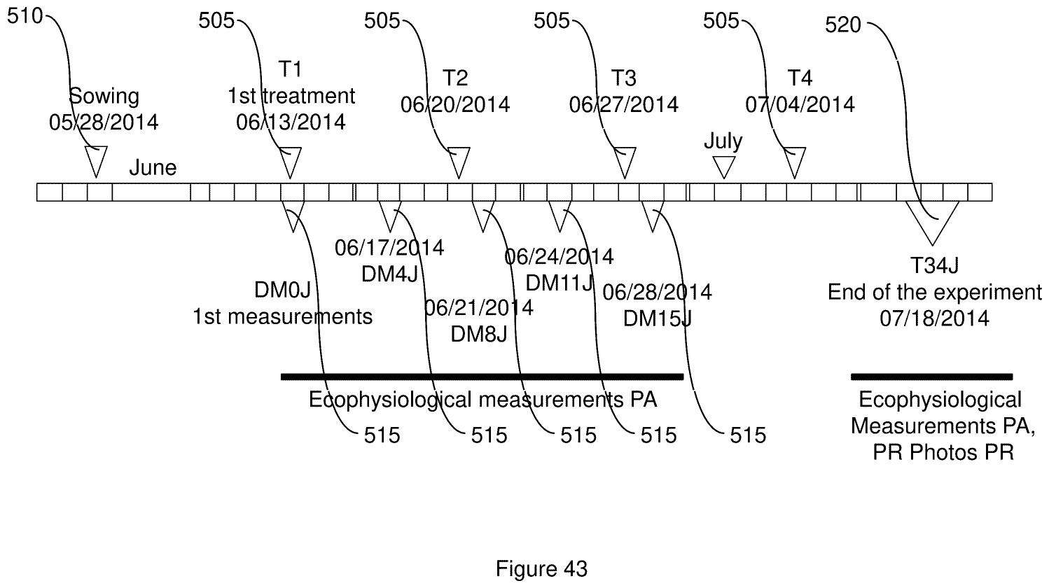

FIG. 43 shows the trial procedure testing the crushed material on maize. Four weekly treatments (triangles 505), by spraying or watering, were applied to seedlings from the 3-leaf stage, 15 days after sowing (triangle 510). The first treatment coincided with DM0J, the date of the first ecophysiological measurements (triangles 515), June 13. The first four measurements (DM0J, DM4J, DM11J, DM15J) concerned the aboveground portion (PA). The end of the trial (DM34J, triangle 520) also allowed physiological measurements of the root portion (PR) to be taken.

The plant material and the growing conditions of the maize are given below.

The sand, with particle size 0.2-5 mm (Filtration sand from Castorama, registered trademark) was rinsed four times with distilled water, then dried for one night in a 105° C. oven. Approximately 100 g of dried sand was used to fill over 60 small containers made of polypropylene plastic (30 cl), then soaked with 40 ml of a nutritive solution prepared according to the manufacturer's protocol (GHE fertilizer). In each container, one maize seed was planted one cm below the surface to germinate. The containers were then placed in the culture chamber under controlled conditions, with a photoperiod of 16 hours, PPFD (acronym for “photosynthetic photon flux density”) approximately equal to 250 μmol·m-2·s-1, humidity of 75%±5%, and a temperature of 24° C.±2° C. in the day and 20° C.±2° C. at night.

After ten days, having reached the 3-leaf stage, the young seedlings were transferred into 2-liter plastic pots filled with sand. After three days' acclimatization, the pots were evenly divided into three groups of 20 plants for the start of the treatments.

There were fifteen days between sowing and the first treatment. At the end of this period, the 60 maize plants obtained were divided into three methods: a control method (C) and two types of treatment with the biostimulant produced from the crushed material, by watering (A) and by spraying (P).

An aqueous extract supplied by the inventor at the beginning was diluted eight times. One hundred milliliters of this dilution was applied to the maize plants, added directly into the pots for method A or sprayed on the plants for method P. For method C, the pots were given 100 ml of water.

The first treatment was applied on Jun. 13, 2014. Three other treatments were scheduled on a weekly basis (FIG. 43).

During the treatments, measurements related to the plant and root growth were taken for the plants of each method, A, P and C. In total, there were four measurement dates: the day of the first treatment (DM0J), 4 (DM4J), 8 (DM8J), 11 (DM11J), 16 (DM16J) and 34 (DM34J) days later (FIG. 43). We measured all the following physiological parameters:

### A/ Mean Size of the Plants:

The plant's size is the distance that separates the base of the coleoptile and the end of the plant's most developed leaf. A mean was calculated for the 20 plants in each method.

### B/ Mean Growth Rate:

The mean growth rate was calculated beginning on DM4J. It corresponds to the difference in size between two adjacent measurement dates divided by the number of days between them. A daily mean was then calculated for each method.

### C/ Mean Leaf Count:

The total leaf count was manually counted on DM34J.

### D/ Mean Diameter of the Stem:

This measurement is the mean of the stem diameters for the 20 plants of each method (A, P, or C). The measurements began on DM11J, the date when the stem was thick enough for the measurement to be taken. The diameter was measured using a caliper rule.

### E/ Measurement of the Mean Weight of the Aboveground Portion and of the Number of Leaves:

These measurements were made at the end of the trial (DM34J) on plants 44 days old. The aboveground portion was separated from the roots, then weighed with the scales. The mean weight was calculated for the 20 plants in each method. The leaf count was manually counted.

### F/ Measurement of the Mean Weight of the Root System

First, the roots were removed from the pots and rinsed with water. The fresh weight of the root portion was measured with precision scales. A mean of the 20 plants was calculated for all these parameters.

### G/ the Mean Chlorophyll and Flavonol Indexes:

The chlorophyll and flavonol indexes were read automatically using a Dualex portable leaf clip (Cerovic, Masdoumier et al. 2012). The device was equipped with a portable infrared light sensor, which made it possible to take non-destructive real-time measurements of the chlorophyll and flavonols of the foliar epidermis following excitation. On DM0J, leaf no. 3, starting from the base of the coleoptile, was sufficiently developed for these measurements to be taken. To ensure a uniform reading, the clip was positioned two cm from the leaf tip. The values were expressed in Dualex units. On DM34J, following the senescence of the largest portion of these third leaves, the measurement was not taken.

All these statistical tests described were carried out using the R program (Pinheiro, Bates et al. 2011). To calculate the various statistical differences between the samples, a Tukey test was carried out for a two-by-two comparison of the means of each method. Ranking according to different letters was carried out manually.

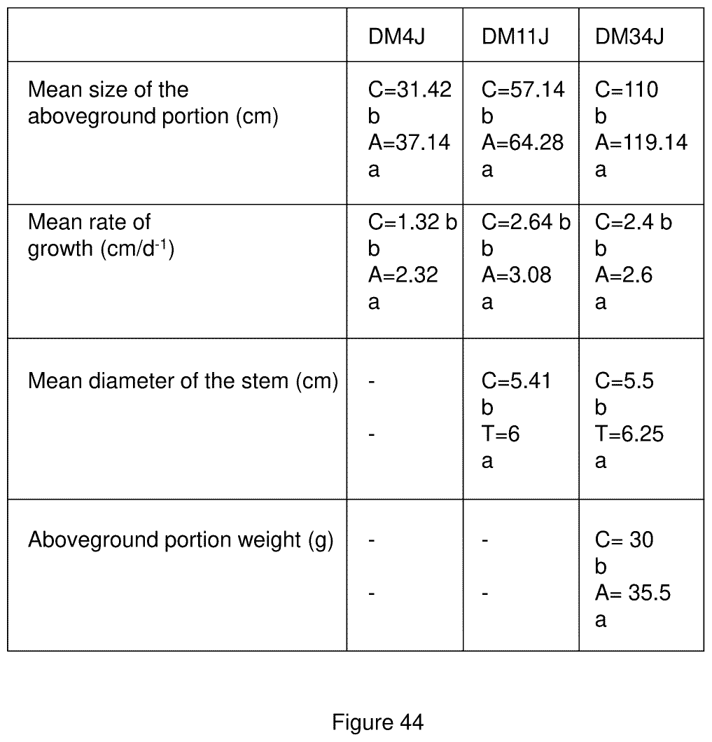

The table shown in FIG. 44 shows the measurements for various ecophysiological parameters during treatments by the use and the method that are the subjects of the present invention.

For each of the measurement dates (DM4J, DM11J, DM34J), the results show the means of the values read for 20 individuals (n=20), following treatments of the maize plants with the finished product from the crushed material by watering (A), compared to the control plants (C). The means are given a different letter when they are statistically different, P<0.05.

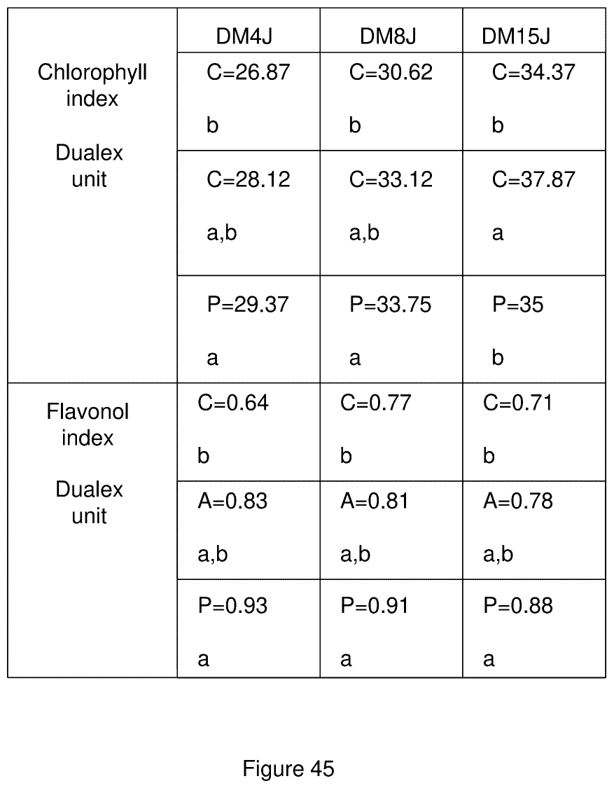

The table shown in FIG. 45 shows the measurements for various ecophysiological parameters (Chlorophyll index and Flavonols index) during treatments using the finished product from the crushed material. For each of the measurement dates (DM4J, DM8J, DM15J), the results show the means of the values read for 20 plants (n=20), following treatments of the maize plants with the finished product from the crushed material by watering (A) and by spraying (P), compared to the control plants (C). The means are given a different letter when they are statistically different, P<0.05.

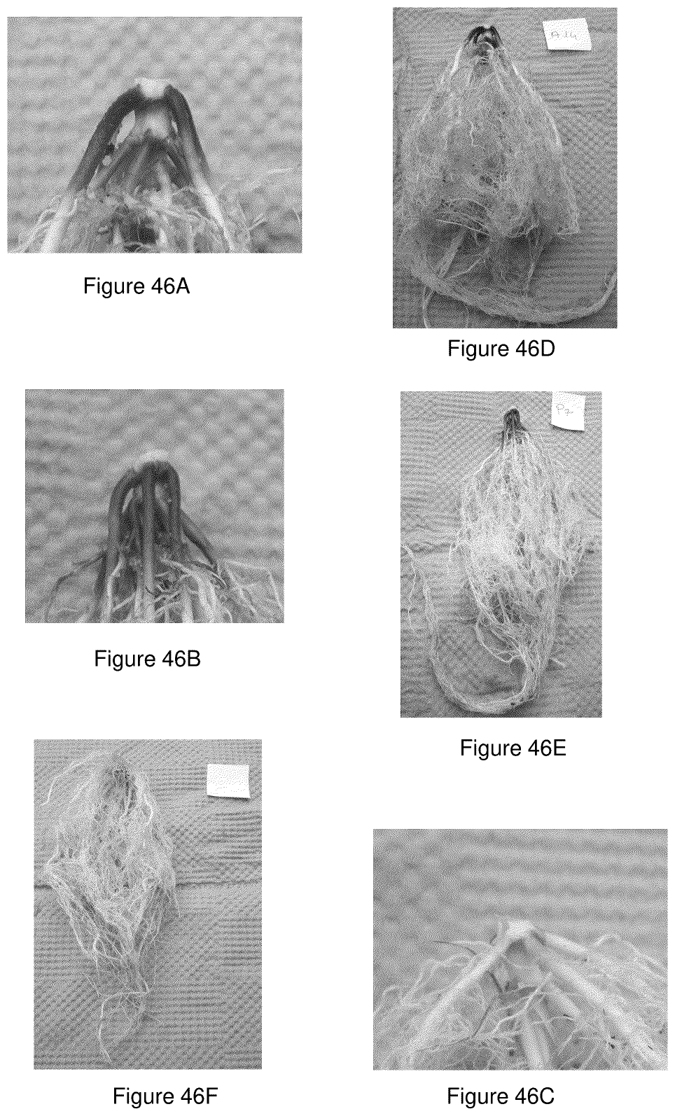

FIGS. 46A to 46F show the stimulation of the root growth under the effect of the finished product from the crushed material. The photos compare the root systems of the control method (FIGS. 46C and 46F) with the treatment by watering methods (FIGS. 46A and 46D) and the spraying methods (FIGS. 46B and 46E).

Table 6 below shows the stimulant effect of the treatment by the use and the method that are the subjects of the present invention on the mean weight of the root portion of maize plants. The results show the means for 20 plants (n=20) of the treatment by watering (A) and by spraying (P) methods compared to the control method (C). The values are given a different letter if they are statistically different, P<0.05.

TABLE 6

| | C | A | P |
|---|---|---|---|
| Mean weight of | 13.6 a | 17.3 b | 15.7 b |
| the root system (g) | | | |

Monitoring the ecophysiological parameters (FIG. 44) linked to the plant growth allowed us to assess the immediate changes occurring after application of the finished product from the crushed material. Just four days after the first treatment (DM4J), we observed that application of the finished product from the crushed material by watering (A) led to a significant increase in the size of the plants. Throughout the trial, the plants of method A remained significantly larger than those of the control method (C).

The mean growth rate values for method A remained significantly higher than those of the controls, for all measurement dates.

Like the mean size, the values recorded for the mean diameter of the plants corresponding to method A are significantly higher than the values for method C.

At the end of the treatments, the aerial biomass measurements showed a significant advance for method A compared to the Control.

The chlorophyll and flavonol indexes (FIG. 45) showed a positive development throughout the trial.

Like the plant growth parameters, these two indexes recorded an increase in value for the 2 methods A and P, with a significant difference for method P, from the 4th day after treatment. Up to DM8J, i.e., one day after the second treatment, the chlorophyll and flavonol indexes remained in favor of the plants of method P, with a significant increase compared to the control plants. At time DM15J, the Chlorophyll index showed a significant difference for method A, compared to the values read for the control method. At the same time, the Flavonol index gave values that continued to show a significant difference for method P. In general, the two indexes showed a positive development over time for methods A and P, even if the differences were not significant for each reading.

Visual inspection of the root system (FIGS. 46A to 46F) allowed us to notice very clear changes at the level of the root phenotype between different methods. The first observation is the extended very pronounced red-purple color of the region at the base of the mesocotyl for the methods treated with the finished product from the crushed material for methods A (FIGS. 46A and 46D) and P (FIGS. 46B and 46E). The second observation concerned the root systems for methods A and P, which seemed to the eye to be more developed than those of the control plants, confirmed by weighing the root system (Table 6).

According to the results obtained, it appears very evident that the two types of treatment, watering and spraying, led to an increase in the plant growth parameters for the maize. This increase, which occurred very early after the first treatment, i.e., after four days, showed a significant benefit for the plants treated by the product of the invention, which was maintained throughout the trial.

An important parameter, which was undoubtedly more developed in the plants watered with the product produced from the crushed material, was the root system. As well as its anchoring role, the root system plays an important role in absorbing nutrients present in the soil. Correlations between the development of root volume, following biostimulant treatments, and a better use of the soil's micro- and macro-elements has been described in several studies (Vessey, 2003; Fan et al. 2006; Canellas et al. 2011; Khan et al. 2013). The improvements observed in the development of the plants treated with the finished product from the Rocket crushed material may therefore be an indirect consequence of the increase in root volume, which increases the effectiveness in using the resources in the soil. The very pronounced red-purple color located at the base of the root mesophyll in the plants treated using crushed material is certainly due to the presumed accumulation of phenolic compounds. The accumulation of these compounds, currently of an unknown nature, can give a preliminary idea for one physiological effect, amongst several, of the finished product from the crushed material on the plant.

The accumulation of phenolic compounds in the plant organs is often a reactive response to environmental stimuli, here making it possible to see a concrete metabolic reaction of the maize plants to the treatment by the product that is the subject of this patent.

The Applicant has found that the biostimulant of the invention, applied to the plant in cultivation as a preventive measure, i.e., before the stress occurs, or as a curative measure, i.e., after the stress occurs, made it possible to reduce the harmful effects of water stresses, in particular the loss of dry matter and therefore of the yield per hectare. In particular, the biostimulant and the treatment method according to the invention induce an overall strengthening of the vigor of the plant. Depending on environmental conditions, this effect may result in maintaining or restoring an optimum yield while the crop is placed under water stress conditions. The description and the examples presented in the description show in particular that the effects of the invention result in an adaptation of the plant (physiology, growth, metabolism, etc.) which enables it to fight against water stresses and to maintain or restore the production of dry matter.

In general, water stress is the cause of a decrease in the yield/production of dry matter and results from drought (lack of water or water stress), extreme temperatures (heat stress), wind, soil salinity (salt stress). In practice, stimulation of root system development makes it possible to enlarge the water reservoir accessible to the plant. The size of the water reservoir accessible to the plant and the rate of consumption of this reservoir are therefore modulated by signals whose transmission involves the biostimulant of the present invention. The effect of the biostimulant applied by coating the seed lasts over time, since the plants treated with the biostimulant of the invention are more tolerant to water stress. In practice, the young seedling is more fragile than the adult plant with regard to water stresses. A young plantlet that has received a treatment with the biostimulant according to the invention reaches a state of so-called complete maturity (“adult” state) more quickly than a plantlet which has not received this treatment.

In practice, the biostimulant according to the invention is applied by spraying the leaves, sprinkling, irrigation, coating the seed, coating the seed, drip or gravity watering the cultivated plant, by addition to a culture medium in hydroponics or aeroponics.

For the purposes of the invention:
“Foliar spray” refers to a pressurized biostimulant projection forming a large number of microdroplets which then cover the upper side and/or bottom of the leaf;
“irrigation” and “watering the soil” refer to a supply of water in the soil solution captured by the root system of the plant; and
“coating the seed” refers to the immersion of the seed in a solution or a powder comprising the biostimulant to produce a dry layer comprising the biostimulant around the non-germinated seed.

Advantageously, the biostimulant is applied by foliar spraying at a rate of 0.1 L/ha to 15 L/ha, preferably at a rate of 1 L/ha to 5 L/ha on the cultivated plant, preferably at the ground cover stage by the leaves of the plant, with 0.1 to 10 grams of dry extract par liter, preferably with 0.5 to 5 grams of dry extract per liter. According to one particular embodiment, the biostimulant is applied as many times as necessary to combat the water stresses to which the cultivated plant is subjected during its life, i.e., until it becomes desiccated or wilted. However, the biostimulant according to the invention may also be applied only once by foliar spraying and/or irrigation and/or coating the seed.

The biostimulant and the methods for manufacturing and applying the biostimulant according to the invention, have the advantages of corresponding to many demands of the farmers:
Respect for the environment;
No induced resistance;
Improvement of environmental conditions;
Lack of danger for humans;
Economic interest;
Wide spectrum of use in terms of varieties of plants in cultivation;
Regulatory interest.

### Effect of PP1 on the Stimulation of the Growth of Different Plant Species Under Water Stress.

Study of the effect of biostimulant PP1 on maize under water deficit conditions.

The effects of drought on maize include:
Delayed and irregular collection,
Poor root development,
Decreased growth/foliar development/reproductive organs,
Decreased performance and
Early senescence and grain filling failure.

A field trial was carried out in 2018 (INRA de Mauguio and EURION Consulting).

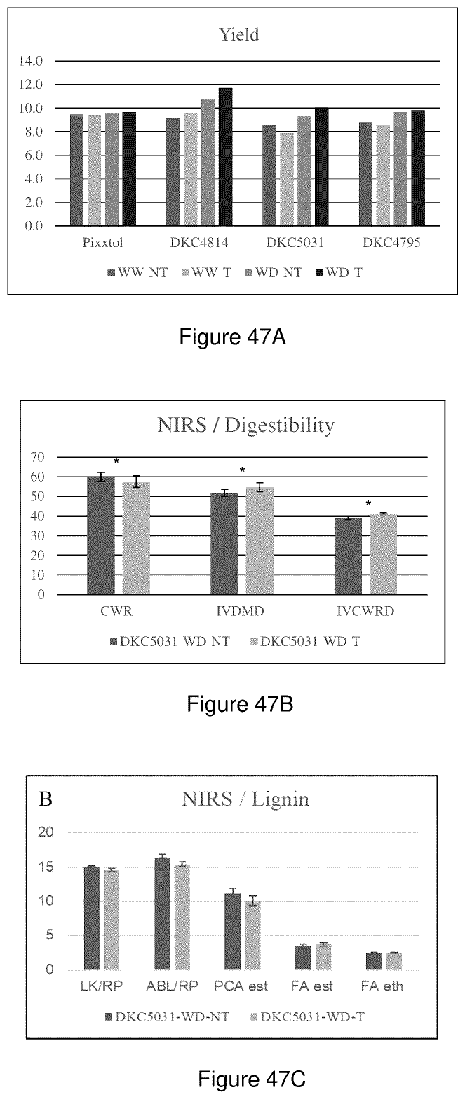

Results: Evaluation of yield. In FIGS. 47A to 47C, “NT” relates to untreated plant, “T” relates to plants treated with PP1, “WW” relates to sufficient irrigation condition and “WD” relates to limiting irrigation condition (water stress).

We can observe on FIG. 47A, that for genotypes DKC4814 and DKC5031, in water deficit condition and treated with PP1, the yield is higher. Thus, PP1 allows stimulation of growth parameters and increased yield under water stress condition.

Evaluation of parietal composition.

A field trial was conducted in 2018 (INRA Mauguio and EURION).

Evaluation of the composition of the wall: Whole plant without spikes/Mode of action.

NIRS (Near Infra Red Spectroscopy) predictions of:
Van Soest Channel:
NDF: membrane or parietal carbohydrates
ADL: lignin
LK: lignin Klason
CWR: wall content
Lignin structure by thioacydolysis: BO4/H/G/S/S/G
Ferulic acid content
Pcoumaric acid content
Sugars: Hemicellulose/cellulose/Xylose/Arabinose/Glucose
DMS: digestibility of dry matter
IVCWRD: digestibility of the wall

As shown in FIG. 47B, PP1 allows an increase in the digestibility of dry matter (IVDMD) and the digestibility of the wall (IVCWRD, +2.32 digestibility point—important point for animal feed/better digestibility of fodder).

As shown in FIG. 47C, PP1 allows a decrease in lignin (LK and ABL).

PP1 allows an improvement of the composition of the wall in condition of water deficit/improvement of fodder for animal feed or for the use of by-products from the cultivation of corn (manufacturing of materials).

In conclusion, PP1 stimulates growth in condition of water deficit/important adaptation to the pouring of cereals, stimulates flower and fruit production, allows an increase in yield and an improvement in the composition of the wall.

### Effects of the Biostimulant PP1 on the Growth of Pedunculate Oak During a Drought.

The objective of the following report is to measure the effects of the biostimulant PP1 on the growth of pedunculate oak (Quercus robur) in the context of afforestation on agricultural land. To do this, the evolution of the total heights of sessile oak seedlings is measured. The plot being surrounded by forests, but being completely fenced and electrified, it is not expected much abrogatutisation (consumption and deformation of young trees by game) of the plantation.

Human activities, an adjacent alfalfa field and forests, should have no influence on this plot, except possibly during hunting season.

Two pedunculate oak modalities (Quercus robur—QUERO) were implemented: Control, (1 block of 40 plants) and treated with PP1 14 days, (1 block of 53 plants). The afforestation is carried out with young seedlings from nursery whose size varies between 15 and 30 cm.

The treatments are carried out by foliar spraying of PP1, 1 g/l, or 190 g/hectare for a density of 1250 pedunculated oaks/hectare.

Equipment used: backpack sprayer: Berthoud, Cosmos 18 pro, capacity 18 liters.

The first treatment took place on Apr. 27, 2021, as soon as the oaks have made their bud break (Time of year when the vegetative and floral buds of the trees develop to reveal their fill (down, young leaves and flowers buried in the buds), then their leaves). Six 14-day spaced sprays were carried out on April 27, May 11, May 27, June 10, June 24 and Jul. 9, 2021.

It should be noted that bud break was later this year 2021, given the cool spring.

The ratings were made on 2 dates, 27 Apr. 2021 and 16 Sep. 2021 and concerned the measurement of total heights.

In order to avoid the edge effect, no plants were used (treatment, notation) on the outer edges of the plot.

The notations are made on 15 pedunculated oaks per modality, chosen randomly.

In addition to the various measures, the removal of pedunculated oaks by game was monitored.

Statistical analyses were carried out according to the Student test at the threshold of 5%. When the results are significantly different according to the Student test performed at a 95% confidence level, different letters indicate this.

During the test, some damage due to the abrogation of pedunculate oak plants by game was observed. There was no significant particular appetite for game between the modality treated with PP1 and the control modality. This damage is therefore not modality/treatment specific. These observations make it possible to validate all the measurements made on pedunculated oaks.

Results of the measurements carried out on the afforestation of pedunculate oak are given in the following table of the evolution of the total heights, in cm

| | Height | Height |
|---|---|---|
| | Witnesses, | PP1 14 days, |
| Dates | in cm | in cm |
| Apr. 27, 2021 | 27.8(a) | 18.7(b) |
| Sep. 16, 2021 | 37.5(c) | 34.9 c |
| Increase observed in 5 months | +9.7 | +16.2 |

As of Sep. 16, 2021, stem oak control plants grew an average of +9.7 cm while those treated with PP1 every 14 days grew an average of +16.2 cm, or 16.2−9.7=6.5 cm more in just 6 months.

Pedunculate oak (Quercus robur) plants reacted positively to PP1. Indeed, under non-optimal conditions of culture (natural environment subjected to high pressures and constraints), the application of the biostimulant PP1 every 14 days stimulated their growth, with a total gain of 6.5 cm (23.4%) on average compared to controls.

Treatments allowed the treated lot, which was significantly smaller, to catch up with the growth level of the control lot. It is important to note that this gain is remarkable on this species, despite a very important grassing and an abnormal drought.

Thus, despite a drought, the increase in growth induced by PP1 would facilitate the installation of pedunculate oak (Quercus robur) in non-optimal growing conditions such as the natural environment where trees are subjected to strong pressures and constraints in the early years, but also to stimulate root growth resulting in better absorption of nutrients and water by the plant, and this, in a sustainable way.

### Effects of the Biostimulant PP1 on the Growth of Sessile Oak During a Drought.

The objective of this report is to identify the effects of biostimulant PP1 on the growth of sessile oak in the context of afforestation on agricultural land, surrounded by protective plastic sheath. To do this, it was measured, the evolution of the total height of each tree.

The plot is surrounded by forests, a fallow field and a cultivated field. It is expected a repeal (consumption and deformation of young trees by game) of the plantation. Human activities, should have no influence on this plot, except possibly during hunting season.

### Modalities

Two modalities of three blocks of 20 sessile oaks (Quercus petraea—QUEPE) were installed:
Control (3×20 plants)
PP1 14 days (3 times 20 plants)

The afforestation is carried out with young seedlings from nursery whose size varies between 15 and 30 cm.

Tests carried out according to EPPO PP 1/152 (4) (European Mediterranean Plant Protection) and the BPE (Good Environmental Practice) guide.

In this plot, red oaks and sessile oaks were planted randomly, in order to mix the species. In this context, the groups of «control» or «treated» plants that concern only sessile oaks do not have regular geometric shapes. In order to avoid the edge effect, no plants were used (treatment, notation) on the outer edges of the plot. In addition to the various measures, the repeal of sessile oaks by game was monitored.

Treatments are carried out by foliar spraying of PP1, 1 g/l, or 190 g/hectare for a density of 1250 sessile oaks/hectare. Equipment used: backpack sprayer: Berthoud, Cosmos 18 pro, capacity 18 liters. The first treatment took place on Mar. 24, 2021, two weeks after planting. Six 14-day spaced sprays were carried out on March 24, April 8, April 22, May 5, May 20 and Jun. 2, 2021.

The ratings were made on two dates, March 24 and Sep. 20, 2021. The notations concern the measurement of the total height of each tree.

Statistical analyses were carried out according to the Student test at the threshold of 5%. When the results are significantly different according to the Student test performed at a 95% confidence level, different letters indicate this.

### Abrogation

During the test, little damage due to the abrogation of sessile oak seedlings by game was observed. There was no significant particular appetite for game between the modality treated with PP1 and the control modality. This damage is therefore not modality/treatment specific. These observations validate all measurements made on sessile oaks.

Results of measurements carried out on the reforestation of sessile oak.

Height, in cm Height, in cm

Dates Witnesses PP1 14 days
Mar. 24, 2021 (t = 0) 40.3(a) 36.9(a)
Sep. 20, 2021 41.7(a) 49.6(b)
Growth difference observed in 6 months/t = 0 + 1.4 + 12.7
Growth difference/control 12.7-1.4 = 11.3 cm
% increase compared to
initial size observed in 6 months 3.5% 34.4%
Growth difference/control 34.4-3.5 = 30.9%

As of Sep. 20, 2021, sessile oak control plants grew an average of 1.4 cm (3.5% from the original size), while those treated with PP1 every 14 days grew an average of 12.7 cm (34.4% from the original size). Under these conditions, plants treated with PP1 grew 11.3 cm more in just 6 months. This difference is significant. Sessile oak (Quercus petraea) plants reacted positively to PP1. Indeed, under non-optimal conditions of culture (natural environment subjected to high pressures and constraints), the application of the biostimulant PP1 every 14 days stimulated their growth, with a total gain of 11.3 cm (30.9%) on average compared to the controls. It is important to note that this gain is remarkable for this species, despite an abnormal drought.

The stimulatory effect of PP1 growth was demonstrated, as plants treated with PP1 have an average 30.9% higher growth than controls, and this difference is significant. This is exceptional for this species, because oak has a slow growth.

Despite a drought, the increase in growth induced by PP1 would facilitate the installation of sessile oak seedlings (Quercus petraea) in non-optimal growing conditions such as the natural environment where trees are subjected to high pressures and stresses (biotic, abiotic) in the first years, but also to stimulate root growth resulting in better absorption of nutrients and water by the plant, and this, in a sustainable way.

### Abiotic Stress

The Applicant has found that the biostimulant of the invention, applied to the plant in cultivation as a preventive measure, i.e., before the stress occurs, or as a curative measure, i.e., after the stress occurs, made it possible to reduce the harmful effects of water stresses, in particular the loss of dry matter and therefore of the yield per hectare. In particular, the biostimulant and the treatment method according to the invention induce an overall strengthening of the vigor of the plant. Depending on environmental conditions, this effect may result in maintaining or restoring an optimum yield while the crop is placed under water stress conditions. The description and the examples presented in the description show in particular that the effects of the invention result in an adaptation of the plant (physiology, growth, metabolism, etc.) which enables it to fight against water stresses and to maintain or restore the production of dry matter.

In general, water stress is the cause of a decrease in the yield/production of dry matter and results from drought (lack of water or water stress), extreme temperatures (heat stress), wind, soil salinity (salt stress). In practice, stimulation of root system development makes it possible to enlarge the water reservoir accessible to the plant. The size of the water reservoir accessible to the plant and the rate of consumption of this reservoir are therefore modulated by signals whose transmission involves the biostimulant of the present invention. The effect of the biostimulant applied by coating the seed lasts over time, since the plants treated with the biostimulant of the invention are more tolerant to water stress. In practice, the young seedling is more fragile than the adult plant with regard to water stresses. A young plantlet that has received a treatment with the biostimulant according to the invention reaches a state of so-called complete maturity (“adult” state) more quickly than a plantlet which has not received this treatment.

In practice, the biostimulant according to the invention is applied by spraying the leaves, sprinkling, irrigation, coating the seed, coating the seed, drip or gravity watering the cultivated plant, by addition to a culture medium in hydroponics or aeroponics.

For the purposes of the invention:
“Foliar spray” refers to a pressurized biostimulant projection forming a large number of microdroplets which then cover the upper side and/or bottom of the leaf;
“irrigation” and “watering the soil” refer to a supply of water in the soil solution captured by the root system of the plant; and
“coating the seed” refers to the immersion of the seed in a solution or a powder comprising the biostimulant to produce a dry layer comprising the biostimulant around the non-germinated seed.

Advantageously, the biostimulant is applied by foliar spraying at a rate of 0.1 L/ha to 15 L/ha, preferably at a rate of 1 L/ha to 5 L/ha on the cultivated plant, preferably at the ground cover stage by the leaves of the plant, with 0.1 to 10 grams of dry extract par liter, preferably with 0.5 to 5 grams of dry extract per liter. According to one particular embodiment, the biostimulant is applied as many times as necessary to combat the water stresses to which the cultivated plant is subjected during its life, i.e., until it becomes desiccated or wilted. However, the biostimulant according to the invention may also be applied only once by foliar spraying and/or irrigation and/or coating the seed.

The biostimulant and the methods for manufacturing and applying the biostimulant according to the invention, have the advantages of corresponding to many demands of the farmers:
Respect for the environment;
No induced resistance;
Improvement of environmental conditions;
Lack of danger for humans;
Economic interest;
Wide spectrum of use in terms of varieties of plants in cultivation;
Regulatory interest.
   Effect of PP1 on the stimulation of the growth of different plant species under water stress.

Study of the effect of biostimulant PP1 on maize under water deficit conditions.

The effects of drought on maize include:
Delayed and irregular collection,
Poor root development,
Decreased growth/foliar development/reproductive organs,
Decreased performance and
Early senescence and grain filling failure.

A field trial was carried out in 2018 (INRA de Mauguio and EURION Consulting).

Results: Evaluation of yield. In FIGS. 47A to 47C, “NT” relates to untreated plant, “T” relates to plants treated with PP1, “WW” relates to sufficient irrigation condition and “WD” relates to limiting irrigation condition (water stress).

We can observe on FIG. 47A, that for genotypes DKC4814 and DKC5031, in water deficit condition and treated with PP1, the yield is higher. Thus, PP1 allows stimulation of growth parameters and increased yield under water stress condition.

Evaluation of parietal composition.

A field trial was conducted in 2018 (INRA Mauguio and EURION).

Evaluation of the composition of the wall: Whole plant without spikes/Mode of action.

### NIRS (Near Infra Red Spectroscopy) Predictions of:

Van Soest Channel:
NDF: membrane or parietal carbohydrates
ADL: lignin
LK: lignin Klason
CWR: wall content
Lignin structure by thioacydolysis: BO4/H/G/S/S/G
Ferulic acid content
Pcoumaric acid content
Sugars: Hemicellulose/cellulose/Xylose/Arabinose/Glucose
DMS: digestibility of dry matter
IVCWRD: digestibility of the wall

As shown in FIG. 47B, PP1 allows an increase in the digestibility of dry matter (IVDMD) and the digestibility of the wall (IVCWRD, +2.32 digestibility point—important point for animal feed/better digestibility of fodder).

As shown in FIG. 47C, PP1 allows a decrease in lignin (LK and ABL).

PP1 allows an improvement of the composition of the wall in condition of water deficit/improvement of fodder for animal feed or for the use of by-products from the cultivation of corn (manufacturing of materials).

In conclusion, PP1 stimulates growth in condition of water deficit/important adaptation to the pouring of cereals, stimulates flower and fruit production, allows an increase in yield and an improvement in the composition of the wall.

### Effects of the Biostimulant PP1 on the Growth of Pedunculate Oak During a Drought.

The objective of the following report is to measure the effects of the biostimulant PP1 on the growth of pedunculate oak (Quercus robur) in the context of afforestation on agricultural land. To do this, the evolution of the total heights of sessile oak seedlings is measured. The plot being surrounded by forests, but being completely fenced and electrified, it is not expected much abrogatutisation (consumption and deformation of young trees by game) of the plantation.

Human activities, an adjacent alfalfa field and forests, should have no influence on this plot, except possibly during hunting season.

Two pedunculate oak modalities (Quercus robur—QUERO) were implemented: Control, (1 block of 40 plants) and treated with PP1 14 days, (1 block of 53 plants). The afforestation is carried out with young seedlings from nursery whose size varies between 15 and 30 cm.

The treatments are carried out by foliar spraying of PP1, 1 g/l, or 190 g/hectare for a density of 1250 pedunculated oaks/hectare.

Equipment used: backpack sprayer: Berthoud, Cosmos 18 pro, capacity 18 liters.

The first treatment took place on Apr. 27, 2021, as soon as the oaks have made their bud break (Time of year when the vegetative and floral buds of the trees develop to reveal their fill (down, young leaves and flowers buried in the buds), then their leaves). Six 14-day spaced sprays were carried out on April 27, May 11, May 27, June 10, June 24 and Jul. 9, 2021.

It should be noted that bud break was later this year 2021, given the cool spring.

The ratings were made on 2 dates, 27 Apr. 2021 and 16 Sep. 2021 and concerned the measurement of total heights.

In order to avoid the edge effect, no plants were used (treatment, notation) on the outer edges of the plot.

The notations are made on 15 pedunculated oaks per modality, chosen randomly.

In addition to the various measures, the removal of pedunculated oaks by game was monitored.

Statistical analyses were carried out according to the Student test at the threshold of 5%. When the results are significantly different according to the Student test performed at a 95% confidence level, different letters indicate this.

During the test, some damage due to the abrogation of pedunculate oak plants by game was observed. There was no significant particular appetite for game between the modality treated with PP1 and the control modality. This damage is therefore not modality/treatment specific. These observations make it possible to validate all the measurements made on pedunculated oaks.

Results of the measurements carried out on the afforestation of pedunculate oak are given in the following table of the evolution of the total heights, in cm

| Height Height Dates | Witnesses, in cm | PP1 14 days, in cm |
|---|---|---|
| Apr. 27, 2021 | 27.8(a) | 18.7(b) |
| Sep. 16, 2021 | 37.5(c) | 34.9 c |
| Increase observed in 5 months | +9.7 | +16.2 |

As of Sep. 16, 2021, stem oak control plants grew an average of +9.7 cm while those treated with PP1 every 14 days grew an average of +16.2 cm, or 16.2−9.7=6.5 cm more in just 6 months.

Pedunculate oak (Quercus robur) plants reacted positively to PP1. Indeed, under non-optimal conditions of culture (natural environment subjected to high pressures and constraints), the application of the biostimulant PP1 every 14 days stimulated their growth, with a total gain of 6.5 cm (23.4%) on average compared to controls.

Treatments allowed the treated lot, which was significantly smaller, to catch up with the growth level of the control lot. It is important to note that this gain is remarkable on this species, despite a very important grassing and an abnormal drought.

Thus, despite a drought, the increase in growth induced by PP1 would facilitate the installation of pedunculate oak (Quercus robur) in non-optimal growing conditions such as the natural environment where trees are subjected to strong pressures and constraints in the early years, but also to stimulate root growth resulting in better absorption of nutrients and water by the plant, and this, in a sustainable way.

### Effects of the Biostimulant PP1 on the Growth of Sessile Oak During a Drought.

The objective of this report is to identify the effects of biostimulant PP1 on the growth of sessile oak in the context of afforestation on agricultural land, surrounded by protective plastic sheath. To do this, it was measured, the evolution of the total height of each tree.

The plot is surrounded by forests, a fallow field and a cultivated field. It is expected a repeal (consumption and deformation of young trees by game) of the plantation. Human activities, should have no influence on this plot, except possibly during hunting season.

### Modalities

Two modalities of three blocks of 20 sessile oaks (Quercus petraea—QUEPE) were installed:
Control (3×20 plants)
PP1 14 days (3 times 20 plants)

The afforestation is carried out with young seedlings from nursery whose size varies between 15 and 30 cm.

Tests carried out according to EPPO PP 1/152 (4) (European Mediterranean Plant Protection) and the BPE (Good Environmental Practice) guide.

In this plot, red oaks and sessile oaks were planted randomly, in order to mix the species. In this context, the groups of «control» or «treated» plants that concern only sessile oaks do not have regular geometric shapes. In order to avoid the edge effect, no plants were used (treatment, notation) on the outer edges of the plot. In addition to the various measures, the repeal of sessile oaks by game was monitored.

Treatments are carried out by foliar spraying of PP1, 1 g/l, or 190 g/hectare for a density of 1250 sessile oaks/hectare. Equipment used: backpack sprayer: Berthoud, Cosmos 18 pro, capacity 18 liters. The first treatment took place on Mar. 24, 2021, two weeks after planting. Six 14-day spaced sprays were carried out on March 24, April 8, April 22, May 5, May 20 and Jun. 2, 2021.

The ratings were made on two dates, March 24 and Sep. 20, 2021. The notations concern the measurement of the total height of each tree.

Statistical analyses were carried out according to the Student test at the threshold of 5%. When the results are significantly different according to the Student test performed at a 95% confidence level, different letters indicate this.

### Abrogation

During the test, little damage due to the abrogation of sessile oak seedlings by game was observed. There was no significant particular appetite for game between the modality treated with PP1 and the control modality. This damage is therefore not modality/treatment specific. These observations validate all measurements made on sessile oaks.

Results of measurements carried out on the reforestation of sessile oak.

| | Height, in cm | Height, in cm |
|---|---|---|
| Dates | Witnesses | PP1 14 days |
| Mar. 24, 2021 (t = 0) | 40.3(a) | 36.9(a) |
| Sep. 20, 2021 | 41.7(a) | 49.6(b) |
| Growth difference observed in | +1.4 | +12.7 |
| 6 months/t = 0 | | |
| Growth difference/control: | | |
| 12.7 − 1.4 = 11.3 cm | | |
| % increase compared to initial | 3.5% | 34.4% |
| size observed in 6 months | | |
| Growth difference/control | | |
| 34.4 − 3.5 = 30.9% | | |

As of Sep. 20, 2021, sessile oak control plants grew an average of 1.4 cm (3.5% from the original size), while those treated with PP1 every 14 days grew an average of 12.7 cm (34.4% from the original size). Under these conditions, plants treated with PP1 grew 11.3 cm more in just 6 months. This difference is significant. Sessile oak (Quercus petraea) plants reacted positively to PP1. Indeed, under non-optimal conditions of culture (natural environment subjected to high pressures and constraints), the application of the biostimulant PP1 every 14 days stimulated their growth, with a total gain of 11.3 cm (30.9%) on average compared to the controls. It is important to note that this gain is remarkable for this species, despite an abnormal drought.

The stimulatory effect of PP1 growth was demonstrated, as plants treated with PP1 have an average 30.9% higher growth than controls, and this difference is significant. This is exceptional for this species, because oak has a slow growth.

Despite a drought, the increase in growth induced by PP1 would facilitate the installation of sessile oak seedlings (Quercus petraea) in non-optimal growing conditions such as the natural environment where trees are subjected to high pressures and stresses (biotic, abiotic) in the first years, but also to stimulate root growth resulting in better absorption of nutrients and water by the plant, and this, in a sustainable way.

In the following study, the effect of PP1 is shown to be accompanied by a better ability to assimilate phosphate (+42.3%) and nitrate (+51.5%). Hormonal tests compared to PP1 provide initial physiological information on the effects of PP1 biostimulant, remaining more effective than the use of ethylene. PP1 effect has also been tested on water stress and proved promising.

In this study, the Columbia ecotype of Arabidopsis thaliana (Col0) was used. The seeds were grown on a 1.5% phyto-agar medium (Roth®) containing 2.6 g L⁻¹ of Murashige and Skoog (MS) nutrient mixture (Sigma-Aldrich®) (pH adjusted to 5.6 using KOH). The seeds were sterilized with 70% ethanol mixed with sodium dodecyl sulfate (SDS) 5% (V/V) for 10 min and then transferred to ethanol 90% for 2 min. The plants were grown at 22° C./19° C. under a 16-hour light/8-hour dark photoperiod, in a refrigerated incubator with Peltier elements IPP410-ecoplus (Memmert®) equipped with LED light modules t7 cold 6500 K (˜130 μmol m²·s⁻¹ light intensity). All seeds were cold stratified at 4° C. for 2 days prior to germination.

Hormonal treatments and PP1 were added to culture media at different concentrations: 1 g/L dry matter of PP1, 0.5 nM of EBL (Sigma-Aldrich®) (diluted in DMSO (PROLABO®)), 10 nM of auxin (Sigma-Aldrich®), 5 μM of ethephon (Sigma-Aldrich®) (ethylene precursor) and auxin (10 nM)+ethephon (5 μM). The PP1 extract was sterilized with Stericup® filtration units (Millipore®) and hormones with Whatman® UNIFLO® 0.22 μm syringe filters. 40 mL of culture medium supplemented with the different treatments were poured in square Petri dishes (Fisher Scientific®). Each treatment is prepared in triplicata. Arabidopsis thaliana seeds (33/can) were seeded in 12×12 cm square Petri dishes and grown for 3 weeks. Measurements were made after 10 days (root structure) and 21 days (root mass).

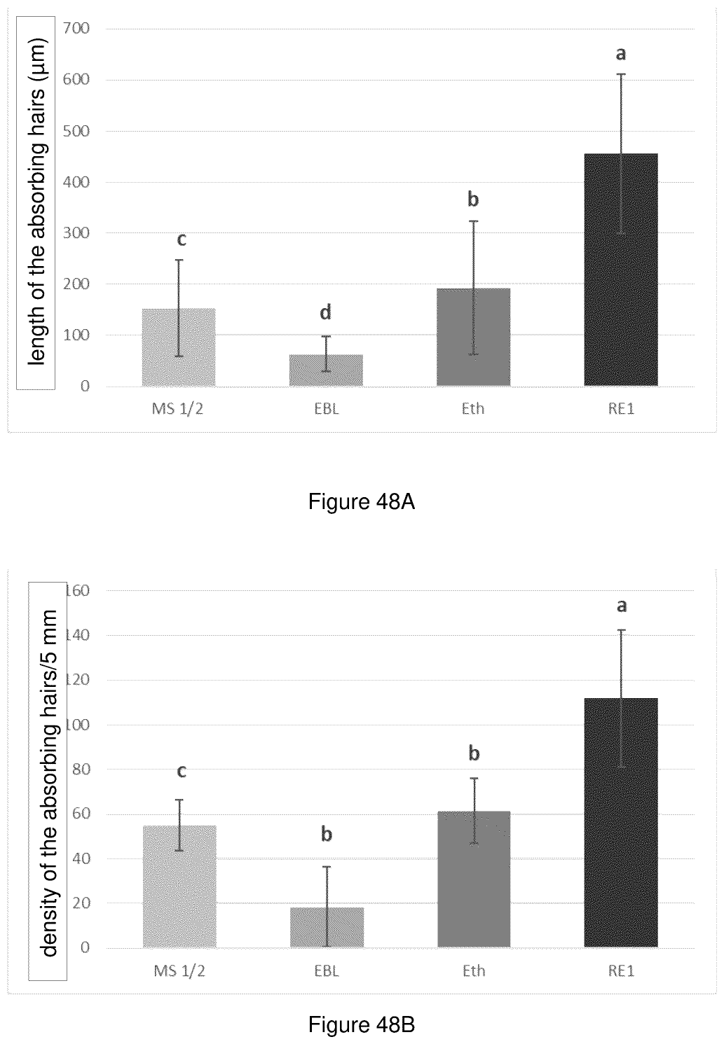

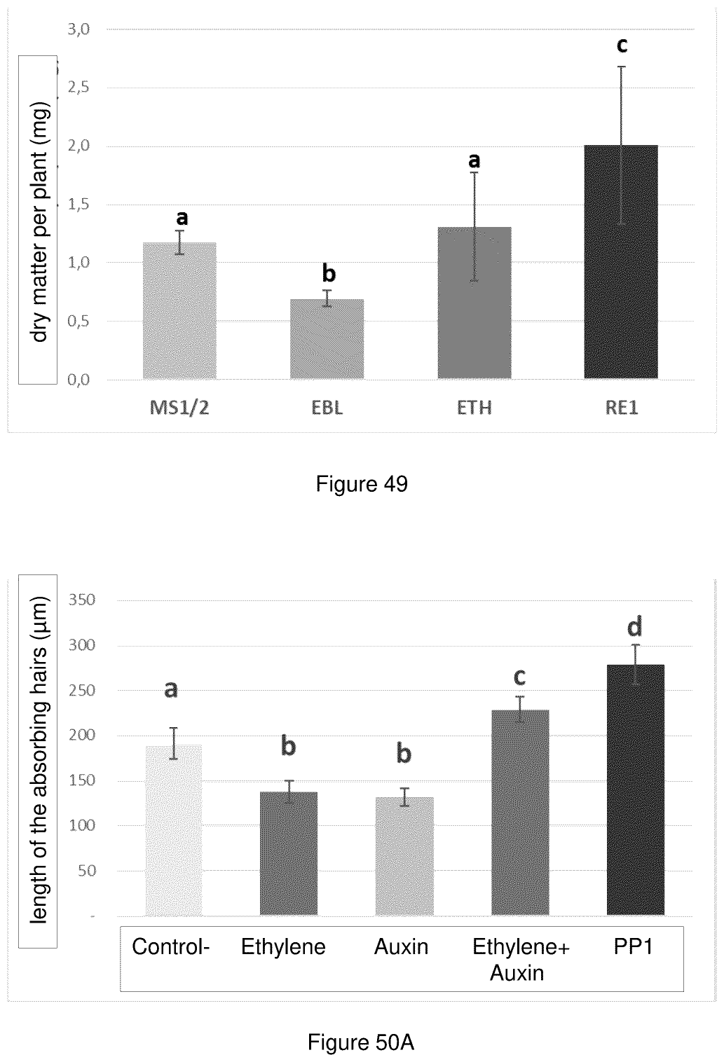

Comparative effects of EBL and ethylene hormones and PP1 treatment on root development in Arabidopsis. thaliana (FIGS. 48A to 49).

FIG. 48A shows lengths of absorbent hair in Arabidopsis thaliana exposed to various treatments (EBL, ethylene and PP1). Length of absorbent hairs measured in μm using ImageJ software. Culture of seedlings on capsule media Murashige and Skoog ½ (MS ½). In the order of treatments, two plant hormones are 24 epi-brassinolide (EBL) and ethylene (Eth) compared to the plant extract PP1 (RE1). The modality (MS ½) corresponds to the culture medium without treatment. The letters above the histograms indicate the level of significance (a>d) according to T test and ANOVA.

FIG. 48B shows densities of absorbent hairs in Arabidopsis thaliana exposed to various treatments (EBL, ethylene and PP1). The density of absorbent hairs is measured by counting the hairs on 5 mm of root. Culture of seedlings on capsules Murashige and Skoog ½ (MS ½). In order of treatments, two plant hormones are 24 epi-brassinolide (EBL) and ethylene (Eth) compared to the plant extract PP1 (RE1). The modality (MS ½) corresponds to the culture medium without treatment. The letters above the histograms indicate the significance according to T test and ANOVA.

FIG. 49 shows dry matter masses per plant in Arabidopsis thaliana exposed to various treatments (EBL, ethylene and PP1). Culture of seedlings on capsules Murashige and Skoog ½ (MS ½). In order of treatments, two plant hormones are 24 epi-brassinolide (EBL) and ethylene (Eth) compared to the plant extract PP1 (RE1). The modality (MS ½) corresponds to the culture medium without treatment. The dry matter was obtained after freeze-drying of the fresh matter. The letters above the histograms indicate the significance according to T test and ANOVA.

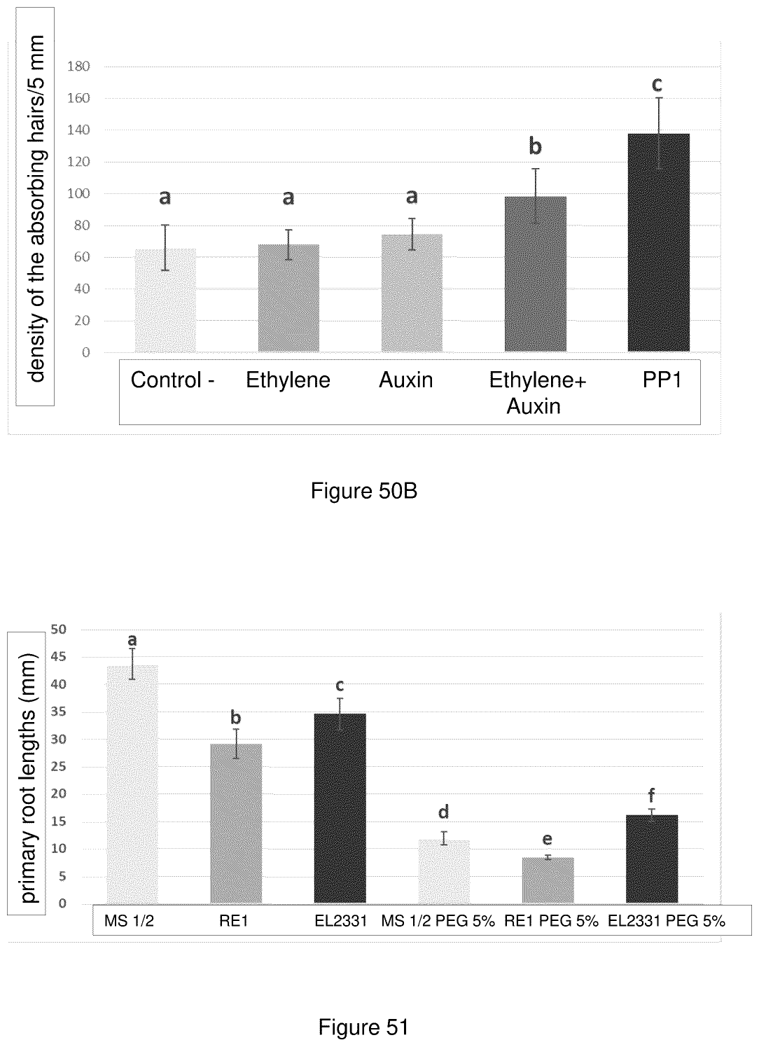

FIG. 50A shows lengths of absorbent hair in Arabidopsis thaliana exposed to various treatments (ethylene, auxin and PP1). Length of absorbent hair measured in μm using ImageJ software. Culture of seedlings on capsules Murashige and Skoog ½. The control modality—corresponds to the culture medium without treatment. The letters above the histograms indicate the significance according to T-test and ANOVA.

FIG. 50B shows densities of absorbent hairs in Arabidopsis thaliana exposed to various treatments (ethylene, auxin and PP1). The density of absorbent hairs is measured by counting the hairs on 5 mm of root. Culture of seedlings on capsules Murashige and Skoog ½. The control modality—corresponds to the culture medium without treatment. The letters above the histograms indicate the significance according to T test and ANOVA.

Effects of PP1 on Water Stress in Arabidopsis thaliana.

PP1 appears to have an effect on plant development, resulting in an increase in total plant mass. The most remarkable effect of PP1 being the development of absorbent hairs, we hypothesized an increase in ion channels and transmembrane proteins found in root hairs and allowing the transport of nutrients. We therefore wanted to check whether the increase in length and density of these hairs would also allow a better absorption of water under water stress, which would be a major asset in the face of drought or climate change.

After 10 days of growth under water stress conditions (thanks to polyethylene glycol added to the culture medium), various measurements were made to test the effect of PP1 on plants under water stress conditions. It was found that under water stress, fresh PP1 significantly increases the length of the primary root compared to untreated plants.

The length of the main roots of A. thaliana grown on an MS ½medium, treated or not with extract PP1 (FIG. 51) was measured after 10 days. Without treatment (control condition), the main roots lengthen on average by 44 mm. In the presence of PP1 (RE1), the root length is 29 mm. In contrast, with fresh PP1 the root length is 34.5 mm. In the presence of PEG 6,000 to 5%, the primary root of the control plants shrinks to 12 mm, plants treated with PP1 RE1 measure 8.5 mm and plants treated with fresh PP1 have a primary root measuring on average 16 mm. The primary root of plants that grew in agar soaked with PEG 6000-10% was not measured, as the measurement was not accurate enough.

Thus, in the presence of PP1 and in optimal condition, it was found that the length of the main root is significantly lower than that of the «untreated» condition, which corroborates the data obtained in previous studies, in which a decrease in the growth of the main root has always been observed. In addition, fresh PP1 was found to significantly increase the length of the primary root under water stress compared to untreated plants. In addition, fresh PP1 significantly increases the length of the primary root, regardless of the condition, compared to non-fresh PP1.

FIG. 51 shows primary root lengths in Arabidopsis thaliana exposed to various treatments. Primary root length measured in mm using ImageJ software. Culture of seedlings on capsules Murashige and Skoog ½. In order of treatments, control-, PP1 (RE1), fresh PP1 (EL2331), control—with PEG 6000 to 5%, PP1 (RE1) with PEG 6000 to 5% and fresh PP1 (EL2331) with PEG 6000 to 5%. The modality (MS ½) corresponds to the culture medium without treatment. The letters above the histograms indicate the significance according to T test.

Under water stress (PEG 6,000 5%), there were 5.77 lateral roots per primary root on average on untreated plants.

There is no significant difference between the same treatments regardless of the water condition. The fresh PP1 allows a significant increase in the number of lateral roots compared to the negative control. Thus, with the fresh PP1, we find results similar to those obtained by the company before.

Again, when analyzing the development of absorbent hair, we found that the results varied considerably according to the treatments, whether in length or density.

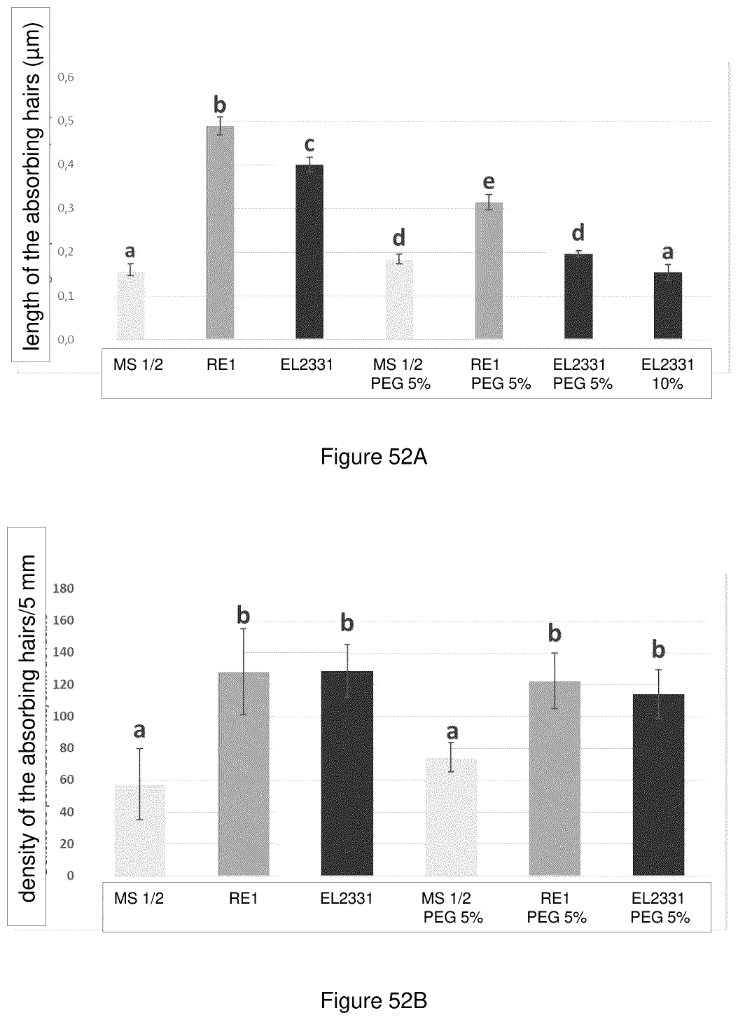

Indeed, the absorbent hairs measured about 160 μm (FIG. 52A) in untreated condition (negative control). On the other hand, the length of the absorbing hairs increased by nearly 305% (488 μm) with a treatment based on PP1 (RE1) and 250% (400 μm) with fresh PP1. In conditions of water stress induced by the presence of PEG 6,000 to 5%, untreated plants had absorbent hairs measuring on average 184 μm. The length of the absorbing hairs of plants treated with PP1 increases under water stress, unlike the non-treated absorbing hairs.

Indeed, under water stress, the absorbing hairs of plants treated with fresh PP1 measured 196 μm. Plants treated with fresh PP1 and grown in agar soaked with 10% PEG 6,000 concentrate had absorbent hairs measuring 154 μm. Namely, absorbent hairs of a similar length to those of control plants in optimal condition.

FIG. 52A shows lengths of absorbent hair in Arabidopsis thaliana exposed to various treatments. Length of absorbent hair measured in μm using ImageJ software. Culture of seedlings on capsules Murashige and Skoog ½. In order of treatments, control-, PP1, PP1 fresh, control—with PEG 6000 to 5%, PP1 with PEG 6000 to 5%, PP1 fresh with PEG 6000 to 5% and PP1 fresh with PEG 6000 to 10%. The modality (MS ½) corresponds to the culture medium without treatment. The letters above the histograms indicate the significance according to T test.

FIG. 52B shows densities of absorbent hairs in Arabidopsis thaliana exposed to various. The density of absorbent hairs is measured by counting the hairs on 5 mm of root. Culture of seedlings on capsule medium Murashige and Skoog ½. In order of treatments, control-, PP1, PP1 fresh, control—with PEG 6000 to 5%, PP1 with PEG 6000 to 5% and PP1 fresh with PEG 6000 to 5%. The modality (MS ½) corresponds to the culture medium without treatment. The letters above the histograms indicate the significance according to T test.

Under the control condition, the density expressed in a number of absorbing hairs per root length unit was 58 for 5 mm. This density was 128 or 221% higher, when PP1 was added to the culture medium. Under water stress (PEG 6,000 5%), the density of absorbent hairs for untreated plants was 74. We were able to count 113 hairs for 5 mm of plant roots treated with fresh PP1, 154% more than for untreated plants.

The data obtained show that PP1 strongly and significantly stimulates the length and density of absorbent hairs under water stress condition remain at a significantly higher level when plants are treated with PP1 (AR1), indicating a positive effect of PP1 on water stress tolerance.

Effects on Total Fresh Mass Per Plant (Arabidopsis thaliana).

The biostimulant effect of PP1 extract was also evaluated via the evolution of fresh biomass. Thus, in controlled condition, untreated plants had a total fresh matter mass per plant of 7.84 mg.

Finally, we observed a significant increase in the total fresh material mass after the addition of fresh PP1 in the culture medium. Indeed, an average of 21.59 mg per plant was weighed, a rate higher than 177% compared to the control condition. In water stress condition (PEG 6,000 5%), each untreated plant weighed about 7.72 mg or 0.12% less than in control condition. On the other hand, under water stress, the fresh mass of plants treated with fresh PP1 decreased by half (10.71 mg). By further increasing water stress with PEG 6,000 to 10%, the mass of untreated plants was 0.75 mg per plant. On the other hand, on average, a plant treated with fresh PP1 weighed 3.18 mg.

Conclusion: PP1 significantly modifies root architecture by doubling the density and tripling the length of the absorbing hairs along the primary and lateral roots in the arabette. This resulted in an increase in total biomass in A. thaliana. Root mass was also increased in Solanum lycopersicum after treatment with PP1 extract. Based on the measurement of the absorbing hairs (150 μm for negative controls and 450 μm for A. thaliana treated with PP1), the diameter of an absorbing hair (about 6 μm) and the density of absorbing hairs (55 and 110) we can estimate the exchange surface. This is 201 mm2 for untreated plants and 950 mm2 for plants treated with PP1 for 5 mm of root. This means that PP1 has the ability to increase the exchange area by a factor of 4.73 with its growing medium.

Thus, this allowed the plants to amplify their exchange surface between the roots or more particularly the absorbent hairs (a factor of 4.73) and the gelled nutrient media in the arabette (A. thaliana) or the substrate used to grow the tomato seedlings (Solanum lycopersicum).

This increase in the exchange surface mainly via the increase of trichogenesis after stimulation with PP1 facilitates the absorption of certain mineral elements by the roots in arabets and tomatoes grown on different nutrient substrates. Indeed, the mineral content increased significantly in the presence of PP1 with a 14% increase in sodium content, 43% in phosphate and potassium or 51.5% more nitrates for plants grown in vitro during the first test. By repeating this test, we measured an increase in the absorption of nitrate, phosphate (not significant difference) and potassium but a decrease in sodium levels in the plant.

In contrast, treating A. thaliana with PP1 allowed plants to better resist water stress, a very important new feature of the PP1 effect that had not been analyzed before and this deserves our full attention to conduct more in-depth studies that help understand the PP1 effect on plant resistance to water stress.

In the experiment described below, 20-day-old maize plants were treated with different rocket crushed materials. One group of plants was treated under normal conditions, while another group of plants was subjected to water stress throughout their growth. The plants underwent two treatments by spraying with the finished products from the crushed material of three plants from the genus Rocket (Eruca sativa, Diplotaxis erucoides and Bunias erucago) at a rate of ten days. The control plants in both conditions were subjected to the same treatment with water.

The following measurements were taken: Measurements of the mean weight of the aboveground portion of maize plants under the different conditions, subjected to water stress or not, and treated with the finished products from crushed material.

In table 7, for each of the measurements (t=20 days), the results show the means of the values read for 14 individuals per method (n=14), following treatment of the maize plants with the finished products from the crushed material by watering (A) and by spraying (P), compared to the control plants (C). The means are given a different letter when they are statistically different, P<0.05.

TABLE 7

| | C | P | A |
|---|---|---|---|
| NORMAL CONDITIONS | | | |
| Mean weight (g) of the aboveground | 19.3 b | 23.9 a | 24.8 a |
| portion of maize plants after | | | |
| treatment with Eruca sativa | | | |
| Mean weight (g) of the aboveground | 17.2 b | 25.2 a | 24.6 a |
| portion of maize plants after | | | |
| treatment with Diplotaxis erucoides | | | |
| Mean weight (g) of the aboveground | 18.5 b | 23.5 a | 23.8 a |
| portion of maize plants after | | | |
| treatment with Bunias erucago | | | |
| WATER STRESS | | | |
| Mean weight (g) of the aboveground | 3.8 b | 10.6 a | 10.8 a |
| portion of maize plants after | | | |
| treatment with Eruca sativa | | | |
| Mean weight (g) of the aboveground | 2.5 b | 9.5 a | 8.5 a |
| portion of maize plants after | | | |
| treatment with Diplotaxis erucoides | | | |
| Mean weight (g) of the aboveground | 3.2 b | 10.2 a | 9.8 a |
| portion of maize plants after | | | |
| treatment with Bunias erucago | | | |

In the trial conditions referred to as normal (optimum growing conditions), the three crushed materials produced from the three genera of Rocket (Eruca sativa, Diplotaxis erucoides and Bunias erucago) allowed the maize plants to have significantly better foliar development, regardless of the treatment, by watering the soil or by foliar spray. In the water stress conditions, as can be seen, the mean weight of the aboveground portion was very low, given the significant dehydration of the plants (many dry leaves). However, the treated plants presented a significantly better vigor and hydration rate than the control plants, regardless of the Rocket genus used.

The application of the product described above showed a positive effect on the tolerance to the lack of water and nutrients. Sprayed on the plants, the two types of application improved the plant's appearance and water content. This property may be the result of an improvement in the root biomass (Marulanda et al. 2009; Anjum et al. 2011), the release of plant hormones such as ABA or CKs into the soil (Zhang & Ervin 2004; Arkhipova et al. 2007; Cohen et al. 2008; Marulanda et al. 2009), or the degradation of ethylene (Arshad et al. 2008).

The list of trials, given as examples, is not exhaustive, and does not in anyway represent a limitation to the use of the crushed material that is the subject of the present invention. This crushed material can be effective on many other plant types not described above.

Demonstration of in vitro effectiveness: use of the crushed material that is the subject of the present invention stimulates the growth of root hairs, and root growth. The observed effects on plant growth are greater than the effects observed during treatments carried out with the baseline product described above.

Biostimulants are remarkably interesting tools to produce more and more efficiently in agriculture and horticulture, since they are products of biological origin, and they appear to be biodegradable, non-toxic, non-polluting, and non-hazardous to various organisms. Their actions are consequences of global pools of their constituents, and not of the presence of one single known essential plant nutrient such as auxins or cytokinins, which can yet be present.

The biostimulant called PP1 has shown strong effects on plant growth, especially budbreak and it stimulates plant immune system. These effects have been shown for instance on Arabidopsis thaliana and a quite unexpected effects have also been enlightened, it seems that PP1 has stimulation action on the adventitious rhizogenesis. Adventitious rhizogenesis is characterized by the appearance of roots on a non-root organ such as shoots or leaves. It is a key process in plant vegetative propagation such as plant striking, which is a widely used technique in agronomy and horticulture (roses production, wine production . . . ). This process is induced by the wounding at the cutting site and the isolation of the cutting from soil resources and global signaling network of the plant. Adventitious rhizogenesis is divided into three phases: it starts with the induction phase, when target cells are reprogramming into meristematic cells, forming new root meristems, then comes the initiation phase, which consists in the first cell divisions that lead to the formation of root primordia; at last, the expression phase occurs with the formation of vascular connections and roots emergence.

Adventitious rhizogenesis is hormonally regulated following a complex and not fully characterized yet mechanism. It is established that auxin is responsible of the induction and initiation of adventitious roots, but exogeneous auxins seem to have an inhibition effect on root elongation and secondary root emergence at high concentrations, indeed, it has been shown that auxins are responsible for a decrease in root epidermal and cortical cell length. Regarding to this, auxin, nowadays widely used in horticulture for plant striking, may not be the best component to use in this context.

In this study supervised by Pr. Christian Jay-Allemand (Université de Montpellier—UMR IATE), we decided to determine the effect of PP1 on adventitious rooting (and budbreak) in a plant striking experiment on an easy to root specie: Nerium oleander. We compared PP1 effects with Indole-3-butyric acid (IBA) effects.

### Material and Methods

### Harvest of Branches and Cuttings Preparation.

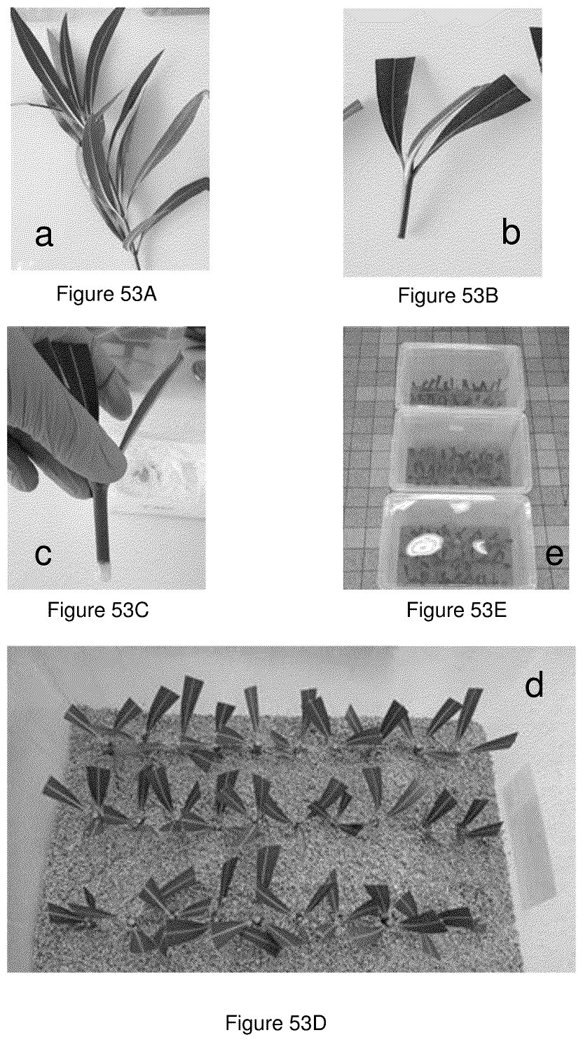

Nerium oleander branches were harvested from 1-year-old shoots on a single healthy tree located on the Campus Triolet of the Université de Montpellier. Each branch was composed of at least five nodes (FIG. 53A, part a) and after a quick rinsing, they were divided in small cuttings composed of only one node by cutting them approximately 1 cm above each node (FIG. 53B, part b). Leaves were also cut at half-length to reduce overload in culture boxes (FIG. 53B, part b). Cuttings were then put into deionized water during about 20 minutes to be fully hydrated. FIGS. 53A to 53E illustrate the striking method, 53A, part a: Branch harvested from the tree, 53B, part b: Cutting, 53C, part c: dry dip method, 53D, part d: planted cuttings, and 53E, part e: culture boxes.

### Treatments of Cuttings and Planting

We decided to test two different ways of applying PP1 to our cuttings, we can call them caulinary way and basal way; the former consists in a simple spraying of a water-based PP1 solution, and the latter is a dry dip method, chosen for its ease. It consists coating, in a quick immersion, of the basal part of the cuttings (around one centimeter from the bottom of the cutting) into talc in which the product to test (powder) has been incorporated.

According to the further experiments proceeded on PP1, we decided to use a concentration of 0.1% (w/v) for PP1 solution and a concentration of 1% (w/w) for PP1 mix with talc. For the positive control, we used Indole-3-butyric acid (IBA) in talc. It has been shown that a concentration of 1% (w/w) gives the best rooting results on oak and beech lignified cuttings and that concentration (here in water based IBA solution) between 0.3% (w/v) and 0.4% (w/v) gives the best rooting results on cuttings from 1-year-old shoots from different species; on Nerium odorum L., it seems that a concentration of 0.4% (w/v) gives the better rooting results. Considering these elements, and since IBA penetration into the plant is probably better using a liquid solution that a solid one, we decided to choose a concentration of 0.5% (w/w) of IBA in talc.

Four plastic transparent boxes were cleaned and disinfected (dimensions 47.5 cm×31.5 cm×30.5 cm) and were filled with approximately 7.5 cm high of autoclaved vermiculite, which correspond to a volume of vermiculite of approximately 11.2 L and a planting surface of approximately 1500 cm². The vermiculite was then homogeneously humidified with 3 L of ultrapure water for each box. 30 cuttings were regularly planted in each box (FIG. 53D, part d) after having been quicky soaked into a mix (talc+PP1n, talc+IBA, pure talc) (FIG. 53C, part c), then we pulverized 50 μl of a solution in each box (ultrapure water+PP1 or ultrapure water alone). The different treatments of the cuttings are described in table 1. Each box represents a single culture condition; therefore, the 30 cuttings are biological replicates. Cuttings were randomly chosen in order not to bias the experiment. To avoid biases, we soaked the negative control cuttings, and the cuttings prone to receive PP1 by caulinary way, into pure talc; and we pulverized 50 μl of ultrapure water in the two control boxes and in the box with PP1 applied to the cuttings by basal way.

Then, we placed the boxes in a culture room with the following growth conditions: 16 hours of light (artificial) at a temperature of 25° C. and 8 h without light at a temperature of 17° C.

| Treatment | Number of | Mix used for | Solution for |
|---|---|---|---|
| code | cuttings | quick dip | pulverization |
| PP1-F | 30 | Talc + PP1 | 50 ml of water |
| PP1-L | 30 | Talc alone | 50 ml of PP1 at 1 g/L |
| IBA | 30 | Talc + IBA | 50 ml of water |
| H₂O | 30 | Talc alone | 50 ml of water |

### Observations and Measurements

Boxes were monitored each day to detect eventual appearance of pathogens and to humidify the cuttings if needed. After 13 days of culture, the number of burst buds and the number of adventitious roots were determined, cuttings were very carefully removed from the vermiculite, a picture was taken and then they were replaced into the vermiculite by digging a hole to avoid root breaking. After 28 days of culture, the number of burst buds, the number of leaves per burst buds and the number of primary adventitious roots were determined as well as the amount of secondary roots. Due to their huge number and their small size, it was not possible to count them, so we attribute a “secondary roots score” to each cutting. The total weight of roots per cutting and burst buds per cutting was determined, by cutting out roots and buds.

### Data Analysis

Data were entered into GraphPad Prism, and a bunch of normality test was performed (Anderson-Darling test, D'Agostino & Pearson test, Shapiro-Wilk test, and Kolmogorov-Smirnov test). When all these tests indicate a normal distribution of the values, a T-test was performed to determine significant differences, when at least one of these tests did not indicate a normal distribution of values, a Mann Whitney test was performed to determine significant differences. Confidence interval at 5% is displayed on the graphics, and significant differences are indicated with letters above bars, a single common letter between bars indicate a non-significant difference, when bars do not have any common letter, this indicates a significant difference.

Results 13 Days after Planting

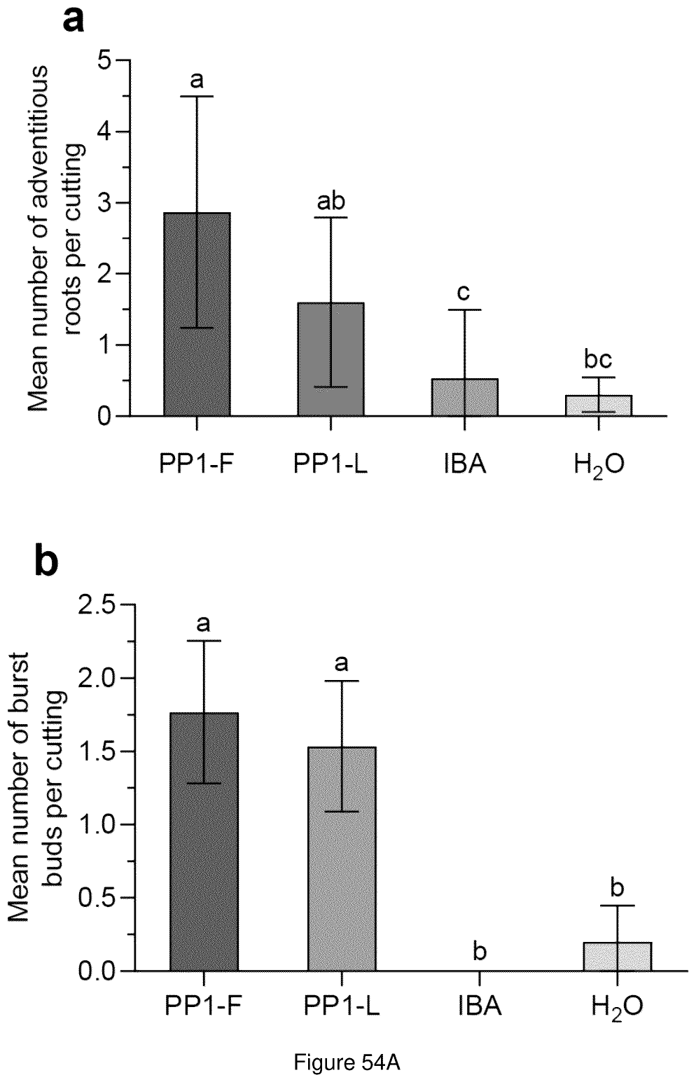

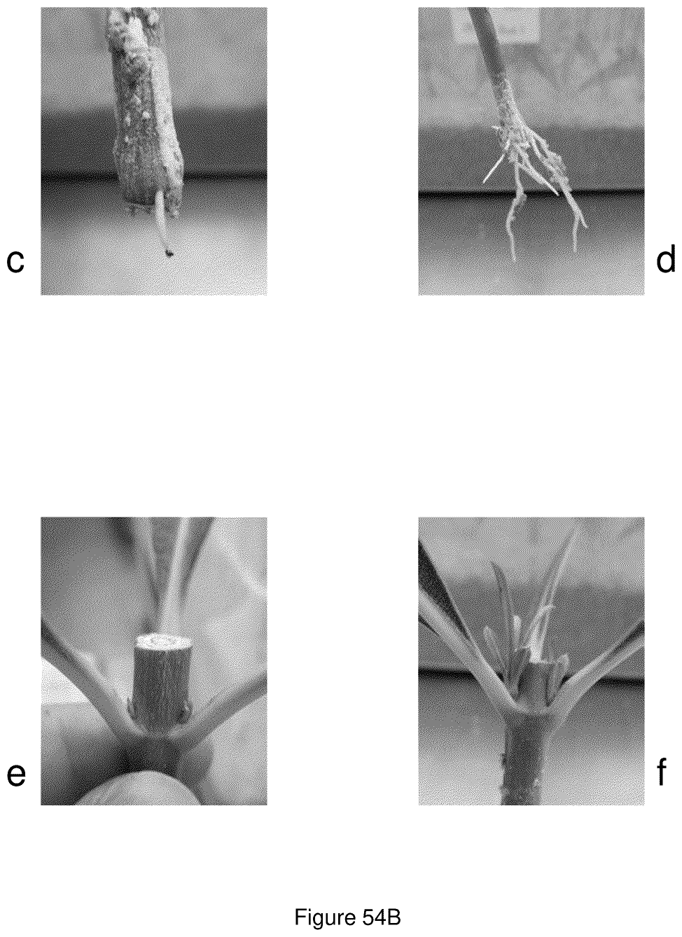

Adventitious roots and burst buds were counted on the 13th day after planting. Both liquid and solid PP1 treatment showed enhancing effects on adventitious root appearance and budbreak with a mean number of burst buds per cutting 7 times higher with PP1-F than with no treatment (FIG. 54A), and a mean number of adventitious roots 6 times higher with PP1-F that with IBA (FIG. 54A).

FIG. 54A illustrates the counts performed on the 13th day of culture. Part a: Mean number of visible adventitious roots per cutting on the 13th day of culture; part b: Mean number of burst buds per cutting on the 13th day of culture. Letters indicate significant differences as explained in Material and methods. FIG. 54B shows pictures of the basal part of cuttings treated with water (part c) and PP1-L (part d), and the apical part of cutting treated with water (part e) and PP1-L (part f).

PP1 Effects on Adventitious Rhizogenesis, 28 Days after Planting

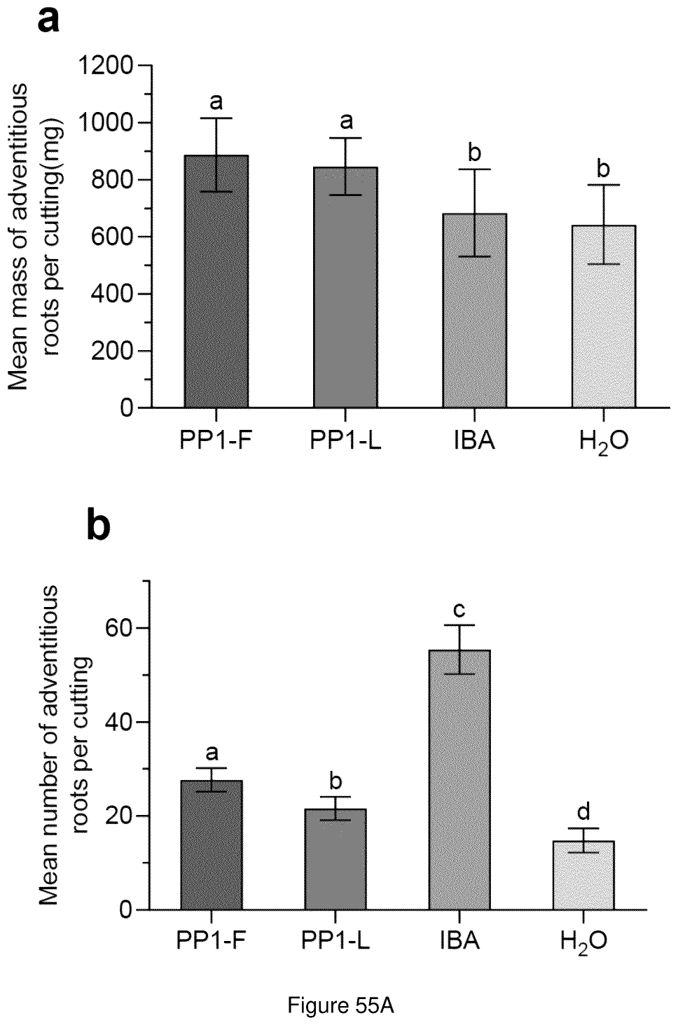

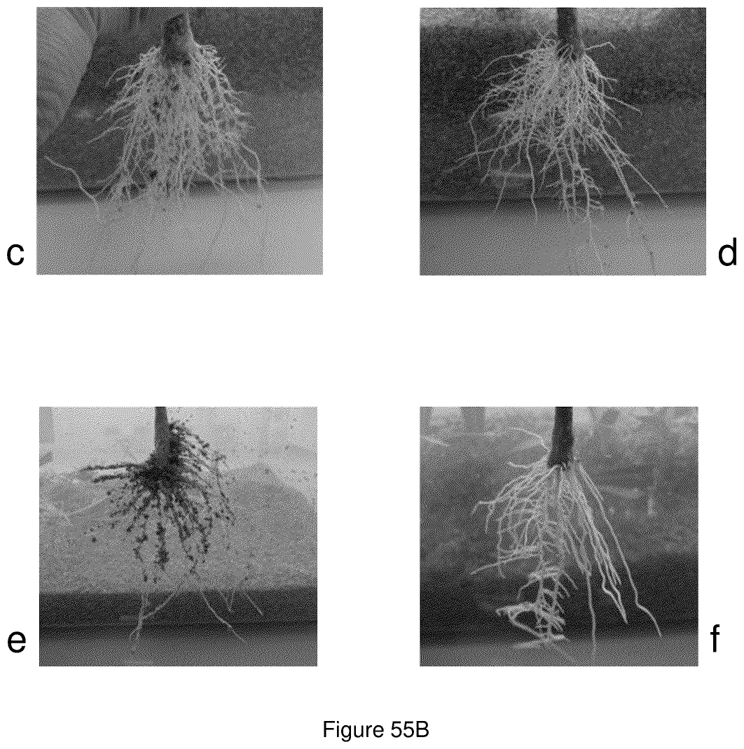

On the 28th day after planting, adventitious roots were counted and the mass of adventitious roots per cutting was determined. The two PP1 treatments gave similar results on the mass of adventitious roots per cutting (about 900 mg in average), this mass was significantly higher, approximately 200 mg higher, than the mass of adventitious roots obtained with and IBA treatment and without treatment (H₂O) (FIG. 55A).

FIG. 55A illustrates the counts and measurements performed on adventitious roots (28th day of culture). Part a: Mean mass of adventitious roots per cutting on the 28th day of culture. Part b, Mean number of adventitious roots per cutting on the 28th day of culture. Letters indicate significant differences as explained in Material and methods. FIG. 55B shows pictures of the basal part of cuttings treated with PP1-F (part c), PP1-L (part d), water (part e) and IBA (part f).

Mean mass of adventitious roots have to be put in relation with the number of adventitious roots, the interesting fact is that, despite a higher mass of roots, PP1 cuttings develop by far less adventitious roots than cutting treated with IBA (FIG. 55A). Indeed, the average mass of a single root is far higher with a PP1 treatment and with no treatment, than with IBA treatment (data not shown). This reflects the fact that IBA leads to an anarchic root development, with lots of small adventitious roots with very few secondary roots; this root appearance occurs along the stems and not only on the basal part of the cuttings, which seems not to be a normal root development, as it is very different from the observations made on the cutting without treatment, than can reasonably be considered as normal development cuttings. Indeed, cuttings without treatment (with only water), show quite long adventitious roots (from 3 to 6 cm in most of the cases) with some secondary roots; the number of these adventitious roots are around 15 per cutting and they come out of the stems on the last centimeter of them (FIG. 55A). Both PP1 solid and liquid treatments showed physiologically similar results to water, PP1 seems to enhance adventitious rooting process without disturbing it as IBA seems to do, indeed, PP1 treated cuttings show more numerous and longer adventitious roots than untreated ones. Furthermore, the amount of secondary roots was higher with PP1 treatments than without treatment and dramatically higher with PP1 treatments than with IBA treatment, PP1 treated cutting show both longer and more numerous secondary roots than untreated ones.

PP1 Effects on Budbreak, 28 Days after Planting

On the 28th day after planting, the number of burst buds per cutting, the number of leaves from bud burst and the mass of buds per cutting was determined.

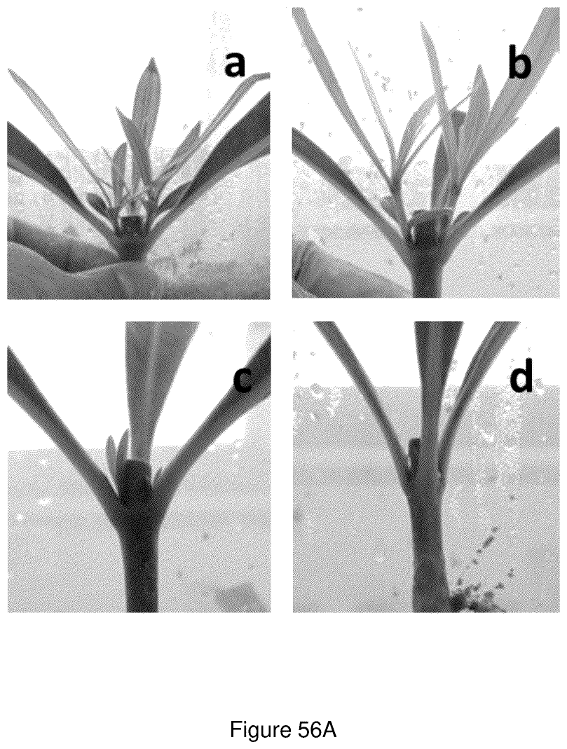

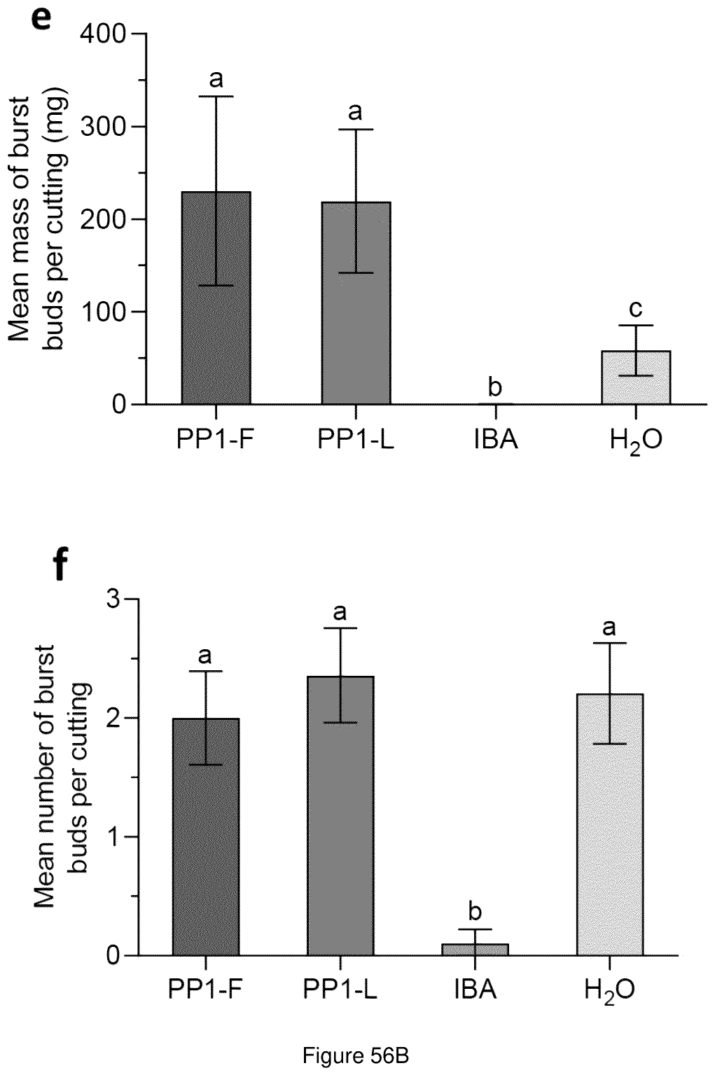

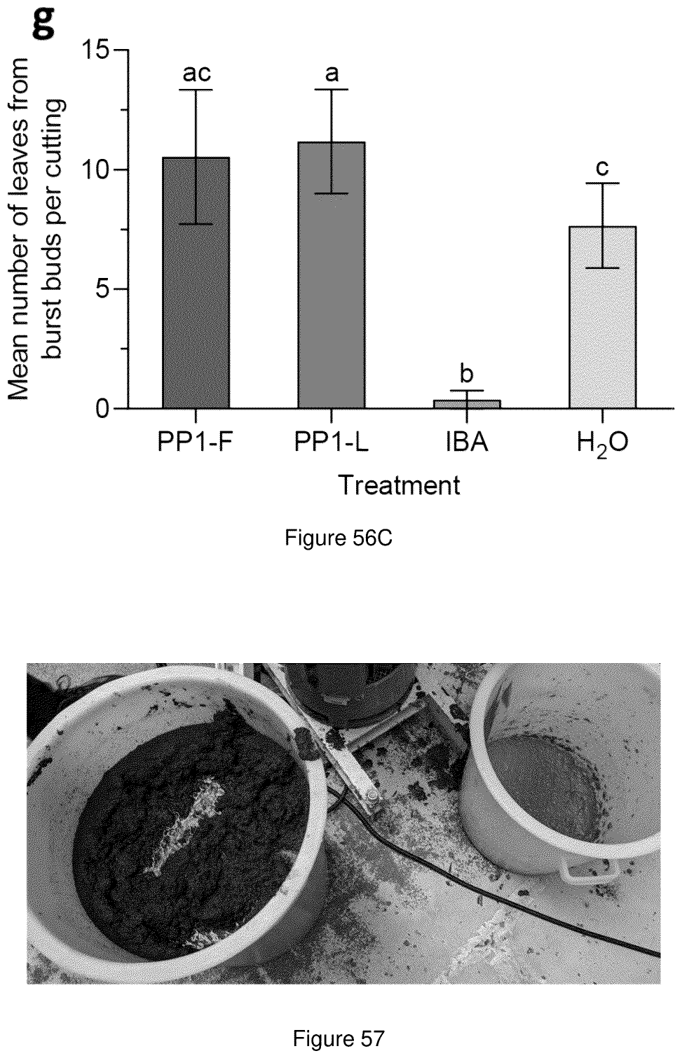

FIG. 56A illustrates the counts and measurements performed on buds (28th day of culture). It shows pictures of the apical part of cuttings treated with PP1-F (part a), PP1-L (part b), water (part c) and IBA (part d). FIGS. 56B and 56C show graphs of mean mass of burst buds per cutting on the 28th day of culture (part e); mean number of burst buds per cutting on the 28th day of culture (part f); and mean number of leaves from burst buds per cutting on the 28th day of culture (part g). Letters indicate significant differences as explained in Material and methods.

As with the adventitious rhizogenesis, both PP1-F and PP1-L treatments gave very similar results, indeed, no significant difference was found between these two treatments in all the parameters studied. However, PP1 has a huge enhancing effect on the budbreak of our cuttings, compared to untreated ones, with a mean mass of buds per cutting around 5 times higher, and a higher mean number of leaves from burst buds per cutting, 3.5 more leaves with PP1 than without in average. PP1 does not seem to have a long-term effect (28 days) on the number of burst buds per cutting. Which seems quite logical since our cutting only had 3 potential buds. PP1 increase the intensity of bud break with the appearance of more numerous, taller, and thus heavier leaves.

IBA seem to have a strong inhibitory effect on budbreak, indeed, only 3 burst buds were found in the whole IBA treated cuttings, it is 19 to 22 time less than with PP1 and 21 time less than without treatment. The same type of observations was made with the average mass of burst buds per cutting (207 times less than without treatment and about 800 times less than with PP1) (FIG. 56B).

Differences between PP1-F and PP1-L, PP1 effects over time and correlation between budbreak and adventitious rhizogenesis

We clearly showed that the penetration way of PP1, by the basal part of the cutting, with solid PP1 powder or by a water-based PP1 solution pulverized on leaves, does not seems to have effect neither on adventitious rhizogenesis or budbreak.

Our experiment showed an effect of PP1 over time, indeed, PP1 seems to lead to more precocious processes of budbreak and adventitious rhizogenesis (data not shown). But since we only have 3 measurements over time (0 days, 13 days, 28 days), and since we do not have any data on mass at 13 days, we should do further experiments to confirm this tendency.

An interesting fact that we discovered is that the two studied processes, namely adventitious rhizogenesis and budbreak, seem not to be correlated, indeed, we studied the correlation of them by doing a scatterplot between mass of adventitious roots and mass of burst buds and by calculating the Pearson correlation coefficient between them; with both methods, we were not able to show any correlation between mass of adventitious roots and mass of burst buds, whatever the treatment was.

### Discussions

### Entry and Transport of PP1's Components and Effect of PP1 on Water Fluxes in the Plants

Our experiment shows that PP1 have an enhancing effect on both budbreak and adventitious rhizogenesis. The way of application of PP1 has been shown to have no effects on both processes. Indeed, applying PP1 by pulverizing it on the apical part of the cuttings leads to an adventitious rooting process almost identical to dipping the basal part of the cuttings into a powder PP1 mix; and the same observation was made with budbreak intensity. To understand this quite unexpected result, we first focused our interest on PP1's components penetration into the cutting. Two major different ways are to be considered, let's call them the wounding and the natural way. Wounding way consists into penetration of PP1 by the basal and the apical wound of the cutting, while natural way consists into penetration of PP1 by the leave or stem surface. Although both ways may come into play when we pulverize PP1, normal way is more likely to occur, indeed, the leaf surface is by far higher than the wounding surface, conversely, since the lignification of the outer cells of the stem makes water entry difficult, we can reasonably think that wounding way is more likely to occur in cuttings where dry dip method was used. Since both methods seems to bring different penetration ways into play, but leading to the same result, we concluded that PP1's components are very efficiently transported all along the cutting. These components may also be in sufficient amount not to be totally used by the cells before reaching one of the ends of the cutting.

So as to know whether the biostimulant that is the subject of the present invention may be a product of nature, i.e., a product that could naturally be produced in nature, for example when a rocket plant is crushed, the method described in FIG. 1 was performed again without additional water. This “dry” extraction was carried out according to the following procedure:
during a “dry” grinding step, the rocket leaves of the same species of rocket plant were ground finely with no additional water (the only water was the water present in the plant cells), for fifteen minutes, in a suitable mixer device to obtain a homogenous crushed material;
during a filtering step, the crushed material was filtered to separate the leaf matter and obtain a dark green colored liquid without leaf residue, which constitutes a crushed material.

FIG. 57 shows, on the left, this dark green colored liquid as compared to the green colored liquid obtained according to the process described with regards to FIG. 1, on the right.

Next, this dark colored liquid was used to repeat the same experiment as described with regards to FIGS. 25 and 26 and later the same experiment as described with regards to FIGS. 53A to 56C. That dark colored liquid and the powder obtained from it did not exhibit any growth stimulation effect on tomatoes or on Nerium oleander.

It can be assumed that chemical reactions necessitating dilution in water of different compounds coming from different parts of the plant are necessary to obtain the biostimulant that is the object of the invention. It can also be assumed that hydrophilic molecules from cells participate in these reactions and that they are inhibited in the presence of hydrophobic molecules. Whatever the cause, the biostimulant object of the invention cannot be produced by nature, for example when accidentally crushing a rocket plant. This biostimulant can therefore only be obtained by an industrial or artisanal production process.

### Plant Micropropagation Tests

The objective of this experiment is to verify the relevance or the advantage of the use of PP1 in complement or substitution of phytohormones. BAP is the abbreviation of benzyl adenine or 6-benzylaminopurine, phytohormone belonging to the groups of cytokinins that are essential to the development of the plant and that in in vitro culture they are used for the development of the buds of explants. IBA (or AIB) is the abbreviation for indole-3-butyric acid or 1H-indole-3-butanoic acid, is a plant hormone of the auxin family and enters the composition of rooting products.

### Methodology

The conventional process of in vitro multiplication based on phytohormones comprises:

Step 1: Delivery of plant material (ready for use) in trays containing culture medium with nutrients (+hormones) at the end of phase 2. The species selected for this study is Eonymus europaeus (or European charcoal)

Step 2: Testing to assess the effects of PP1 at different concentrations. Phases 1 and 2 will study the effect of PP1 in the multiplication process from preformed buds forming a bunch of shoots+cal (vs. BAP/sucrose). The duration of this stage is estimated at 4 weeks.

Step 3: Effect of PP1 in the development of adventitious roots on leafy shoots of at least 1 cm in length (vs. IBA/Sucrose). The duration of this stage is also estimated at 4 weeks.

Step 4: Effect of PP1 in the acclimatization process of rooted micro-strains. The resulting plants will be adapted to the substrate of the greenhouse. The duration of this stage is also estimated at 4 weeks.

These results could be used as performance indicators in vertical agriculture.

Experimental design: in this experimental phase, it is essential to calculate the effective dose of PP1 at each phase. This trial will consist of 5 different modalities per experimental phase:
1. Explant Multiplication Phase:
a. 3 doses of PP1 (g/L of culture medium): 0.25 g/L, 0.5 g/L, 1.0 g/L
b. 1 negative control (trays with culture medium and nutrients and without hormones)
c. 1 positive control (trays with culture medium and nutrients+BAP/AIB)
2. Explants Rooting Phase:
a. 3 doses of PP1 (g/L of culture medium): 0.25 g/L, 0.5 g/L, 1.0 g/L
b. 1 negative control (trays/box with culture medium and nutrients and without hormones)
c. 1 positive control (trays/box with culture medium and nutrients+AIB/BAP)

A tray/species, with multiplied explants of an age of about 2-3 months, will be used to carry out the first phase of multiplication of the experiment. The test will consist of 3 successive multiplication steps followed by 3 rooting steps.

### Phases 1 and 2—Effect of PP1 in the Multiplication Process:

12 trays containing only nutrient- and hormone-free culture medium (−BAP−AIB);
9 trays will be prepared with each concentration of PP1 (3 concentrations—total 9 trays with PP1;
3 trays will be prepared without PP1;
3 trays containing only culture medium with nutrients and hormones (+BAP+/−AIB);
45 trays in total for this experimental phase;
Duration of the 4-5 week phase;
If all three species (charcoal+honeysuckle+viburnum) are tested, 45 trays will be needed in total (15 trays per each multiplication time).

### Phase 3—Effect of PP1 in Adventitious Root Development:

12 trays containing only culture medium with nutrients and without hormones (−AIB−BAP). Three trays will be prepared containing all 3 concentrations of PP1;
9 trays will be prepared with each concentration of PP1 (3 concentrations—total 9 trays with PP1;
3 trays will be prepared without PP1;
3 trays containing only culture medium with nutrients and hormones (+AIB+/−BAP);
45 trays in total for this experimental phase
Phase duration: 4-6 weeks.

### Phase 4—Effect of PP1 in the Acclimatization Process of Rooted Plants:

90-100 culture pots to receive rooted plants and containing a substrate adapted to their acclimatization needs.

### Results

Table of compositions of different treatments

| Name | ID | BAP (mg/L) | IBA (mg/L) | PP1 (g/L) |
|---|---|---|---|---|
| Control− | DKW0 | 0 | 0 | 0 |
| Control+ | DKW7 | 0.7 | 0.5 | 0 |
| Treatment 1 | DKW7 + PP1 | 0.7 | 0.5 | 0.1 |
| Treatment 2 | DKW3 + PP1 | 0.3 | 0 | 0.1 |
| Treatment 3 | ME230 | 0 | 3 | 0 |
| Treatment 4 | ME230 + PP1 | 0 | 3 | 0.1 |

DKW samples contain the standard culture medium. The “0” means without hormones, the “7” means that all hormones are present and “3” means that only half of the hormones are present. DKW3 medium, low in hormone, is compensated by PP1. ME230 samples contain traditional culture medium and rooting hormones.

Table of results of different treatments

| | DHW0 | DKW7 | DKW7 + PP1 | DKW3 + PP1 | ME230 | ME230 + PP1 |
|---|---|---|---|---|---|---|
| Plants | 45 | 45 | 45 | 45 | 45 | 45 |
| Cals/plant | 43 | 45 | 45 | 45 | 1 | 12 |
| Size of cals | + | ++ | +++ | +++ | + | + |
| Shoots/plant | 2 | 44 | 45 | 45 | 2 | 2 |
| Routs/plant | 0 | 0 | 0 | 0 | 3 | 2 |

Conclusion: Samples that contain PP1 (and only half of the hormones usually provided) behave in the same way as samples that contain only hormones at the “normal” rate. PP1 could thus allow a decrease in the amount of hormones used in the culture medium.

The present invention applies, in particular, to biostimulation of one of the following plants:
tomato;
lettuce;
cucumber;
wheat;
soft wheat;
maize; or
cereal in the broad sense.

1. Elicitor composition stimulating the defences of a plant or tree against a pathogen, said composition comprising at least one aqueous extract of at least one of the following plants: Eruca sativa, Diplotaxis, Erucastrum, Bunias genera, Cakile,
wherein said plant or tree is a strain compatible with said pathogen.

2. The elicitor composition of claim 1, wherein said elicitor composition is applied to said plant or tree between 1 hour and 10 days prior to estimated exposure to said pathogen.

3. The elicitor composition of claim 1, wherein said elicitor composition is applied to said plant or tree at least once every 8 days during a time of risk of exposure to said pathogen.

4. The elicitor composition of claim 1, wherein said pathogen is a virus.

5. The elicitor composition stimulating the defences of the plants and trees of claim 1, wherein the extract is obtained from a plant containing precursors of 1,3-thiazepane-2-thione.

6. The elicitor composition of claim 5, which comprises:
1,3-thiazepane-2-thione extracted from a plant,
additional synthetised 1,3-thiazepane-2-thione or 1,3-thiazepane-2-thione coming from a biological reactor.

7. The elicitor composition stimulating the defences of the plants and trees of claim 1, wherein the extract is obtained from at least one plant not containing precursors of Methyl-isothiocyanate and/or Propenyl isothiocyanate.

8. The elicitor composition stimulating the defences of the plants and trees of claim 1, wherein the extract of at least one plant part is an extract obtained from ground material of said plants, and:
said extract of at least one plant part comprises at least the leaves of said plants, preferably mainly leaves and flowers, and
the method making it possible to obtain said liquid extract comprises the following steps:
a) a step of grinding said plants;
b) filtering the ground material obtained;
c) recovering the liquid extract obtained after filtering and
d) a step of nebulising the liquid extract and passing the nebulised liquid extract in a flow of hot air.

9. The elicitor composition of claim 1, wherein the extract obtained from at least one plant contains a brassinosteroid.

10. A method of reducing the effects of a pathogen on plants, including trees, comprising a step of applying the elicitor composition of claim 1.

11. The method of claim 10, which comprises putting the plant in a state of resistance, in which the plant acts as after an interaction between the R and AVR genes, and the plant triggers the defence mechanisms appearing after a gene-for-gene recognition.

12. The method of claim 10, applied to reduce the effects of an attack by one of the following viruses:
Beet yellowing viruses,
Tobacco mosaic virus,
Cassava mosaic virus,
Banana Bunchy Top Virus (BBTV),
Banana streak virus (BSV),
Barley yellows dwarf virus (BYDV),
Cucumber mosaic virus,
Sugarcane mosaic virus (SCMV),
Maize lethal necrosis (MLN) disease viruses (maize chlorotic mottle virus (MCMV) and sugarcane mosaic virus (SCMV)),
Potyviridae virus family,
Sweet potato feathery mottle virus (Potyvirus), or SPFMV,
Sweet potato chlorotic stunt virus (Crinivirus), or SPCSV
and SPVD,
Sweet potato mild mottle virus, or SPMMV,
Sweet potato latent virus, or SPLV,
Sweet potato chlorotic fleck virus, or SPCFV,
Sweet potato virus G, or SPVG,
Sweet potato leaf curl virus, or SPLCV,
Tomato brown rugose fruit virus (ToBRFV),
Tomato spotted wilt virus, or TSWV,
Tomato mosaic virus, or ToMV,
Zucchini yellow mosaic virus, or ZYMV,
Rose mosaic virus.

13. The method of claim 10, applied to reduce the effects of an attack by one of the following bacteria:
Xylella fastidiosa
Pseudomonas syringae pv actinidiae bacteria
Xantomonas arboricola pv juglandis
Xanthomonas arboricola pv. pruni bacteria
phytoplasma bacteria
Candidatus phytoplasma pyri
Candidatus phytoplasma solani bacteria

14. The method of claim 10, applied to reduce the effects of one of the following bacterium-host combinations:
Xylella fastidiosa bacteria on myrtle-leaf milkwort, grape vines, olive trees, citrus trees, oleander, almond trees, coffee trees, peach trees and stone fruit trees, oak trees, lavender, rosemary, or broom,
Pseudomonas syringae pv actinidiae bacteria on plants of the Actinidia genus,
Xantomonas arboricola pv juglandis bacteria on walnut trees,
Xanthomonas arboricola pv. pruni bacteria on Prunus spp., and preferably the following group of fruit/nut trees: apricot trees, almond trees, cherry trees, peach trees, plum trees, P. salicina, cherry laurel and other exotic or ornamental Prunus species, including P. davidiana and P. laurocerasus,
Pear Decline phytoplasma bacteria or Candidatus phytoplasma pyri on pear trees,
Candidatus phytoplasma solani bacteria on grape vines, lavender, potato plants, tomato plants, aubergine plants, pepper plants and tobacco plants,
Plasmapora viticola fungus on grape vines, or Phytophtora infestans on potato plants and tomato plants, or Phytophtora citrophtora on citrus trees, or Phytophtora cactorum on pear trees and apple trees, or Bremia lactucae on artichokes. All these pathogenic fungi are responsible for mildew, or
oidium-type fungi such as Podosphaera pannosa on rose bushes, and Erysiphe necator, formerly Uncinula necator, on grape vines, and oidia on tomato plants, lettuces, cucumbers, strawberry plants, raspberry plants, currant bushes, peach trees, pear trees, privet, carnations.

15. The method of claim 10, wherein the application of the elicitor composition is a foliar application on the plants.

16. The method of claim 10, wherein the application on said plants is achieved with a dilution of the composition in water between 2 g/L and 2000 g/L expressed in grammes of plants on which the extraction was carried out per litre of product.

17. The method of claim 10, wherein the application on said plants is achieved with a dilution of the composition in water between 5 g/L and 200 g/L expressed in grammes of plants on which the extraction was carried out per litre of product.

18. A method of simulating a gene for gene recognition by a plant of a pathogen that is not gene for gene recognized by said plant, comprising applying the elicitor composition of claim 1.

19. The method of claim 18, which comprises putting the plant in a state of resistance, in which the plant acts as after an interaction between the R and AVR genes, and the plant triggers the defence mechanisms appearing after a gene-for-gene recognition.

20. The method according to claim 18, wherein the elicitor composition is applied to said plant or tree at least once every 20 days during a time of risk of exposure of said plant to said pathogen.
